(19) United States
(12) Patent Application Publication
(10) Pub. No.: US 2025/0054364 A1
(43) Pub. Date: Feb. 13, 2025

(54) SYSTEM, METHODS, AND APPARATUS FOR DISPENSING WAGER PAYOUTS

(71) Applicant: ATMBETPAY LLC, Scottsdale, AZ (US)

(72) Inventors: Osamah Arikat, Phoenix, AZ (US); Derek Smith, Scottsdale, AZ (US)

(21) Appl. No.: 18/925,967

(22) Filed: Oct. 24, 2024

Related U.S. Application Data
(63) Continuation of application No. PCT/US2023/020442, filed on Apr. 28, 2023.
(60) Provisional application No. 63/336,264, filed on Apr. 28, 2022.

(51) Int. Cl. G07F 17/32

(52) U.S. Cl. CPC G07F 17/3244; G07F 17/3241

(57) ABSTRACT

An apparatus for dispensing wager payouts that includes a body and a dispenser disposed therein that stores a plurality of items to be dispensed. The apparatus further includes: a request processing circuit; a verification circuit; and a payout provisioning circuit. The request processing circuit is structured to interpret a payout request command generated by a user. The payout request command corresponds to a payout for one or more wagers made by the user. The verification circuit is structured to, in response to the payout request command, determine that the user is authorized to receive the payout. The payout provisioning circuit is structured to, in response to determining that the user is authorized to receive the payout, cause the dispenser to dispense an amount of the plurality of items corresponding to the payout.

### CROSS-REFERENCE TO RELATED APPLICATION

This application is a continuation of and claims priority to International Application No. PCT/US2023/020442, filed Apr. 28, 2023, and entitled “SYSTEM, METHODS, AND APPARATUS FOR DISPENSING WAGER PAYOUT”, which published on Nov. 2, 2023 as WO 2023/212345 (ATMB-0001-WO).

International Application No. PCT/US2023/020442 claims priority to U.S. Provisional Patent Application Ser. No. 63/336,264, filed Apr. 28, 2022, and entitled “A SYSTEM AND METHODOLOGY FOR ENABLING PHYSICAL CASH PAYOUTS OF ONLINE WAGER WINNINGS USING AUTOMATED TELLER MACHINES” (ATMB-0001-P01).

All of the foregoing patent applications are incorporated herein by reference in their entirety for all purposes.

### BACKGROUND

Sports betting involves risking money on the outcome of a sporting-related event to earn the right to collect on a winning, e.g., money. Sports betting is increasing in popularity and wagering information, and elements thereof, is often displayed on sport broadcasts, with many sports fans considering sports betting and fantasy sports an intrinsic part of the sports fan experience. One aspect of sports betting is the depositing of money by bettors and gamers with a sportsbook, e.g., an entity and/or individual who accepts bets typically placed by individuals/bettors. The depositing of money by bettors with a sportsbook is often accomplished electronically, e.g., without physical money/cash, via credit cards and/or electronic transfer services such as Paypal, CashApp, Venmo, etc., where virtual money is moved from a bettor's bank account to an account with the sportsbook. Winning payouts are paid in a similar manner, where the sportsbook electronically transfers virtual money from their account to the bettor's bank account. Such transfers often take hours, days, and/or longer to complete, which the bettor must wait for prior to withdrawing their winnings as physical money.

One thrill of sports betting is the anticipation of winning money experienced by a bettor while waiting to see whether their placed bet yields a winning result, and the subsequent rush received by the bettor from receiving the money upon winning the bet. This thrill, however, is often softened by the delay in current payout processes between a bettor winning a bet and the bettor being able to see and/or hold the won money physically.

### SUMMARY

Embodiments of the current disclosure provide, among other things, systems, methods, and apparatuses for enabling physical cash payouts for wager winnings at item dispensing devices, e.g., an automatic teller machine (ATM). For example, embodiments of the current disclosure allow a user, e.g., a “player”, “gamer”, and/or “bettor”, to collect their winnings immediately, or nearly immediately, after winning a wager, e.g., a bet on the outcome of a sporting event, placed with a sportsbook. By providing the bettor immediate, or nearly immediate, access to their winnings in the form of cold hard physical cash, embodiments of the current disclosure supercharge and/or enhance the experience of winning money online.

As explained in greater detail herein, embodiments of the current disclosure provide for a user to request a payout of their winnings from a mobile electronic device, e.g., a smart phone. For example, in an embodiment, a server having access to sportsbook data is informed of the request and verifies the user's right to collect on the winnings. Upon verifying that the user is entitled to collect on the winnings, a payout code is displayed on an electronic display of an item dispensing device, e.g., an ATM. The user then scans, e.g., image with a camera, the payout code with the mobile electronic device, and the mobile electronic device then transmits the payout code, or data derived from the payout code, to the server. Upon receipt of the payout code, or the data derived therefrom, the server instructs the ATM to dispense items, e.g., pieces of currency, to the user.

In other embodiments, the payout code is displayed on an electronic display of the user's mobile electronic device and scanned by the item dispensing device. The item dispensing device then transmits the payout code, or data derived from the payout code, to the server. Upon receipt of the payout code, or the data derived therefrom, the server instructs the item dispensing device to dispense items, e.g., pieces of currency, to the user.

Further embodiments of the current disclosure provide for a first user to collect on winnings from a wager with a second user. In such embodiments, the payout code is scanned by the item dispensing device or the electronic mobile device and transmitted to the server. The server then verifies that the first user is entitled to collect on the winnings from the wager with the second user and then instructs the item dispensing to dispense items, e.g., pieces of currency, to the user. In embodiments, the wager may be related to a sporting event and/or an event defined by the first and/or the second user. For example, the wager may be whether it will rain on the first Saturday of the month.

Further embodiments of the current disclosure also provide for a user to transfer the ability to collect on their winnings to a third-party, e.g., a friend, relative, creditor, etc., by providing for the user to send the third-party the payout code. Upon receipt of the payout code, the third-party can collect on the user's winnings by scanning the payout code at an item dispensing device. The item dispensing device then transmits the payout code, or data derived therefrom, to the server which verifies the user is entitled to collect on the winnings and then instructs the item dispensing device to dispense items, e.g., pieces of currency, to the third-party.

Further embodiments of the current disclosure also provide for a winning bettor to collect on their winnings without going through the bettor's bank account and/or without requiring any ATM card.

Further embodiments of the current disclosure provide for offers of new wagers to be presented to a bettor just prior to the bettor collecting on their winnings from prior wagers.

These and other systems, methods, objects, features, and advantages of the present disclosure will be apparent to those skilled in the art from the following detailed description of the embodiments and drawings.

### BRIEF DESCRIPTION OF THE FIGURES

The disclosure and the following detailed description of certain embodiments thereof may be understood by reference to the following figures:

FIG. 1 is a schematic diagram of a system for dispensing wager payouts, in accordance with embodiments of the current disclosure;

FIG. 2 is a schematic diagram of an item dispensing device, in accordance with embodiments of the current disclosure;

FIG. 3 is a block diagram of an item dispensing device, in accordance with embodiments of the current disclosure;

FIG. 4 is a schematic diagram of a user device, in accordance with embodiments of the current disclosure;

FIG. 5 is a block diagram of a user device, in accordance with embodiments of the current disclosure;

FIG. 6 is a schematic diagram of a sportsbook, in accordance with embodiments of the current disclosure;

FIG. 7 is a block diagram of a wager record, in accordance with embodiments of the current disclosure;

FIG. 8 is a schematic diagram of a bank, in accordance with embodiments of the current disclosure;

FIG. 9 is a schematic diagram of a third-party entity, in accordance with embodiments of the current disclosure;

FIG. 10 is a schematic diagram of an apparatus for dispensing wager payouts, in accordance with embodiments of the current disclosure;

FIG. 11 is a flow chart depicting a method for dispensing wager payouts, in accordance with embodiments of the current disclosure;

FIG. 12 is a schematic diagram of an apparatus for dispensing wager payouts, in accordance with embodiments of the current disclosure;

FIG. 13 is a flowchart depicting a method for dispensing wager payouts, in accordance with embodiments of the current disclosure;

FIG. 14 is a flowchart depicting portions of the method of FIG. 13, in accordance with embodiments of the current disclosure;

FIG. 15 is a schematic diagram of an apparatus for dispensing wager payouts, in accordance with embodiments of the current disclosure;

FIG. 16 is a flowchart depicting a method for dispensing wager payouts, in accordance with embodiments of the current disclosure;

FIG. 17 is schematic diagram of an apparatus for dispensing wager payouts, in accordance with embodiments of the current disclosure;

FIG. 18 is a flowchart depicting a method for dispensing wager payouts, in accordance with embodiments of the current disclosure;

FIG. 19 is a schematic diagram of an apparatus for dispensing wager payouts, in accordance with embodiments of the current disclosure;

FIG. 20 is a flowchart depicting a method for dispensing wager payouts, in accordance with embodiments of the current disclosure;

FIG. 21 is a schematic diagram of an apparatus for dispensing wager payouts, in accordance with embodiments of the current disclosure;

FIG. 22 is a flowchart depicting a method for dispensing wager payouts, in accordance with embodiments of the current disclosure;

FIG. 23 is a schematic diagram of an apparatus for dispensing wager payouts, in accordance with embodiments of the current disclosure;

FIG. 24 is a flowchart depicting a method for dispensing wager payouts, in accordance with embodiments of the current disclosure;

FIG. 25 is a schematic diagram of an apparatus for dispensing wager payouts, in accordance with embodiments of the current disclosure;

FIG. 26 is a flowchart depicting a method for dispensing wager payouts, in accordance with embodiments of the current disclosure; and

FIGS. 27 and 28 depict a graphical user interface for an application for dispensing wager payouts, in accordance with embodiments of the current disclosure.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

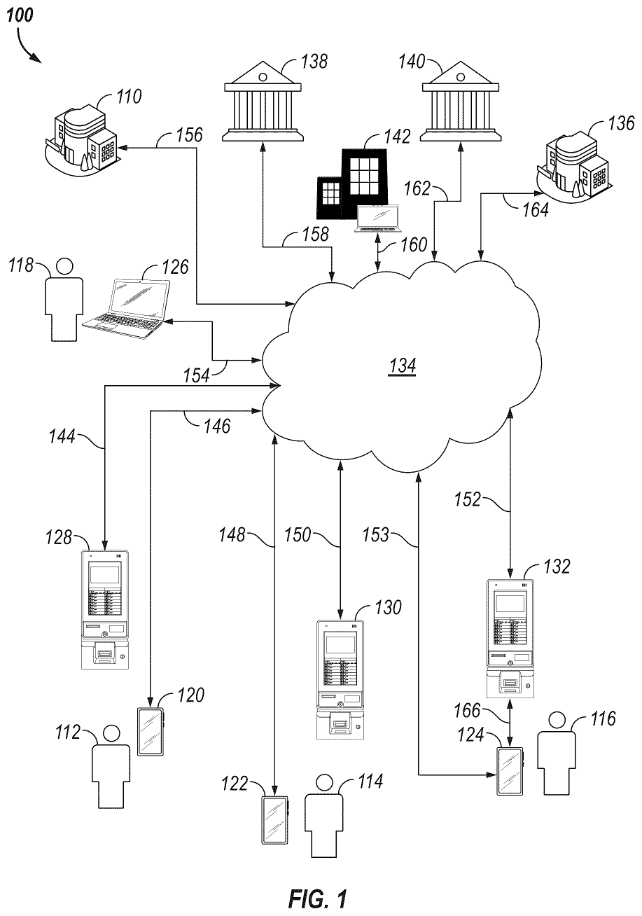

Referring now to FIG. 1, a non-limiting example system 100 for dispensing wager payouts, in accordance with embodiments of the current disclosure, may include a sportsbook 110, one or more users 112, 114, 116, 118 and corresponding user devices 120, 122, 124, 126, one or more item dispensing devices 128, 130, 132; and/or a network 134. In embodiments, the system 100 may further include one or more additional sportsbooks 136; one or more banks 138, 140, and/or a third-party entity 142. The sportsbooks 110, 136, user devices 120, 122, 124, 126, item dispensing devices 128, 130, 132, banks 138, 140, and/or third-party entity 142 may electronically communicate with each other over the network 134 via one or more secure electronic communication channels 144, 146, 148, 150, 152, 153, 154, 156, 158, 160, 162, 164. Non-limiting examples of security features used by the one or more secure electronic communication channels 144, 146, 148, 150, 152, 153, 154, 156, 158, 160, 162, 164 include: IPSec, VPNs, SSL, TLS, Kerberos, AES, RSA, Blowfish, and/or any other technology for mitigating the risk of a non-authorized entity gaining access to data sent in electronic form. In embodiments, one or more of the user devices, e.g., user device 124, may communicate with one or more of the item dispensing devices, item dispensing device 132, via one or more short-range secure electronic communication channels, e.g., secure electronic communication channel 166.

As will be understood, the item dispensing devices 128, 130, 132 may be owned, licensed to, and/or operated by one or more of the banks 138, 140, sportsbooks 110, 136, third-party entity 142, a venue operator, and/or the like. For example, the item dispensing devices 128, 130, 132 may be ATMs owned by a bank 138 and located at a casino, where the casino makes a profit off transactions performed by the ATM. As another example, the item dispensing devices 128, 130, 132 may be owned by a sportsbook 110 and located at a restaurant/bar, where the sportsbook 110 and/or the restaurant/bar owner make a profit off transactions performed at the ATM. While FIG. 1 concerns a sportsbook 110, it is to be understood that the sportsbook may be any type of bookmaker, e.g., an entity that provides for the placing of bets/wagers, such as casino.

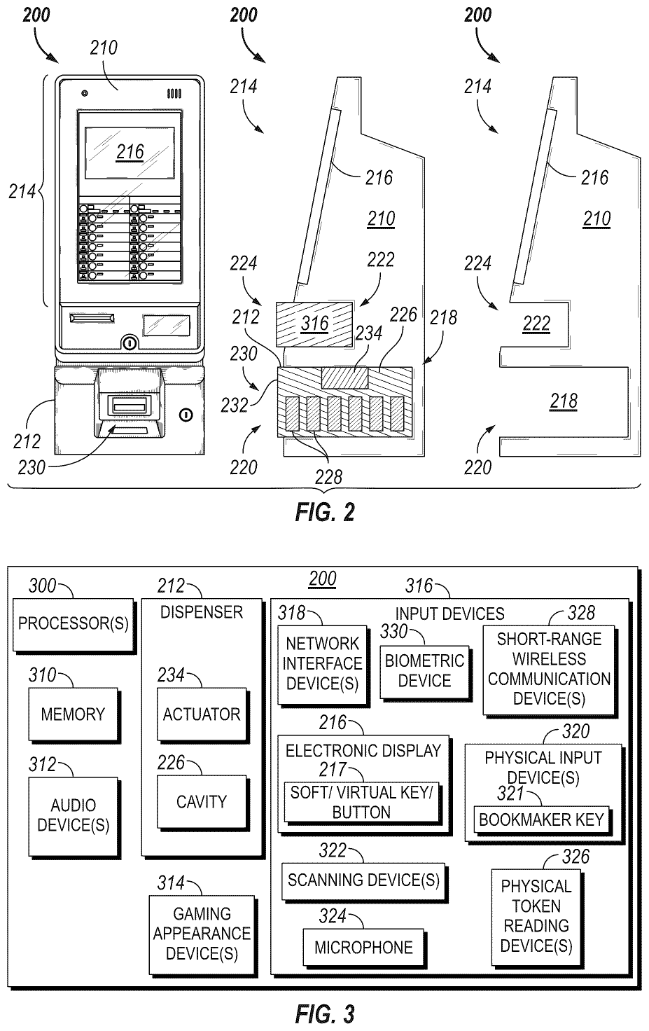

FIG. 2 depicts a non-limiting example of item dispensing device 200 that includes a body 210 and a dispenser 212. The body 210 may be made of metals, plastics, wood, composites, and/or any other material sufficient to support and/or retain the dispenser 212. The body 210 may be weighted to increase the difficulty of moving the body 210, which may help to mitigate theft of the body 210 and/or its contents. In embodiments, the body 210 may constructed in a tamper proof manner to reduce and/or eliminate points of access to the interior of the body 210. The body 210 may include electromagnetic shielding to prevent and/or mitigate the effects of unauthorized electromagnetic waves on one or more electrical components of the body 210, as described herein. Such shielding may include wire meshes, metal foils, and/or any other type of faraday cages and/or wave guides. The body 210 may define a display panel 214 for housing an electronic display 216. The body 210 may have a dispenser cavity 218 and an opening 220.

The body 210 may include one or tamper and/or theft detection devices structured to detect unauthorized electrical and/or physical access and/or an unauthorized attempt to access the interior of the body 210. For example, in embodiments, the body 210 may include one or more trip wires integrated into the body 210, wherein cutting and/or impacting the body 210 in excess of a predefined threshold causes and alarm to sound, flash, and/or be silently transmitted to an entity that oversees, owns, maintains, and/or is at least partly responsible for the item dispensing devices and/or for preventing theft of the item dispensing device, e.g., a security office, the police, etc. In embodiments, the body 210 may be structured to prevent and/or include a sensor to detect the injection of explosive gas into the body 210, and/or an attempt to inject explosive gas into the body 210, wherein such detection may trigger an alarm, as disclosed herein.

As shown in FIG. 2, the opening 220 may connect/open the interior of the cavity 218 to the exterior of the body 210. The body 210 may have one or more additional cavities, e.g., cavity 222, and corresponding openings, e.g., opening 224, that connect/open the cavities 222 to the exterior of the body 210.

The dispenser 212 may include a cavity 226 that stores a plurality it items to be dispensed 228. The plurality of items 228 may include: currencies, gift cards, coupons, casino chips, event tickets, travel vouchers, food items, drinks, vehicles, and/or any other type of item described herein and/or suitable for being dispensed. The dispenser 212 may have a dispensing portion 230 and/or end, from which the items 228 may be dispensed from. In embodiments, the dispenser 212 may be disposed in at least a portion of the dispenser cavity 218. For example, the dispenser 212 may be disposed in the dispenser cavity 218 so the dispensing portion 230 aligns with the opening 220. Aligning of the dispensing portion 230 with the opening 220 may include: an edge 232 of the dispensing portion 230 protruding from the exterior of the body 210; the edge 232 being recessed into the body 210 with respect to the exterior of the body 210, the edge 232 being flush with the exterior of the body 210, and/or any other configuration where the plurality of items 228 can be dispensed from dispenser 212 and physically collected/picked up by a user. In embodiments, the dispenser 212 may include at least one actuator 234 that dispenses one or more of the plurality of items 228 from the cavity 226 through the opening 220 of the body 210. The actuator 234 may include: an electric motor, pneumatics, hydraulics, magnets, and/or any other device and/or technology for moving the plurality of items 228 from the cavity 218 to a location and/or position where the plurality of items 228 can be collected/picked up by a user. In embodiments, the dispenser 212, and/or any of its components, e.g., the cavity 226 and/or actuator 234, may form part of and/or otherwise be integrated into a cassette, such as an ATM cassette, that can be selectively inserted and/or removed from the cavity 218 to reload the item dispensing device 200 with new items for dispensing.

FIG. 3. depicts a block diagram of the item dispensing device 200. As shown in FIG. 3, the item dispensing device 200 may include: one or more processors 300; one or more memory devices 310; one or more audio devices 312, e.g., speakers; one or more gaming appearance devices 314; and/or one or more input devices 316.

The one or more processors 300 may form part of a controller for the item dispensing device 200 and may be in electronic communication with the one or more memory devices 310; the one or more audio devices 312; the one or more gaming appearance devices 314; the one or more input devices 316, and/or any other electronic device disclosed herein. The one or more memory devices 310 may store computer-readable instructions that, when loaded into the one or more processors 300, adapt/configure/cause the one or more processors 300 to perform, one or more of the functions/methods/processes disclosed herein.

The one or more audio devices 312 may be disposed on, in and/or otherwise integrated into the body 210 (FIG. 2) of the item dispensing device 200. In embodiments, one or more of the audio devices 312 may be located apart from the body 210 and placed in electronic communication with the one or more elements/components of the item dispensing device 200 via wired and/or wireless connections. For example, in embodiments, the one or more audio devices 312 may be mounted to a wall of a room in which the item dispensing device is located. In embodiments, the one or more audio devices 312 may from part of an alarm, as disclosed herein, wherein an audio signal and/or message is played over the one or more audio devices 312 upon the detection of a tempering and/or an attempt to tamper with the item dispensing device 200, as disclosed herein. In embodiments, one or more audio messages may be played over the one or more audio devices 312 to a user interacting with the item dispensing device 200.

The one or more gamming appearance devices 314 may include: lights, e.g., incandescent lights, neon lights, light emitting diodes (LEDs), organic light-emitting diodes (OLEDs), and/or the like; electronic displays, e.g., cathode-ray displays; LED displays, OLED displays, plasma displays, and/or the like; mechanical sound devices, e.g., bells, whistles, horns, sirens, and/or the like; mechanical displays, e.g., animatronics, ticker tape, split-flap, flip-disc, vane displays, rollsigns, tactile displays (for enabling communication in brail with a user interacting with the item dispensing device), and/or the like; and/or one or more of the audio devices 312. The one or more gamming appearance devices 314 may be disposed on, in and/or otherwise integrated into the body 210 (FIG. 2) of the item dispensing device 200. In embodiments, one or more gamming appearance devices 314 may be located apart from the body 210 and placed in electronic communication with one or more elements/components of the item dispensing device 200 via wired and/or wireless connections. For example, in embodiments, the one or more gamming appearance devices 314 may be mounted to a wall of a room in which the item dispensing device is located. In embodiments, the one or more gamming appearance devices 314 may from part of an alarm, as disclosed herein, wherein a visual signal and/or message is played over the one or more gamming appearance devices 314 upon the detection of a tempering and/or an attempt to tamper with the item dispensing device 200, as disclosed herein. In embodiments, one or more visual messages may be shown by the one or more gamming appearance devices 314 to a user interacting with the item dispensing device 200.

In embodiments, the one or more gaming devices 314 may be structured/configured to conform the appearance of the item dispensing device 200 to that of a gambling device, e.g., a slot machine, commonly found in many gaming environments, e.g., a casino. For example, the item dispensing device 200 may have one or more lights that flash in a synchronized manner, and/or one or more speakers that play a siren or bell sound, when one or more of the plurality of items 228 are dispensed by the item dispensing device 200, as disclosed herein. In embodiments, the one or more gaming devices 314 may generate one or more attractor signals, e.g., sounds and/or displays structured to draw the attention of individuals, in proximity of the item dispensing device 200, to the item dispensing device. Embodiments of an item dispending device 200 may include one or more gaming devices 314 while not providing and/or enabling any gaming options, e.g., the placing of bets/wagers. Some embodiments of the item dispensing device 200 may provide for gamming options via a graphical user interface shown on the electronic display 216.

The one or more input devices 316 may include: one or more network interface devices 318, one or more physical input devices 320; one or more scanning devices 322; one or more microphones 324; one or more physical token reading devices 326; one or more short-range wireless communication devices 328; and/or one or more biometric devices. One or more of the input devices 316 may be disposed on, in, and/or otherwise integrated into the body 210 (FIG. 2), e.g., housed by cavity 222. One or more of the input devices 316 may be disposed apart from the body 210, e.g., mounted on and/or integrated with an object other than the body 210, and placed in electronic communication with the one or more elements/components of the item dispensing device 200 via wired and/or wireless connections.

The one or more network interface devices 318 may be structured to electronically communicate with one or more devices, e.g., one or more servers, and/or any electronic device disclosed herein, via the network 134 (FIG. 1). The one or more network interface devices 318 may include: ethernet cards, WiFi network cards, cellular network cards, satellite modems and/or network cards, fiber network cards; cable modems, cellular modems, dial-up modems; Digital Subscriber Line (DSL) modems; one or more supporting antennas, and/or any other type of computer networking equipment.

In embodiments, the one or more network interface devices 318 may be structured to communicate based at least in part on at least one of: an ethernet-based protocol, e.g., Ethernet and/or a derivative of Ethernet; a WiFi-based protocol, e.g., WiFi and/or a derivative thereof; an Internet Protocol-based protocol, e.g., Internet Protocol and/or a derivative of Internet Protocol; a cellular protocol, e.g., a protocol structured to provide electronic communications over a cellular network such as Frequency Division Multiplexing (FDM), Time Division Multiplexing (TDM), Code-Division Multiple Access (CDMA), Global System for Mobile Communications (GSM), General Packet Radio (GPRS), Enhanced Data Rates for GSM Evolution (EDGE), Universal Mobile Telecommunications Service (UMTS), High Speed Packet Access (HSPA), Evolution-Data Optimized (EV-DO, EVDO, 1×EV-DO), etc.; a satellite communication-based protocol, e.g., a protocol structured to provide electronic communications over a satellite link; a dial-up connection-based protocol, e.g., a protocol structured to provide electronic communications over a dial-up connection such as Point-to-Point Protocol (PPP), Serial Line Protocol (SLIP), etc.; a cable modem-based protocol, e.g., a protocol structured to provide electronic communications over a cable modem such as Data Over Cable Service Interface Specifications (DOCSIS); a fiber-based protocol, e.g., a protocol structured to provide electronic communications over a fiber-based network such as Synchronous Optical Network (SONET); and/or a DSL-based protocol, e.g., a protocol structured to provide electronic communications over a DSL connection such as Asynchronous Transfer Mode (ATM), Discrete Multitone Modulation (DMT), Trellis-Coded Pulse-Amplitude Modulation (TC-PAM), Carrierless Amplitude Phase Modulation (CAP), Two-Binary, One-Quaternary (2B1Q), etc.

The one or more short-range wireless communication devices 328 may include a wireless communication card that provides for electronic communications over a short-range secure electronic communication channel 166 (FIG. 1) between the item dispensing device 200 and a mobile electronic device 124 (FIG. 1), e.g., a smart phone, a radio-frequency identification (RFID) device, etc. In embodiments, the one or more short-range wireless communication devices 328 may include an infrared (IR) transceiver that provided for a communication link with a smart device and/or a physical token, as disclosed herein. In embodiments, the one or more short-range wireless communication devices 328 may be structured to communicate based at least in part on at least one of: a WiFi-based protocol, e.g., WiFi and/or a derivative thereof; a Bluetooth-based protocol, e.g., Bluetooth or a derivative thereof; a ZigBee-based protocol, e.g., ZigBee and/or a derivative thereof; an IR-based protocol, e.g., Consumer IR (CIR) or a derivative thereof, and/or any other protocol for communicating over an IR channel; or a UWB-based protocol, e.g., UWB and/or a derivative thereof.

The electronic display 216 may be configured by the instructions stored in the one or more memory devices 310 via adapting the one or more processors 300 to display a graphical user interface (GUI), as disclosed herein, and/or a text-based menu structured to interact with a user of the item dispensing device 200. The electronic display 216 may be a single display, as shown in FIG. 2, or it may include multiple electronic displays. The electronic display 216 may be an LED display, an OLED display, a plasma display, a cathode-ray tube display, and/or any other type of electrical display that displays a GUI and/or a text-based menu for interacting with the item dispensing device 200. In embodiments, the electronic display 216 be one of the one or more physical input devices 320, e.g., the electronic display 216 may be a touchscreen.

The one or more physical input devices 320 may include: a keyboard, depressible buttons, touch surfaces, and/or any other type of device that a user can physically interact with to generate input commands.

The one or more scanning devices 322 may include: bar-code scanners, RFID scanners, quick-response (QR) code scanners, laser-based scanners, optical cameras, infrared cameras, and/or any other device that reads-in information printed on an object, shown in an electrical display, and/or stored in a memory device.

The one or more microphones 324 may be used to capture and/or record voice commands by a user interacting with the item dispensing device 200. In embodiments, the recorded voice commands may be saved to memory and/or electronically transmitted via the network interface device 318 to a server and/or database. The one or more microphones 324 may be structured and/or disposed in a location to mitigate and/or cancel out background noise with respect to the voice of a user interacting with the item dispensing device 200. For example, in embodiments, noise cancelling software may be used to reduce and/or eliminate background noise with respect to the voice of a user captured by the one or more microphones 324. As will be appreciated, such background noise cancelling may make the user's voice more clear/understandable in a recording.

The one or more or more physical token reading devices 326 may include: card readers, e.g., ATM card readers, RFID scanners, and/or any other type of device for reading data from a physical token, e.g., an object whose possession provides a level of authentication. In embodiments, a token may be a branded card issued by a sportsbook or a fantasy operator to a user. As will be understood, the issuance of such a branded card provides for the placement of a brand in physical form in the player's pocket, which may provide assurance that winnings in the form of cash can be withdrawn conveniently at an item dispensing device, e.g., an ATM. In embodiments, a user may have a card, e.g., a bank ATM card, or sportsbook card, gift card, etc., “refilled” as the payout instead of taking one or more of the items 228, e.g., cash.

The one or more biometric devices 330 may be structured to generate biometric data corresponding to a user interacting with the item dispensing device 200. The one or more biometric devices 330 may include: a face scanner, a fingerprint and/or thumb print scanner, a deoxyribonucleic acid (DNA) scanner; a voice scanner (which may be integrated with and/or include the one or more microphones 324); a retina scanner; an iris scanner; a heart-rate scanner; and/or the like.

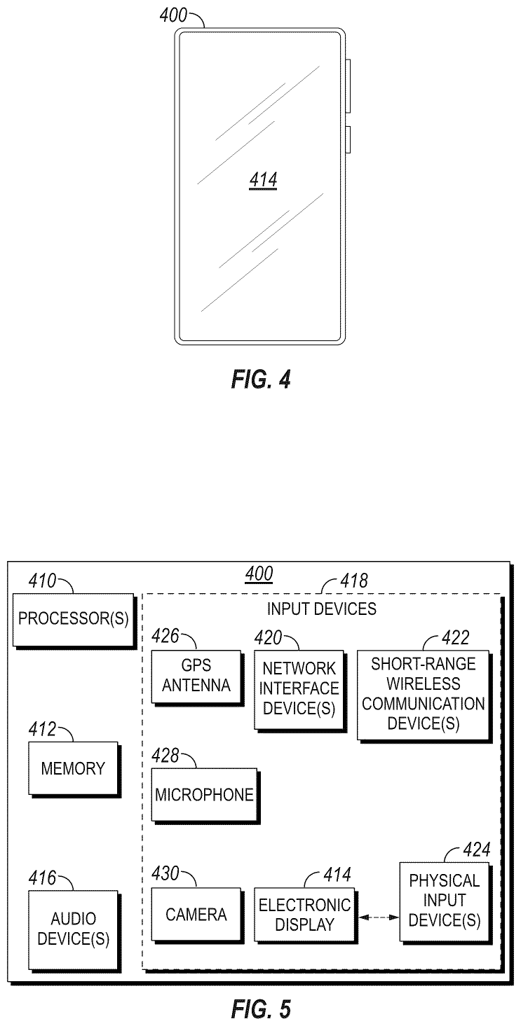

FIGS. 4 and 5 respectively depict an example user device 400 and a corresponding block diagram of the same. While FIG. 4 depicts the user device 400 in the form of a smart phone, it is to be understood that the user device 400 may take the form of any type of mobile electronic device, such as tablets, smartwatches, an infotainment system in a vehicle (which may interact with a drive-through ATM), and/or the like. Embodiments of the user device 400 may include: one or more processors 410; one or more memory devices 412; an electronic display 414; one or more audio devices 416, e.g., speakers; and/one or more input devices 418.

The one or more processors 410 may form part of a controller for the user device 400 and may be in electronic communication with the one or more memory devices 412; the electronic display 414, the one or more audio devices 416, the one or more input devices 418, and/or any other electronic device disclosed herein. The one or more memory devices 412 may store computer-readable instructions that, when loaded into the one or more processors 410, adapt/configure/cause the one or more processors 410 to perform, one or more of the functions/method/processes disclosed herein.

The one or more input devices 418 include: one or more network interface devices 420; one or more short-range wireless communication devices 422; one or more physical input devices 424; one or more location detection devices 426; one or more microphones 428; and/or one or more scanning devices 430.

The one or more network interface devices 420 may be structured to electronically communicate with one or more devices, e.g., one or more servers, item dispensing devices, and/or any electronic device disclosed herein, via the network 134 (FIG. 1). The one or more network interface devices 420 may include: ethernet cards, WiFi network cards, cellular network cards, cellular modems, satellite modems and/or network cards, one or more supporting antennas, and/or any other type of computer networking equipment.

In embodiments, the one or more network interface devices 420 may be structured to communicate based at least in part on at least one of: an ethernet-based protocol, e.g., Ethernet and/or a derivative of Ethernet; a WiFi-based protocol, e.g., WiFi and/or a derivative thereof; an Internet Protocol-based protocol, e.g., Internet Protocol and/or a derivative of Internet Protocol; a cellular protocol, e.g., a protocol structured to provide electronic communications over a cellular network such as Frequency Division Multiplexing (FDM), Time Division Multiplexing (TDM), Code-Division Multiple Access (CDMA), Global System for Mobile Communications (GSM), General Packet Radio (GPRS), Enhanced Data Rates for GSM Evolution (EDGE), Universal Mobile Telecommunications Service (UMTS), High Speed Packet Access (HSPA), Evolution-Data Optimized (EV-DO, EVDO, 1×EV-DO), etc.; a satellite communication-based protocol, e.g., a protocol structured to provide electronic communications over a satellite link; and/or the like.

The electronic display 414 may be configured by the instructions stored in the one or more memory devices 412 via adapting the one or more processors 410 to display a graphical user interface (GUI), as disclosed herein, and/or a text-based menu structured to interact with a user. The electronic display 414 may be a single display, as shown in FIG. 4, or it may include multiple electronic displays. The electronic display 414 may be an LED display, an OLED display, a plasma display, a cathode-ray tube display, and/or any other type of electrical display that displays a GUI and/or a text-based menu for interacting with the user device 400. In embodiments, the electronic display 414 may be one of the one or more physical input devices 424, e.g., the electronic display 414 may be a touchscreen.

The one or more short-range wireless communication devices 422 may include a wireless communication card that provides for electronic communications over a short-range secure electronic communication channel 166 (FIG. 1) between the user device 400 and an item dispensing device, a radio-frequency identification (RFID) device, and/or the like. In embodiments, the one or more short-range wireless communication devices 422 may include an infrared (IR) transceiver that provides for a communication link with a smart device and/or a physical token, as disclosed herein. In embodiments, the one or more short-range wireless communication devices 422 may be structured to communicate based at least in part on at least one of: a WiFi-based protocol, e.g., WiFi and/or a derivative thereof; a Bluetooth-based protocol, e.g., Bluetooth or a derivative thereof; a ZigBee-based protocol, e.g., ZigBee and/or a derivative thereof; an IR-based protocol, e.g., Consumer IR (CIR) or a derivative thereof, and/or any other protocol for communicating over an IR channel; or a UWB-based protocol, e.g., UWB and/or a derivative thereof.

The one or more physical input devices 424 may include: a keyboard; push buttons; touch surfaces; the electronic display 414 (when in the form of a touchscreen); and/or the like.

The location detection device 426 may include: a Global Positioning System (GPS) antenna; a WiFi antenna; and/or any device suitable for determining a location of the user device 400.

The one or more scanning devices 430 may include: bar-code scanners, RFID scanners, quick-response (QR) code scanners, laser-based scanners, optical cameras, infrared cameras, and/or any other device that reads-in information printed on an object, shown in an electrical display, and/or stored in a memory device. In embodiments, the one or more scanning deiced may include one or more biometric devices, as disclosed herein, e.g., a face scanner, an iris scanner, a retina scanner, a DNA scanner, a fingerprint and/or thumbprint scanner, etc. In embodiments, an application executing on the one or more processors 410 may be structured/configured to provide for a user-lock-out feature where one or more functions of the user device 400, as disclosed herein, are locked-out, e.g., non-selectable by a user, unless the user unlocks the user device, e.g., entering a pin on a touchscreen, providing a thumbprint, fingerprint, voice sample, etc. As will be appreciated, such lock-out and/or unlocking features may mitigate the risk of an unauthorized person using the user device 400 to request and/or receive a payout. For example, the lock-out feature may prevent and/or impede a thief from using a stolen user device 400, in accordance with embodiments of the current disclosure, to steal a payout corresponding to the true owner of the solen user device 400.

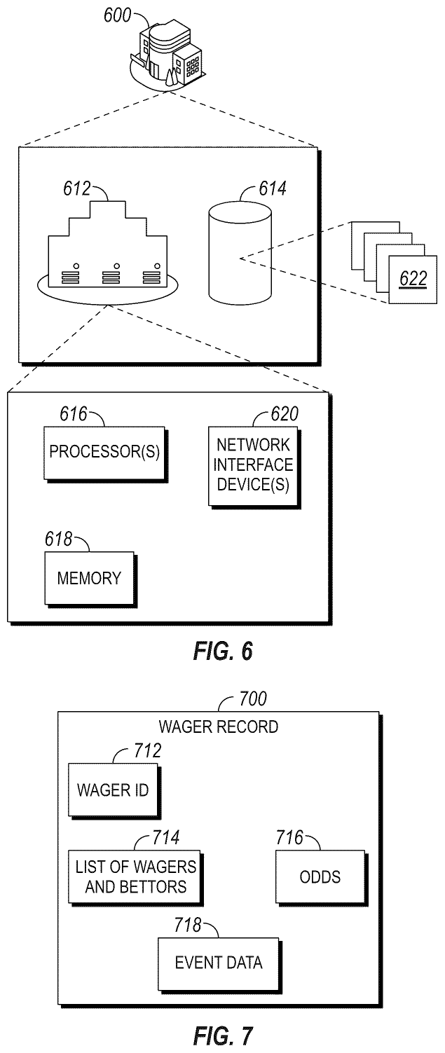

FIG. 6 illustrates an embodiment, in accordance with the current disclosure, of a sportsbook 600 that may operate, own, license, and/or otherwise be affiliated with and/or correspond to: one or more servers 612, e.g., sportsbook servers; and/or one or more databases 614. The sportsbook 600 may provide/offer and/or track one or more wagers made by bettors, e.g., users 112, 114, 116, and/or 118 (FIG. 1), against the sportsbook and/or against other users. In embodiments, the one or more wagers may correspond to: a sporting event; a political election; or a user defined event. Non-limiting examples of sporting events include: the outcome of a game/contest between opposing teams; the number of points scored by a team and/or a player during an entire contest/game and/or a subdivision of a contest/game, e.g., a half, quarter, etc.; the number of points scored by a team and/or a player during an entire season and/or a subdivision of a season, e.g., a half, quarter, etc.; the number of points scored by a team and/or a player during playoffs; the spread of points between two competing teams; the drafting of a player to a team; the trading of a player to a team; an injury status of a player; a suspension status of a player; and/or the like. Non-limiting examples of political elections include: outcomes of local government elections, national/federal government elections, corporate elections, and/or the like. Non-limiting examples of user defined events include: weather events, e.g., whether it will rain on Tuesday; answers to trivia questions; outcomes of non-professional and/or non-collegiate sporting events, such as a road race between friends; and/or any other type of event that can serve as the basis of a wager.

The one or more servers 612 may include one or more processors 616, one or more memory devices 618, and/or one or more network interface devices 620. The one or more processors 616 may be in electronic communication with the one or more memory devices 618, the one or more network interface devices 620, the one or more databases 614, and/or another other electrical device disclosed herein, e.g., a user device and/or an item dispensing device. The one or more memory devices 618 may store instructions that adapt/configure/cause the one or more processors to perform one or more of the methods/functions/processes disclosed herein. The one or more network interface devices 620 may be structured to electronically communicate via the network 134 with one or more servers, one or more item dispensing devices, one or more user devices, and/or any other electrical device disclosed herein.

The one or more databases 614 may include: a wager databases structured to track wagers and corresponding winnings and losses for one or more users who made/accepted the wagers; an offer database structured to store offer data related to offers for open wagers, e.g., wagers that can still be accepted/made, and/or the like; and/or a user account database structured to store data corresponding to a user/bettor, to include data regarding an amount of money the user has deposited with the sportsbook, to include money the user has won from wagers placed with the sportsbook. In embodiments, offers may have corresponding text and/or audio messages, e.g., “Congratulations, BUT WAIT! . . . ”. Such text and/or audio messages and/or in combination with a new wager may be structured to induce a user to not withdraw their payout. Such offers may prompt a user to make further bets on their mobile device, which may mitigate the risk of an offer for a wager being illegal in a particular location, e.g., city, county, state, country, etc. The one or more databases 614 may store data in one or more records 622. In embodiments, the sportsbook 600 may interact with one or more banks 138, 140 (FIG. 1), via the one or more network interface devices 620, to transfer funds between a user/bettor's bank account and the user/bettor's deposit account with the sportsbook 600.

Illustrated in FIG. 7 is a non-limiting example of a wager record 700 that may be stored in the one or more database 614 (FIG. 6) for tracking a wager. The wager record 700 may include a wager ID 712 corresponding to a wager; a listing 714 of user IDs (corresponding to users who have accepted/made the wager corresponding to the wager ID 712) paired to placed bets, e.g., an amount of money being risked on the wager by the user corresponding to the user ID; odds data 716 that corresponds and/or represents the odds associated with the wager corresponding to the wager ID 712; event data 718 corresponding to and/or representative of the event(s) for the wager corresponding to the wager ID 712; and/or other data suitable for recording and/or tracking the status of the wager corresponding to the wager ID 712. In embodiments, the listing 714 may further pair winner and/or looser indicators to the user IDs to track whether a bet by a particular user won or lost.

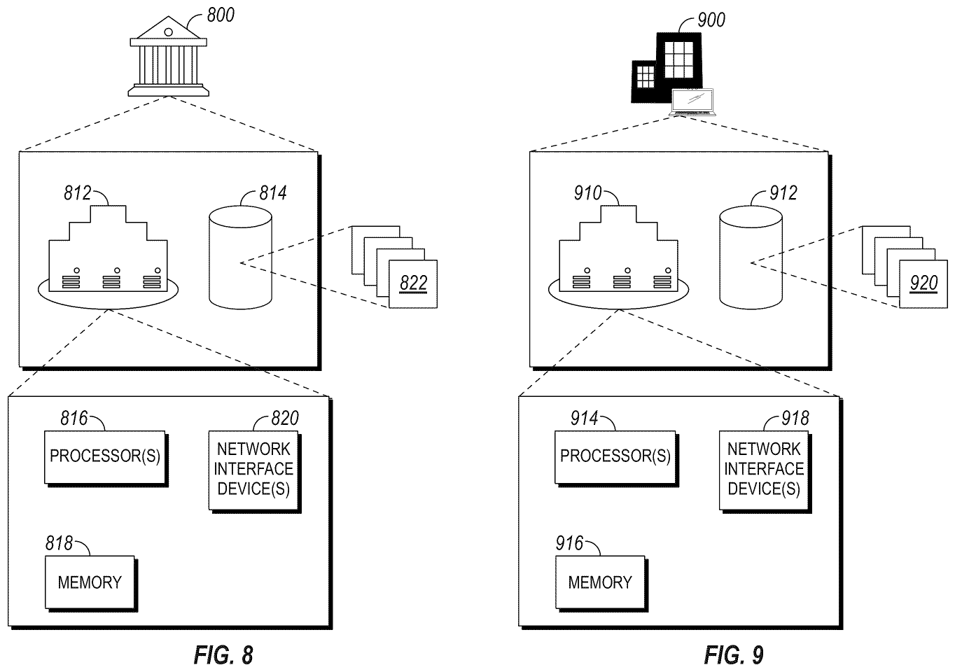

FIG. 8 depicts a bank 800, in accordance with embodiments of the current disclosure. The bank 800 may operate, own, license, and/or otherwise be affiliated with and/or correspond to: one or more servers 812, e.g., banking servers; and/or one or more databases 814. The one or more servers 812 may include one or more processors 816, one or more memory devices 818, and/or one or more network interface devices 820. The one or more memory devices 818 may store computer-readable instructions that adapt/configure/cause the one or more processors 816 to perform one or more of the methods/functions/processes disclosed herein. The one or more network devices 820 may be structured to electronically communicate via the network 134 with one or more other devices disclosed herein, e.g., user devices, sportsbook servers, item dispensing devices, and/or any other electronic device disclosed herein. The one or more databases 814 may include a plurality of records 822 that store banking data for the one or more users 112, 114, 116, 118 (FIG. 1), the one or more sportsbooks 110, 136, and/or the third-party entity 142 (FIG. 1). In embodiments, the one or more sportsbook servers, one or more third-party entity servers, user device, item dispensing device, and/or the corresponding apparatuses and/or methods disclosed herein, may request and/or require approval/permission from the bank 800 in order to execute a payout to a user. Such approval and/or permission may be obtained via the exchange of verification data between the one or more sportsbook servers, one or more third-party entity servers, user device, item dispensing device, and/or the corresponding apparatuses and/or methods disclosed herein, and the one or more bank servers 812.

Illustrated in FIG. 9 depicts a non-limiting example of a third-party entity 900, in accordance with embodiments of the current disclosure. The third-party entity 900 may operate, own, license, and/or otherwise be affiliated with and/or correspond to: one or more servers 910, e.g., third-party servers; and/or one or more databases 912. The one or more servers 910 may include one or more processors 914, one or more memory devices 916, and/or one or more network interface devices 918. The one or more databases 912 may store a plurality of records 920. The one or more processors 914 may be in electronic communication with the one or more memory devices 916, the one or more network interface devices 918, the one or more databases 912. The one or more memory devices 916 may store computer-readable instructions that adapt/configure/cause the one or more processors 914 to perform one or more of the functions/methods/processes disclosed herein. The one or more network interface devices 918 may be structured to electronically communicate with the one or more user devices 120, 122, 124, 126, the one or more banks 138, 140, the one or more sportsbooks, 110, 126, one or more item dispensing devices, and/or any other electrical device disclosed herein.

In embodiments, the third-party entity 900 may act as an intermediate party for electronic communications and/or fund (money) transfers between one or more of: the one or more sportsbooks 110, 136; the one or more users 112, 114, 116, 118; the one or more item dispensing devices 128, 130, 132; and/or the one or more banks 138, 140. The third-party entity 900 may also provide for maintenance and/or reloading of the item dispensing devices.

As will be understood, one or more of the apparatuses disclosed herein may transmit and/or exchange one or more verification data for the purpose of verifying the identity of and/or the permissions of one or more of a user, a user device, an item dispensing device, a server, and/or other entities and/or individuals. For example, verification data may be used by a server to confirm, verify, and/or determine: the identity and/or location of a user requesting a payout and/or whether the user is entitled to a payout; the identify and/or location of an item dispensing device and/or whether the item dispensing device is authorized to dispense a payout; whether an application executing on a user device requesting a payout is authentic, e.g., approved by a sportsbook; and/or the like.

Verification data may be used by a user device to confirm, verify, and/or determine: the identity and/or permissions of an item dispensing device; whether an item dispensing device is authorized to provide a payout; the identity and/or permissions of a server; the identity and/or permissions of a user interacting with the user device, and/or the like. Verification data may include data used by a user to unlock a user device, as disclosed herein, e.g., a pin, biometric data, password, etc. Verification data may be used by an item dispensing device to confirm, verify, and/or determine: the identity and/or permissions of a server; the identity and/or permissions of a user device; the identity and/or permissions of a user; and/or the like. In embodiments, verification data may include token data, biometric data, location data, user identification data, user security credential data, user device identification data, user device security credential data, item dispensing device identification data, item dispensing device security credential data, server identification data, sever security credential data, application identification data, application security credential data, bank identification data, bank security credential data, sportsbook identification data, sportsbook security credential data, and/or the like.

In embodiments, an instance of verification data may be based at least in part on and/or derived from another instance of verification data. For example, a first instance of verification data may be and/or include an encryption hash generated from a second instance of verification data, wherein the hash can be used to determine that the first instance of verification data was based at least in part on and/or derived from the second instance of verification data. Verification data may also include shared security keys, e.g., cryptographic keys. Verification data may include challenge and/or response data, e.g., a security question with a pre-defined acceptable response.

In embodiments, the one or more servers, user device, user, item dispensing device, and/or any other device and/or entity disclosed herein, may exchange a sequence of verification data exchanges, e.g., first verification data, second verification data, third verification data, fourth verification data, etc. to verify, authorize, and/or otherwise facilitate a payout.

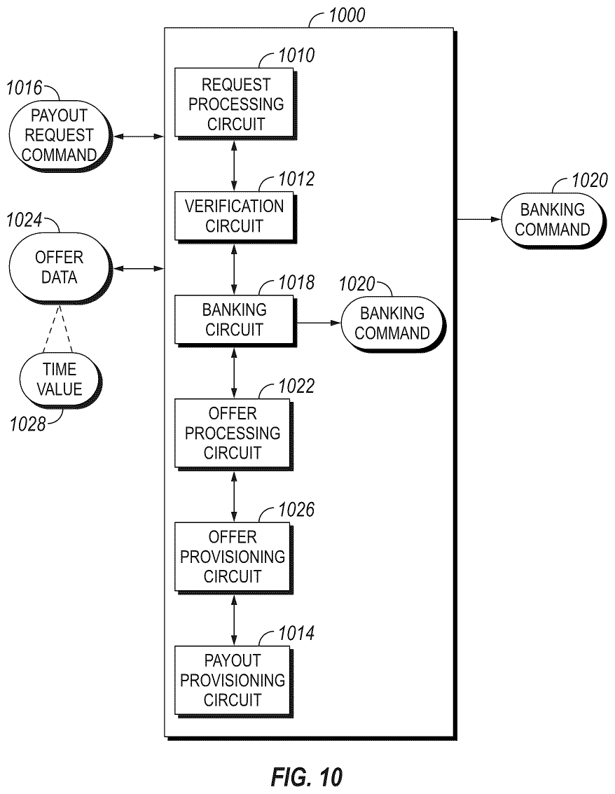

FIG. 10 depicts an apparatus 1000 for dispensing wager payouts, in accordance with embodiments of the current disclosure. The apparatus 1000 may form part of an item dispensing device 128, 130, 132 (FIG. 1), 200 (FIGS. 2 and 3), e.g., the apparatus 1000 may take the form of the one or more processors 300 (FIG. 3), and/or form part of any other computing/electronic device disclosed herein. A non-limiting use case for apparatus 1000 includes an ATM with a menu option to request a payout from a sportsbook account, where the ATM depicts a QR code. The user scans the QR code into an application executing on their smart phone, and the application transits the QR code to a remote sportsbook server that interacts with the smart phone and ATM to verify that the user is authorized is receive the payout and/or that the ATM is a known ATM which is trusted by the sportsbook. Upon verifying the user and/or the ATM, the server approves the payout to the user at the ATM. Another non-limiting use case for the apparatus 1000 may be where the user authenticates themselves in an application executing on their smart phone, and the application generates a QR code to be scanned by the ATM to provide for user and/or ATM verification by a remote sportsbook server. Upon verifying the user and/or the ATM, the server approves the payout to the user at the ATM. As will be understood, the verification checks disclosed herein may be performed by: a remote server, a user device, and/or an item dispensing device.

The apparatus 1000 may include a request processing circuit 1010, a verification circuit 1012, and a payout provisioning circuit 1014. The request processing circuit 1010 is structured to interpret a payout request command generated 1016 by a user, e.g., user 112 (FIG. 1), and corresponding to a payout for one or more wagers made by the user. The verification circuit 1012 is structured to, in response to the payout request command 1016, determine that the user is authorized to receive the payout. The verification circuit 1012 may use one or more of the processes disclosed herein for: verifying that the user is authorized to receive the payout; and/or that an item dispensing device is authorized to dispense the payout to the user. The payout provisioning circuit 1014 is structured to, in response to determining that the user is authorized to receive the payout, cause a dispenser, e.g., 212 (FIGS. 2 and 3), to dispense, via an actuator 234 (FIGS. 2 and 3), an amount of a plurality of items 228 (FIG. 2) corresponding to the payout.

In embodiments, the apparatus 1000 may further include a banking circuit 1018 structured to generate and transmit, via one or one or more secure electronic communication channels, e.g., 144, 150, 152 (FIG. 1), a banking command 1020 to a bank server, e.g., 812 (FIG. 8). The banking command 1020 may be structured to execute one or more of: a withdraw of funds by the user from an account at the bank 800; a deposit to an account at the bank 800; a checking of a balance of an account at the bank 800; and/or any other type of banking related process/method that can be performed remotely, e.g., from an ATM. In embodiments, the banking circuit 1018 may be structured to display a graphical user interface on an electronic display, e.g., 216 (FIGS. 2 and 3), to provide for the user to configure the banking command 1020, e.g., select an ATM function such as withdraw funds, and/or to interpret and display data transmitted from the bank server 812 to the apparatus 1000.

In embodiments, the apparatus 1000 may further include an offer processing circuit 1022 structured to interpret offer data 1024 corresponding to an offer for the user to make a new wager. The offer data 1024 may be from a sportsbook database, e.g., 614 (FIG. 6). The apparatus 1000 may further include an offer provisioning circuit 1026 structured to display, based at least in part on the offer data 1024, the offer on the electronic display, e.g., 216 (FIGS. 2 and 3) prior to dispensing of the amount of the plurality of items, e.g., 228 (FIGS. 2 and 3). In embodiments, the new wager has at least one of: an enhancement over the one or more wagers; an improved spread over the one or more wagers; or improved odds over the one or more wagers. As will be understood, the new wager may be structured to entice the user to not cash-out their winnings and, instead, risk a portion of their winnings on the new wager. In embodiments, the offer data 1024 includes a time value 1028 corresponding to a time period during which the offer can be accepted by the user, and the offer provisioning circuit 1026 is further structured to display the offer on the electronic display based at least in part on the time value 1028. For example, a user may be seeking to obtain a payout for a first horse race and the offer data 1024 may be for a second horse race that starts in the next five (5) minutes, where the time value 1028 is the start time of the second horse race and causes the offer to be shown to the user if the user still as time to make a wager on the second horse race before it starts. In embodiments, the offer provisioning circuit 1026 is further structured to display the offer during the time period corresponding to the time value. For example, the offer data 1024 may be for a wager for the winning team in a baseball game where the time value 1028 indicates the wager can only be made during the baseball game. In such a scenario, the offer provisioning circuit 1026 may display the offer while the baseball game is occurring.

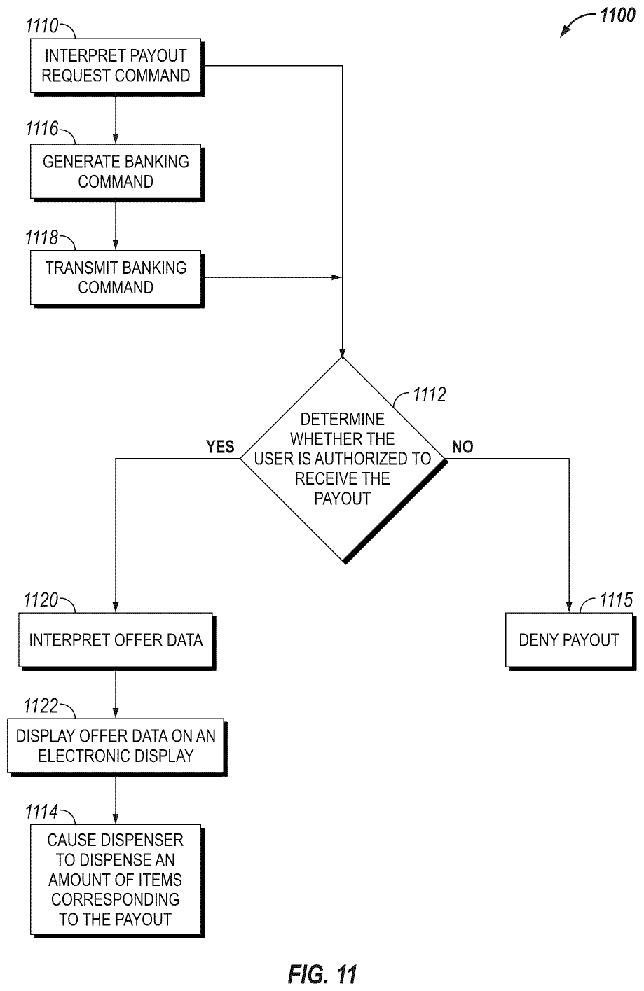

FIG. 11 depicts a method 1100 dispensing wager payouts. The method 1100 may be performed by the apparatus 1000 (FIG. 10), an item dispensing device, e.g., 144, 150, 152 (FIG. 1), 200 (FIGS. 2 and 3), and/or any other computing device disclosed herein. The method 1100 includes interpreting 1110, at an apparatus, e.g., 200, for dispensing the wager payouts, a payout request command generated by a user, the payout request command corresponding to a payout for one or more wagers made by the user. The method 1100 further includes, in response to the payout request command, determining 1112, at the apparatus for dispensing the wager payouts, that the user is authorized to receive the payout. The method 1100 further includes, in response to determining 1112 that the user is authorized to receive the payout, causing 1114 a dispenser, e.g., 212 (FIGS. 2 and 3), of the apparatus for dispensing wager payouts, to dispense, via an actuator, e.g., 234 (FIGS. 2 and 3) of the apparatus for dispensing the wager payouts, an amount of a plurality of items, e.g., 228 (FIG. 2), corresponding to the payout. If the user is determined 1112 to not be authorized to receive the payout, the user is denied 1115 the payout.

In embodiments, the method 1100 further includes: generating 1116, at the apparatus, e.g., 200 (FIG. 2), for dispensing the wager payouts, a banking command; and transmitting 1118, from the apparatus for dispensing the wager payouts via one or more secure electronic communication channels, e.g., 144, 150, 152 (FIG. 1), the banking command to a bank server, e.g., 812 (FIG. 8). The banking command may be any type of banking command disclosed herein.

In embodiments, the method 1100 may further include: interpreting 1120, at the apparatus, e.g., 200 (FIG. 2), for dispensing the wager payouts, offer data corresponding to an offer for the user to make a new wager; and displaying 1122 on an electronic display, e.g., 216 (FIGS. 2 and 3), of the apparatus for dispensing the wager payouts, and based at least in part on the offer data, the offer prior to dispensing of the amount of the plurality of items. The offer data may be from a sportsbook database 614 (FIG. 6) and correspond to any type of wager disclosed herein. In embodiments, the offer data includes a time corresponding to a time period during which the offer can be accepted by the user; and displaying 1122 the offer is performed during the time period.

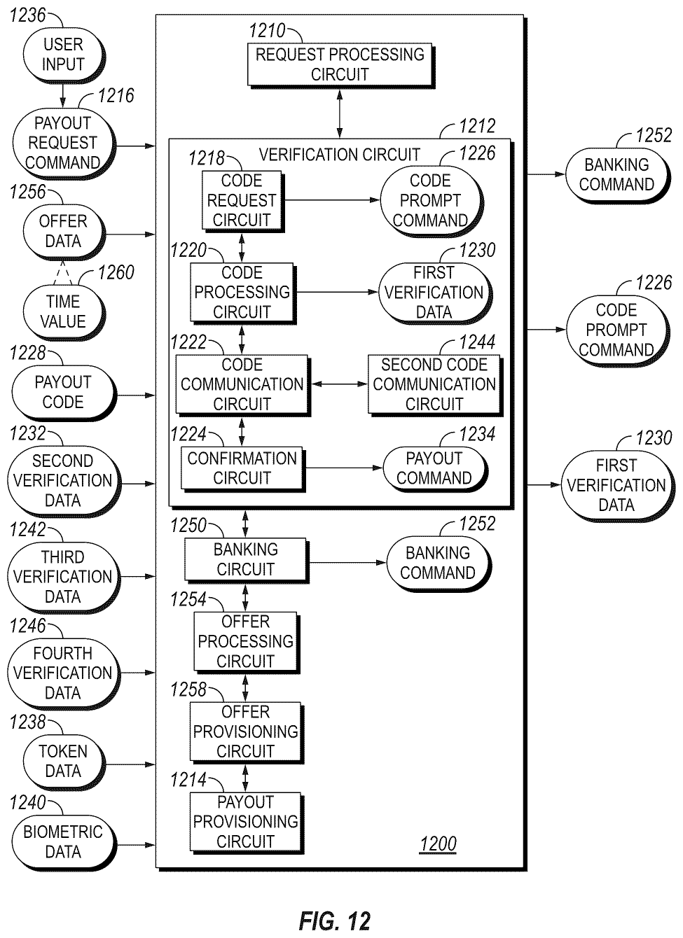

FIG. 12 depicts an apparatus 1200 for dispensing wager payout, in accordance with an embodiment of the current disclosure. The apparatus 1200 may form part of an item dispensing device 128, 130, 132 (FIG. 1), 200 (FIGS. 2 and 3), e.g., the apparatus 1200 may take the form of the one or more processors 300 (FIG. 3), and/or form part of any other computing/electronic device disclosed herein. A non-limiting use case for the apparatus may be where an ATM provides a QR code to be scanned in by a smart phone, where an application on the smart phone interprets and uses the data encoded in the QR code to verify the ATM with a sportsbook server. Upon verification of the ATM, the application and/or the server approves the ATM for executing the payout.

Accordingly, the apparatus 1200 includes a request processing circuit 1210, a verification circuit 1212, and a payout provisioning circuit 1214.

The request processing circuit 1210 is structured to interpret a payout request command 1216 initiated by a user and corresponding to a payout for one or more wagers made by the user.

The verification circuit 1212 includes: a code request circuit 1218; a code processing circuit 1220; a code communication circuit 1222; and a confirmation circuit 1224. The code request circuit 1218 is structured to, in response to the payout request command 1216, generate and transmit a code prompt command 1226 structured to generate a prompt for a payout code 1228 to be provided for read-in via a payout code scanner, e.g., 322 (FIG. 3). The code processing circuit 1220 is structured to, in response to the payout code scanner reading-in the payout code 1228, interpret the payout code 1228 and generate first verification data 1230 based at least in part on the payout code 1228. The first verification data 1230 may include the payout code 1228, data generated/derived from the payout code 1228, and/or data demonstrating that the payout code was received. The code communication circuit 1222 is structured to: transmit, via one or more secure electronic communication channels, e.g., 144, 150, 152 (FIG. 1), the first verification data 1230 to one or more servers, e.g., servers 612 (FIG. 6), and in response to transmitting the first verification data 1230, interpret second verification data 1232 transmitted from the one or more servers via the one or more secure electronic communication channels. In embodiments, the second verification data 1232 may be generated/derived from the first verification data 1230 and/or include an indicator that the user is authorized to receive the payout. For example, the payout code 1228 may have been generated by the one or more servers and provided to the user, where the first verification data 1232 provides for the one or more servers to identify the user and/or which item dispensing device the user is attempting to collect their payout from. The one or more servers may check the identified item dispensing device against a list of approved item dispensing devices and generate the second verification data 1232 if the identified dispensing device is on the list. The confirmation circuit 1224 is structured to determine, based at least in part on the second verification data 1232, that the user is authorized to receive the payout and, if the user is determined to be authorized to receive the payout, generate a payout command 1234.

The payout provisioning circuit 1214 is structured to cause, in response to the payout command 1234, a dispenser, e.g., 212 (FIGS. 2 and 3) to dispense, via an actuator, e.g., 234 (FIGS. 2 and 3), an amount of a plurality of items, e.g., 228 (FIG. 2), corresponding to the payout.

In embodiments, the payout code 1228 includes: a quick response code; a bar code; alphanumeric characters, and/or any other type of encoded information disclosed herein.

In embodiments, an input device, e.g., 316 (in FIG. 3) may be structured to receive the payout request command 1216 and transmit the payout request command 1216 to the request processing circuit 1210. For example, the input device 316 may include a network interface device 318 (FIG. 3); or a short-range wireless communication device 328 (FIG. 3). For example, a user's phone may generate a payout request command that is then transmitted from the user's phone to the item dispensing device via over the network 134 (FIG. 1) and/or over a short-range secure electronic communication channel 166 (FIG. 1).

In embodiments, an input device, e.g., 316 (FIG. 3), may be structured to receive a user input 1236 and, in response to the user input 1236, generate the payout request command 1216. In embodiments, the input device 316 includes: a physical button such as a bookmaker and/or sportsbook specific button/key 321 (FIG. 3), and/or an electronic display, e.g., 216 (FIGS. 2 and 3), having a virtual button 217. The virtual button 217 may include the logo and/or other branding of a sportsbook. As a non-limiting example, a user may select a “payout” option on a graphical user interface of an ATM machine, where selection of “payout” generates the payout request command 1216.

In embodiments, a physical token reading device 326 (FIG. 3) may be structured to: interpret token data 1238 from a physical token device, and transmit the token data 1238 to the confirmation circuit 1224. In such embodiments, the confirmation circuit 1224 may be further structured to determine that the user is authorized to receive the payout based at least in part on the token data 1238. As a non-limiting example, an ATM may ask a user to insert a card, (e.g., a sportsbook card, bank ATM card, etc.) as an additional verification process.

In embodiments, a biometric device 330 (FIG. 3) may be structured to: generate biometric data 1240 corresponding to the user and transmit the biometric data 1240 to the confirmation circuit 1224. In such embodiments, the confirmation circuit 1224 is further structured to determine that the user is authorized to receive the payout based at least in part on the biometric data 1240. As will be appreciated, the use of biometric data may be additional verification process. For example, interpretation of a payout request command may cause an ATM to take a picture of the user's face for verification by the ATM, and/or the one or more servers, prior to dispensing the payout.

In embodiments, an input device 316 may be structured to interpret third verification data 1242 from at least one of: a user device, e.g., 120, 112, 124, 126 (FIG. 1), 200 (FIG. 2), corresponding to the user, or from the user, e.g., the user may enter information corresponding to the third verification data 1242 on a keyboard, e.g., 320. In such embodiments, the confirmation circuit 1224 is further structured to determine that the user is authorized to receive the payout further based at least in part on the third verification data 1242. Non-limiting examples of the third verification data 1242 include pins, passwords, one-time codes, etc.

In embodiments, the verification circuit 1212 further includes a second code communication circuit 1244 structured to interpret fourth verification data 1246 transmitted by the one or more servers 612 (FIG. 6) via the one or more secure electronic communication channels. In such embodiments, the confirmation circuit 1224 is further structured to determine that the user is authorized to receive the payout further based at least in part on comparing the third verification data 1242 to the fourth verification data 1246. The confirmation circuit 1224 may be further structured to determine that the user is authorized to receive the payout if the third verification data 1242 matches the fourth verification data 1242, e.g., the third verification data 1242 and the fourth verification data 1246 may be a one-time-use code transmitted by the sportsbook 600 to the user (or their smartphone) and to the item dispensing device. In embodiments, the third verification data 1242 and the fourth verification data 1246 may function as a challenge and response, where either the confirmation circuit 1224 is able to use the fourth verification data 1246 to determine that the user received the third verification data 1242 from the one or more servers. For example, in embodiments, the third verification data 1242 and the fourth verification data 1246 may be a one-time access code and/or a hash, as disclosed herein, transmitted by the one or more server.

In embodiments, the code prompt command 1226 is structured to display the prompt as a visual message via an electronic display, e.g., 216 (FIGS. 2 and 3) and/or 414 (FIGS. 4 and 5); and/or the code prompt command is structured to play the prompt as an audio message over an audio device, e.g., 312 (FIG. 3) and/or 416 (FIG. 5).

In embodiments, the apparatus 1200 further includes a banking circuit 1250 structured to generate and transmit, via the one or more secure electronic communication channels, e.g., 144, 150, 152, a banking command 1252 to a bank server 812 (FIG. 8). The banking command 1252 may be any type of banking command disclosed herein.

In embodiments, the apparatus 1200 further includes: an offer processing circuit 1254 structured to interpret offer data 1256 corresponding to an offer for the user to make a new wager, as disclosed herein; and an offer provisioning circuit 1258 structured to display, based at least in part on the offer data, the offer on an electronic display, e.g., 216 (FIGS. 2 and 3) and/or 414 (FIGS. 4 and 5) prior to dispensing of the amount of the plurality of items. The new wager may be any type of wager disclosed herein. In embodiments, the offer data 1256 includes a time value 1260 corresponding to a time period during which the offer can be accepted by the user; and the offer provisioning circuit 1258 is further structured to display the offer on the electronic display based at least in part on the time value, as disclosed herein.

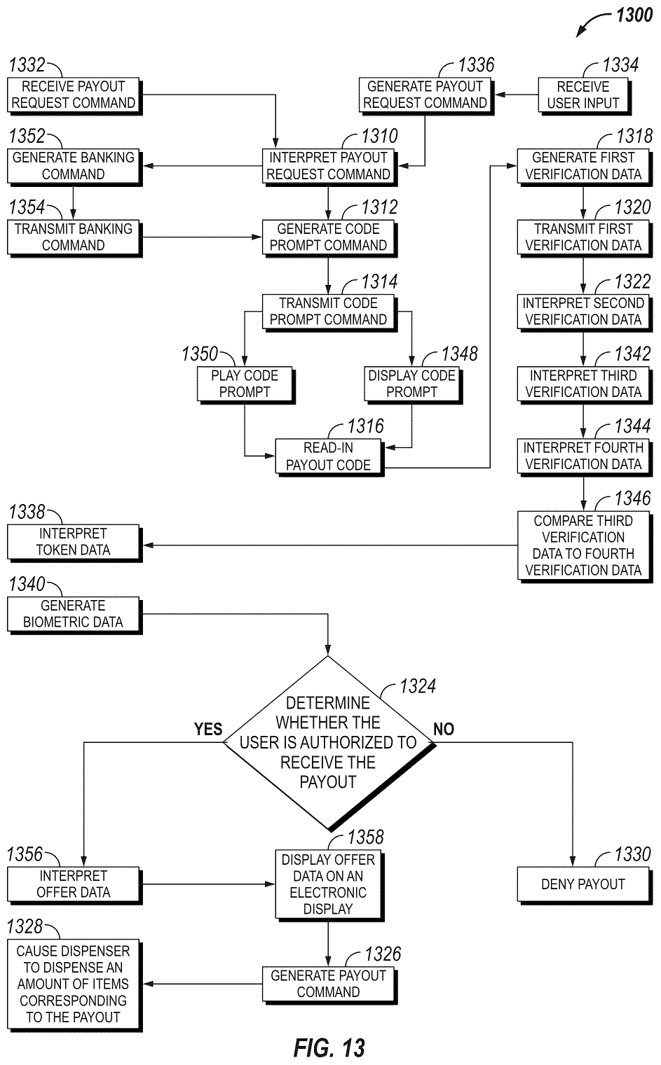

FIG. 13 depicts a method 1300 for dispensing wager payouts that may be performed by the apparatus 1200, item dispensing devices 128, 130, 132 (FIG. 1), 200 (FIG. 2), and/or any other electrical/computing device disclosed herein. The method 1300 includes: interpreting 1310, at an item dispensing device, a payout request command initiated by a user and corresponding to a payout for one or more wagers made by the user. The method 1300 further includes generating 1312, at the item dispensing device and in response to the payout request command, a code prompt command structured to generate a prompt for a payout code to be provided for read-in via a payout code scanner of the item dispensing device. The method 1300 further includes: transmitting 1314, by the item dispensing device, the code prompt command; reading-in 1316, in response to transmitting the code prompt command, the payout code via a payout code scanner of the item dispensing device; generating 1318, at the item dispensing device in response to reading-in the payout code, first verification data; transmitting 1320, from the item dispensing device via one or more secure electronic communication channels, the first verification data to one or more servers; interpreting 1322, at the item dispensing device in response to transmitting the first verification data, second verification data transmitted from the one or more servers via the one or more secure electronic communication channels; and determining 1324, at the item dispensing device and based at least in part on the second verification data, that the user is authorized to receive the payout. If the user is determined 1324 to be authorized to receive the payout, the method 1300 further includes generating 1326, at the item dispensing device, a payout command; and causing 1328, based at least in part on the payout command, a dispenser of the item dispensing device to dispense, via an actuator, an amount of a plurality of items corresponding to the payout. If the user is determined 1324 to not be authorized to receive the payout, the user is denied 1330 the payout.

In embodiments, the method 1300 further includes receiving 1332, at an input device of the item dispensing device, the payout request command. In embodiments, the input device may be a network interface device 318 (FIG. 3) and/or a short-range wireless communication device 328 (FIG. 3).

In embodiments, the method 1300 further includes: receiving 1334, at an input device of the item dispensing device, a user input; and generating 1336, by the input device, the payout request command.

In embodiments, the method 1300 further includes interpreting 1338, via a physical token reading device 326 (FIG. 3) of the item dispensing device, token data from a physical token device. In such embodiments, determining 1324 that the user is authorized to receive the payout is further based at least in part on the token data.

In embodiments, the method 1300 further includes generating 1340, via a biometric device 330 (FIG. 3) of the item dispensing device, biometric data corresponding to the user. In such embodiments, determining 1324 that the user is authorized to receive the payout is further based at least in part on the biometric data.

In embodiments, the method 1300 further includes interpreting 1342, at an input device 316 of the item dispensing device, third verification data from at least one of: a user device corresponding to the user, or the user. In such embodiments, the user is determined 1324 to be authorized to receive the payout is further based at least in part on the third verification data.

In embodiments, the method further includes interpreting 1344, at the item dispensing device, fourth verification data transmitted by the one or more servers 612 (FIG. 6) via the one or more secure electronic communication channels; and comparing 1346, at the item dispensing device, the third verification data to the fourth verification data. In such embodiments, determining 1324 that the user is authorized to receive the payout is further based at least in part on the comparing of the third verification data to the fourth verification data. In embodiments, the user is determined 1334 to be authorized to receive the payout if the third verification data matches the fourth verification data.

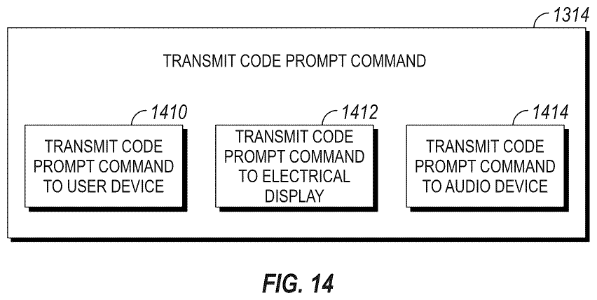

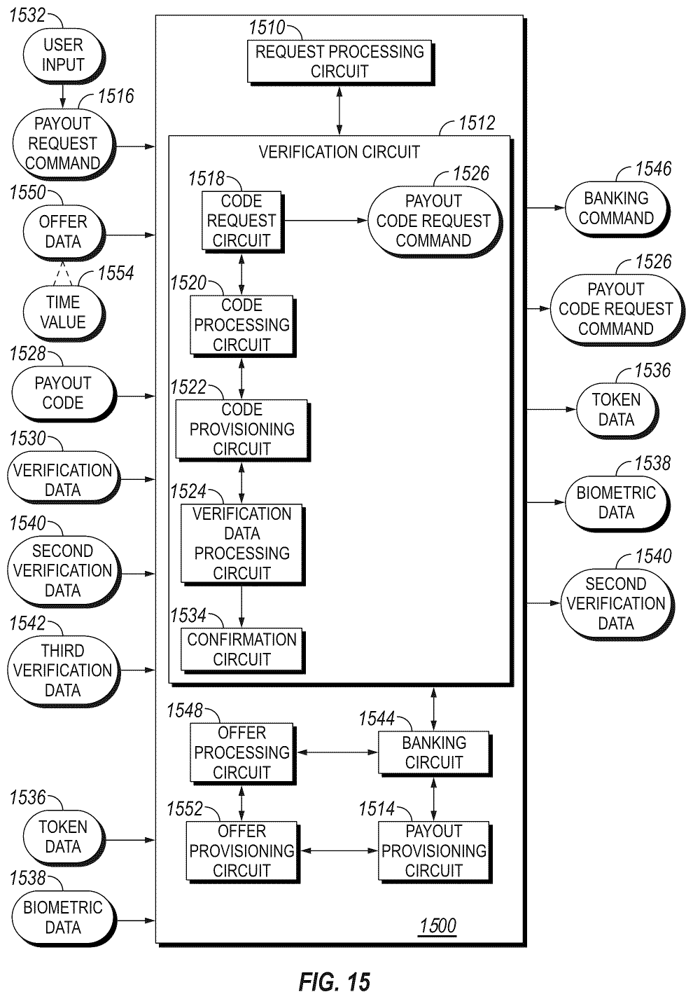

In embodiments, the method 1300 further includes: displaying 1348, based at least in part on the code prompt command, the prompt as a visual message on an electronic display of the item dispensing device; and/or playing 1350, based at least in part on the code prompt command, the prompt as an audio message on an audio device of the item dispensing device. As shown in FIG. 14, transmitting 1314 the code prompt command may include: transmitting 1410 the code prompt command to a user device to play 1350 (FIG. 13) the prompt as an audio message on an audio device 416 (FIG. 4) and/or to display 1348 (FIG. 13) the prompt as a visual message on an electrical display 414 (FIG. 4); transmitting 1412 the code prompt command to an electrical display 216 (FIGS. 2 and 3) of the item dispensing device for display 1348 (FIG. 13) as visual message; and/or transmitting 1414 the code prompt command to an audio device 312 (FIG. 3) of the item dispensing device for playing 1350 (FIG. 13) the prompt as an audio message.

As further shown in FIG. 13, the method 1300 may include: generating 1352, at the item dispensing device, a banking command; and transmitting 1354, from the item dispensing device via the one or more secure electronic communication channels, the banking command to a bank server 812 (FIG. 8). The banking command may be any type of banking command disclosed herein.

In embodiments, the method 1300 may include: interpreting 1356, at the item dispensing device, offer data corresponding to an offer for the user to make a new wager; and displaying 1358, based at least in part on the offer data, the offer on an electronic display of the item dispensing device prior to dispensing of the amount of the plurality of items. The wager may be for any type of wager disclosed herein. In embodiments, the offer data includes a time value corresponding to a time period during which the offer can be accepted by the user; and displaying 1358 the offer on the electronic display of the item dispensing device is based at least in part on the time value. For example, displaying 1358 of the offer may be performed during the time period corresponding to the time value.

FIG. 15 depicts an apparatus 1500 for dispensing wager payouts, in accordance with embodiments of the current disclosure. The apparatus 1500 may form part of an item dispensing device 128, 130, 132 (FIG. 1), 200 (FIGS. 2 and 3), e.g., the apparatus 1500 may take the form of the one or more processors 300 (FIG. 3), and/or form part of any other computing/electronic device disclosed herein. A non-limiting use case for the apparatus 1500 includes an ATM providing a QR code to a user to be scanned by a smart phone application, which then interprets and sends the data encoded in the QR code, or data derived from the same, to a sportsbook server. The sportsbook server then uses the data transmitted by the smart phone application to verify the ATM and/or the user. Upon verification of the user and/or the ATM, the sportsbook server approves the ATM to dispense the payout.

Accordingly, the apparatus 1500 includes a request processing circuit 1510, a verification circuit 1512; and a payout provisioning circuit 1514. The request processing circuit 1510 is structured to interpret a payout request command 1516 generated by a user and corresponding to a payout for one or more wagers made by the user.

The verification circuit 1512 includes a code request circuit 1518, a code processing circuit 1520, a code provisioning circuit 1522, and a verification data processing circuit 1524. The code request circuit 1518 is structured to, in response to the payout request command 1516, generate a payout code request command 1526 and transmit the payout code request command 1526 to one or more servers, e.g., 612 (FIG. 6) via one or more secure electronic communication channels, e.g., 144, 150, 152 (FIG. 1). The code processing circuit 1520 is structured to, in response to transmission of the payout code request command 1526, interpret a payout code 1528 transmitted by the one or more servers via the one or more secure electronic communication channels. The code provisioning circuit 1522 is structured to display the payout code 1528 via an electronic display, e.g., 216 (FIGS. 2 and 3) for scanning by a user device corresponding to the user. The verification data processing circuit 1524 is structured to interpret verification data 1530 transmitted from the one or more servers via the one or more secure electronic communication channels, and the verification data 1530 corresponds to the payout code 1528. The payout provisioning circuit 1514 is structured to cause, in response to the verification data 1530, dispenser, e.g., 212 (FIGS. 2 and 3) to dispense, via an actuator 234 (FIGS. 2 and 3), an amount of a plurality of items 228 (FIG. 2) corresponding to the payout.

In embodiments, an input device 316 (FIG. 3) may be structured to receive the payout request command 1516 and transmit the payout request command 1516 to the request processing circuit 1510. The input device 316 may include a network interface device 318 (FIG. 3); or a short-range wireless communication device 328 (FIG. 3).

In embodiments, an input device 316 (FIG. 3) may be structured to receive a user input 1532 and, in response to the user input 1532, generate the payout request command 1516. In embodiments, the input device 316 includes a physical button, e.g., 320 (FIG. 3), and/or an electronic display 216 (FIGS. 2 and 3) having a virtual button 217 (FIG. 3).

In embodiments, the verification circuit 1512 may include a confirmation circuit 1534, where a physical token reading device 326 (FIG. 3) interprets token data 1536 from a physical token device and transmits the token data 1536 to the confirmation circuit 1534. The confirmation circuit 1534 may be structured to transmit the token data 1536 to the one or more servers, and the verification data 1530 is based at least in part on the token data.

In embodiments, a biometric device 330 (FIG. 3) may generate biometric data 1538 corresponding to the user, and transmit the biometric data 1538 to the confirmation circuit 1534. The confirmation circuit 1534 may be structured to transmit the biometric data 1538 to the one or more servers; and the verification data 1530 is based at least in part on the biometric data 1538.

In embodiments, an input device 316 (FIG. 3) may interpret second verification data 1540 from at least one of: a user device or the user; and transmit the second verification data 1540 to the confirmation circuit 1534. The confirmation circuit 1534 may be structured to transmit the second verification data 1540 to the one or more servers; and the verification data 1530 transmitted from the one or more servers is based at least in part on the second verification data 1540.

In embodiments, the confirmation circuit is structured to interpret second verification data 1540 transmitted by the one or more servers via the one or more secure electronic communication channels. An input device 316 (FIG. 3) may be structured to: interpret third verification data 1542 from at least one of: the user device, or the user; and transmit the third verification data 1542 to the confirmation circuit 1534. The confirmation circuit 1534 may be structured to determine that the user is authorized to receive the payout further based at least in part on comparing the second verification data 1540 to the third verification data 1542; and the payout provisioning circuit 1514 is further structured to cause the dispenser to dispense the amount of the plurality of items corresponding to the payout if the user is authorized to receive the payout. In embodiments, the confirmation circuit may be further structured to determine that the user is authorized to receive the payout if the second verification data 1540 matches the third verification data 1542.

In embodiments, the apparatus 1500 may include a banking circuit 1544 structured to generate and transmit, via one or one or more secure electronic communication channels, a banking command 1546 to a bank server. The banking command 1546 may be any type of banking command disclosed herein.

In embodiments, the apparatus 1500 may include: an offer processing circuit 1548 structured to interpret offer data 1550 corresponding to an offer for the user to make a new wager; and an offer provisioning circuit 1552 structured to display the offer on the electronic display, e.g., 216 (FIGS. 2 and 3), 414 (FIGS. 4 and 5) prior to dispensing of the amount of the plurality of items. The new wager may be any type of wager disclosed herein. The offer data may include a time value 1554 corresponding to a time period during which the offer can be accepted by the user, and the offer provisioning circuit 1552 may be structured to display the offer on the electronic display based at least in part on the time value. For example, the offer provisioning circuit 1552 may be structured to display the offer during the time period corresponding to the time value.

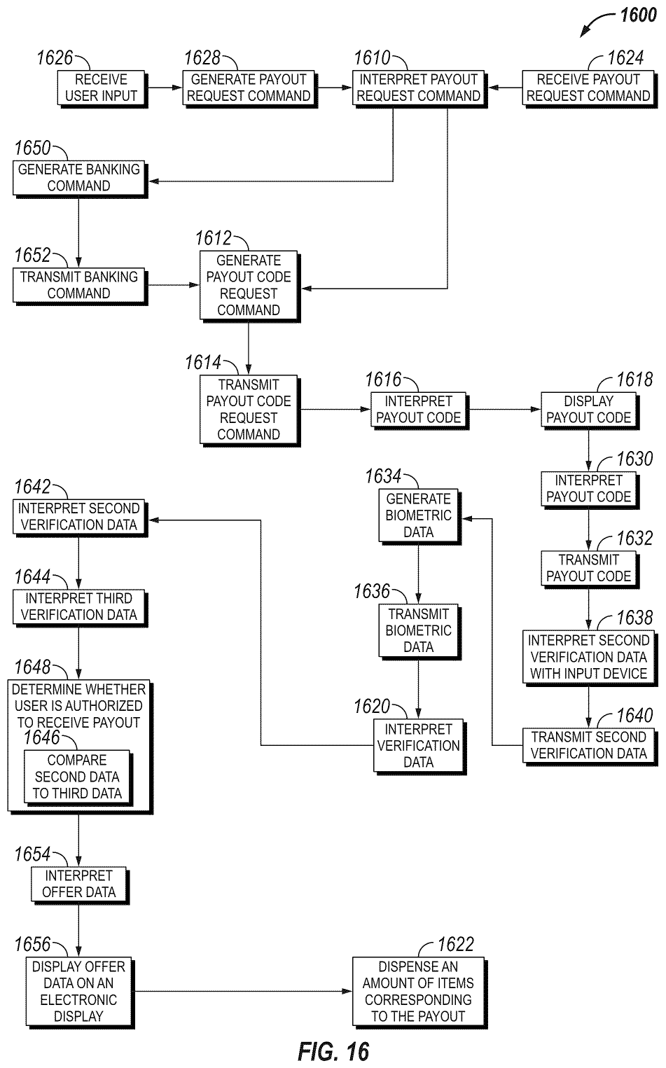

FIG. 16 depicts a method 1600 for dispensing wager payouts, in accordance with embodiments of the current disclosure. The method 1600 may be performed via the apparatus 1500 (FIG. 15) and/or any other electrical device disclosed herein. The method 1600 includes: interpreting 1610, at an item dispensing device, a payout request command generated by a user and corresponding to a payout for one or more wagers made by the user; in response to the payout request command, generating 1612, at the item dispensing device, a payout code request command; and transmitting 1614, from the item dispensing device, the payout code request command to one or more servers via one or more secure electronic communication channels. The method 1600 further includes: in response to transmitting 1614 the payout code request command, interpreting 1616, at the item dispensing device, a payout code transmitted by the one or more servers via the one or more secure electronic communication channels; and displaying 1618 the payout code via an electronic display of the item dispensing device for scanning by a user device corresponding to the user. The method 1600 further includes: interpreting 1620, at the item dispensing device, verification data transmitted from the one or more servers via the one or more secure electronic communication channels and corresponding to the payout code; and in response to the verification data, dispensing 1622, by the item dispensing device, an amount of a plurality of items corresponding to the payout.

In embodiments, the method 1600 includes receiving 1624, at an input device 316 (FIG. 3) of the item dispensing device, the payout request command. The input device 316 may include a network interface device 318 (FIG. 3); and/or a short-range wireless communication device 328 (FIG. 3).

In embodiments, the method 1600 includes: receiving 1626, at a user input device 316 (FIG. 3) of the item dispensing device, a user input; and in response to the user input, generating 1628 the payout request command. The user input device 316 may include a physical button, e.g., 321 (FIG. 3), and/or an electronic display 216 (FIGS. 2 and 3) having a virtual button 217 (FIG. 3).

In embodiments, the method 1600 includes: interpreting 1630, via a physical token reading device 326 (FIG. 3) of the item dispensing device, token data form a physical token device; and transmitting 1632 the token data from the item dispensing device to the one or more servers. In such embodiments, the verification data may be based at least in part on the token data.

In embodiments, the method 1600 includes: generating 1634, via a biometric device 330 (FIG. 3) of the item dispensing device, biometric data corresponding to the user; and transmitting 1636 the biometric data from the item dispensing device to the one or more servers via the one or more secure electronic communication channels. In such embodiments, the verification data is based at least in part on the biometric data.

In embodiments, the method 1600 further includes: interpreting 1638, via an input device of the item dispensing device, second verification data; and transmitting 1640 the second verification data from the item dispensing device to the one or more servers via the one or more secure electronic communication channels. In such embodiments, the verification data transmitted from the one or more servers is based at least in part on the second verification data.

In embodiments, the method 1600 includes: interpreting 1642, at the item dispensing device, second verification data transmitted by the one or more servers via the one or more secure electronic communication channels; interpreting 1644, via an input device 316 (FIG. 3) of the item dispensing device, third verification data from at least one of: the user device, or the user; comparing 1646, at the item dispensing device, the second verification data to the third verification data; and determining 1648, at the item dispensing device and based at least in part on the comparing of the second verification data to the third verification data, that the user is authorized to receive the payout. In such embodiments, dispensing 1622, by the item dispensing device, an amount of the plurality of items corresponding to the payout is performed if the user is authorized to receive the payout. In embodiments, the user is determined 1648 to be authorized to receive the payout if the second verification (from the one or more servers) data matches the third verification data (from the user input device and/or the user).

In embodiments, the method 1600 includes: generating 1650, at the item dispensing device, a banking command; and transmitting 1652 the banking command from the item dispensing device to the one or more servers via the one or more secure electronic communication channels. The banking command may be any type of banking command disclosed herein.

In embodiments, the method 1600 includes: interpreting 1654, at the item dispensing device, offer data corresponding to an offer for the user to make a new wager; and displaying 1656 the offer on the electronic display prior to the dispensing of the amount of the plurality of items. The new wager may be any type of wager disclosed herein.

In embodiments, the offer data includes a time value corresponding to a time period during which the offer can be accepted by the user, and displaying 1656 the offer on the electronic display is based at least in part on the time value. For example, displaying the offer on the electronic display may be performed during the time period corresponding to the time value.

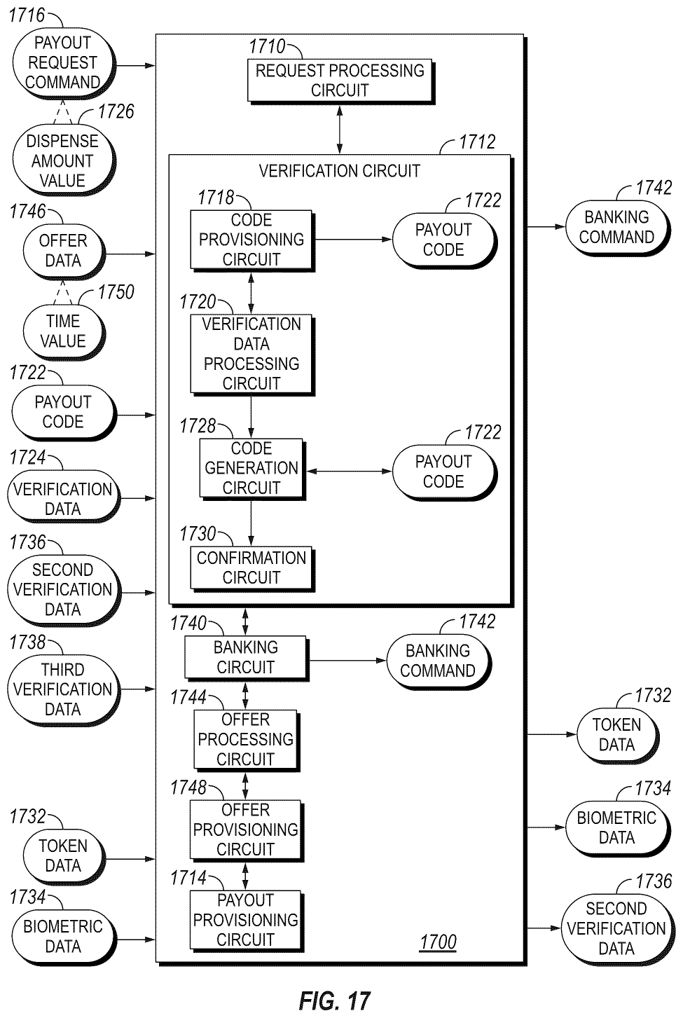

FIG. 17 depicts an apparatus 1700 for dispensing wager payouts, in accordance with embodiments of the current disclosure. The apparatus 1700 may form part of an item dispensing device 128, 130, 132 (FIG. 1), 200 (FIGS. 2 and 3), e.g., the apparatus 1700 may take the form of the one or more processors 300 (FIG. 3), and/or form part of any other computing/electronic device disclosed herein. The apparatus 1700 includes: a request processing circuit 1710, a verification circuit 1712, and a payout provisioning circuit 1714.

The request processing circuit 1710 is structured to interpret a payout request command 1716 initiated by a user and corresponding to a payout for one or more wagers made by the user.

The verification circuit 1712 includes: a code provisioning circuit 1718, and a verification data processing circuit 1720. The code provisioning circuit 1718 is structured to display, in response to the payout request command 1716, a payout code 1722 via an electronic display, e.g., 216 (FIGS. 2 and 3) for scanning by a user device corresponding to the user. The verification data processing circuit 1720 is structured to interpret, in response to the display of the payout code 1722, verification data 1724 transmitted from one or more servers, e.g., 612 (FIG. 6) via one or more secure electronic communication channels.

The payout provisioning circuit 1714 is structured to cause, in response to the verification data 1724, a dispenser 212 (FIGS. 2 and 3) to dispense, via an actuator 234 (FIG. 3), an amount of a plurality of items 228 (FIG. 2) corresponding to the payout.

In embodiments, the request processing circuit 1710 is further structured to interpret a dispense amount value 1726 that defines, at least in part, the amount of the plurality of items dispensed by the dispenser.

In embodiments, the payout code 1722, as well as any other payout code disclosed herein, may be structured to identify a location, e.g., the payout code may include encoded location data such as GPS coordinates, street address, IP address, media access control (MAC) address, and/or the like.

In embodiments, the payout code 1722 may be stored in a memory device, e.g., 310 (FIG. 3), prior to display of the payout code 1722 on the electronic display 216 for scanning by the user device. In such embodiments, the code provisioning circuit 1718 may be structured to access the payout code 1722 from the memory device.

In embodiments, the apparatus 1700 may include a code generation circuit 1728 structured to generate the payout code 1722.

In embodiments, an input device 316 (FIG. 3) is structured to receive the payout request command 1716 and transmit the payout request command 1716 to the request processing circuit 1710. The input device 316 may include: a network interface device; and/or a short-range wireless communication device.

In embodiments, an input device 316 (FIG. 3) is structured to receive a user input and, in response to the user input, generate the payout request command 1716. The input device 316 may include a physical button, e.g., 320 (FIG. 3), and/or a virtual button, e.g., 217 (FIG. 3), on the electronic display 216.

In embodiments, the verification circuit 1712 includes a confirmation circuit 1730. In such embodiments, a physical token reading device 326 (FIG. 3) is structured to: interpret token data 1732 from a physical token device and transmit the token data 1732 to the confirmation circuit 1730, which is structured to transmit the token data 1732 to the one or more servers. The verification data 1724 may be based at least in part on the token data 1732.

In embodiments, a biometric device 330 (FIG. 3) is structured to: generate biometric data 1734 corresponding to the user, and transmit the biometric data 1734 to the confirmation circuit 1730. In such embodiments, the confirmation circuit 1730 is structured to transmit the biometric data 1734 to the one or more servers, and the verification data 1724 is based at least in part on the biometric data 1734.

In embodiments, an input device 316 (FIG. 3) is structured to interpret second verification data 1736 from the user device and/or the user, and transmit the second verification data 1736 to the confirmation circuit 1730. In such embodiments, the confirmation circuit 1730 is structured to transmit the second verification data 1736 to the one or more servers, e.g., 612 (FIG. 6); and the verification data 1724 transmitted from the one or more servers is based at least in part on the second verification data 1736.

In embodiments, the confirmation circuit is structured to interpret second verification data 1736 transmitted by the one or more servers, e.g., 612 (FIG. 6) via the one or more secure electronic communication channels; and an input device 316 (FIG. 3) is structured to: interpret third verification data 1738 from the user device and/or the user; and transmit the third verification data 1738 to the confirmation circuit 1730. In such embodiments, the confirmation circuit 1730 may be structured to determine that the user is authorized to receive the payout based at least in part on comparing the second verification data 1736 to the third verification data 1738; and the payout provisioning circuit 1714 may be structured to cause the dispenser 212 (FIG. 3) to dispense the amount of the plurality of items corresponding to the payout if the user is authorized to receive the payout. In embodiments, the confirmation circuit 1730 is structured to determine that the user is authorized to receive the payout if the second verification data 1736 matches the third verification data 1738.

In embodiments, the apparatus 1700 may further include one or more of: a banking circuit 1740 for generating and transmitting banking command 1742; an offer processing circuit 1744 for interpreting offer data 1746 corresponding to an offer for a new wager; and an offer provisioning circuit 1748 for displaying and/or displaying the offer as a visual message on one or more electronic displays, e.g., 216 (FIGS. 2 and 3), 414 (FIG. 4), and/or for playing the offer as an audio message on one or more audio devices, e.g., 312 (FIG. 3) and 416 (FIG. 4). The banking command 1742 may be any type of banking command disclosed herein, and the new wager may be any type of wager disclosed herein. The offer data 1746 may include a time value 1750 that determines, in part, when the offer provisioning circuit 1744 displays and/or plays the offer, as disclosed herein.

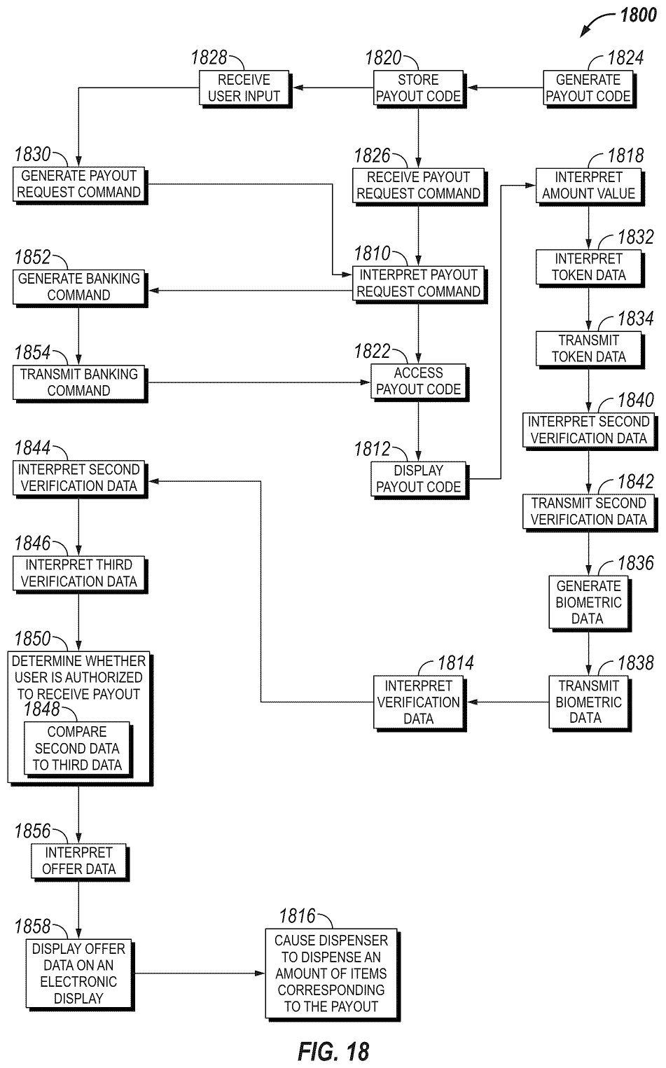

FIG. 18 depicts a method 1800 for dispensing wager payouts. The method 1800 may be performed via the apparatus 1700 (FIG. 17) and/or any other electronic device disclosed herein. The method 1800 includes interpreting 1810, at an item dispensing device, a payout request command initiated by a user, the payout request command corresponding to a payout for one or more wagers made by the user. The method 1800 further includes: displaying 1812, in response to the payout request command, a payout code via an electronic display, e.g., 216 (FIG. 2) for scanning by a user device corresponding to the user; interpreting 1814, at the item dispensing device, in response to the display 1812 of the payout code, verification data transmitted from one or more servers, e.g., 612 (FIG. 6) via one or more secure electronic communication channels; and causing 1816, in response to the verification data, a dispenser 212 (FIGS. 2 and 3) of the item dispensing device to dispense, via an actuator 234 (FIG. 3), an amount of a plurality of items 228 (FIG. 2) corresponding to the payout.

In embodiments, the method 1800 includes interpreting 1818, at the item dispensing device, a dispense amount value that defines, at least in part, the amount of the plurality of items dispensed by the dispenser.

The method 1800 may include: prior to display 1812 of the payout code on the electronic display for scanning by the user device: storing 1820 the payout code in a memory device of the item dispensing device; and accessing 1822, at the item dispensing device, the payout code from the memory device.

In embodiments, the method 1800 includes generating 1824, at the item dispensing device, the payout code.

In embodiments, the method 1800 includes receiving 1826, at an input device 316 (FIG. 3) of the item dispensing device, the payout request command. In embodiments, the input device 316 includes a network interface device 318 (FIG. 3) and/or a short-range wireless communication device 328 (FIG. 3).

In embodiments, the method 1800 includes receiving 1828, at an input device 316 (FIG. 3) of the item dispensing device, a user input; and in response to the user input, generating 1830, at the item dispensing device, the payout request command. The input device may include a physical button, e.g., 320 (FIG. 3) and/or an electronic display 216 (FIGS. 2 and 3) having a virtual button 217 (FIG. 3).

In embodiments, the method 1800 includes: interpreting 1832, via a physical token reading device 326 (FIG. 3) of the item dispensing device, token data from a physical token device, and transmitting 1834 the token data from the item dispensing device to the one or more servers, e.g., 612 (FIG. 6). In such embodiments, the verification data is based at least in part on the token data.

The method 1800 may include: generating 1836, via a biometric device 330 (FIG. 3) of the item dispensing device, biometric data corresponding to the user, and transmitting 1838 the biometric data from the item dispensing device to the one or more servers 612 (FIG. 3). In such embodiments, the verification data is based at least in part on the biometric data.

In embodiments, the method 1800 further includes: interpreting 1840, via a user input device 316 (FIG. 3) of the item dispensing device, second verification data from the user device and/or the user; and transmitting 1842 the second verification data from the item dispensing device to the one or more servers 612 (FIG. 6). In such embodiments, the verification data transmitted from the one or more servers is based at least in part on the second verification data.

In embodiments, the method 1800 includes: interpreting 1844, at the item dispensing device, second verification data transmitted by the one or more servers 612 (FIG. 6) via the one or more secure electronic communication channels; and interpreting 1846, via an input device 316 (FIG. 3) of the item dispensing device, third verification data from the user device and/or the user; comparing 1848, at the item dispensing device, the second verification data to the third verification data; and determining 1850, at the item dispensing device and based at least in part on the comparing of the second verification data to the third verification data, that the user is authorized to receive the payout. In such embodiments, dispensing, by the item dispensing device, the amount of the plurality of items corresponding to the payout is performed if the user is authorized to receive the payout. In embodiments, the user is determined to be authorized to receive the payout if the second verification data matches the third verification data.

In embodiments, the method 1800 may include generating 1852 a banking command and transmitting 1854 the banking command to a bank server, e.g., 812 (FIG. 8). The method 1800 may further include: interpreting offer data 1856 corresponding to an offer for a new wager; and displaying 1858 the offer on an electronic display, e.g., 216 (FIGS. 2 and 3) and 414 (FIG. 4). As disclosed herein, displaying 1858 the offer may be based at least in part on a time value, which may be included in the offer data.

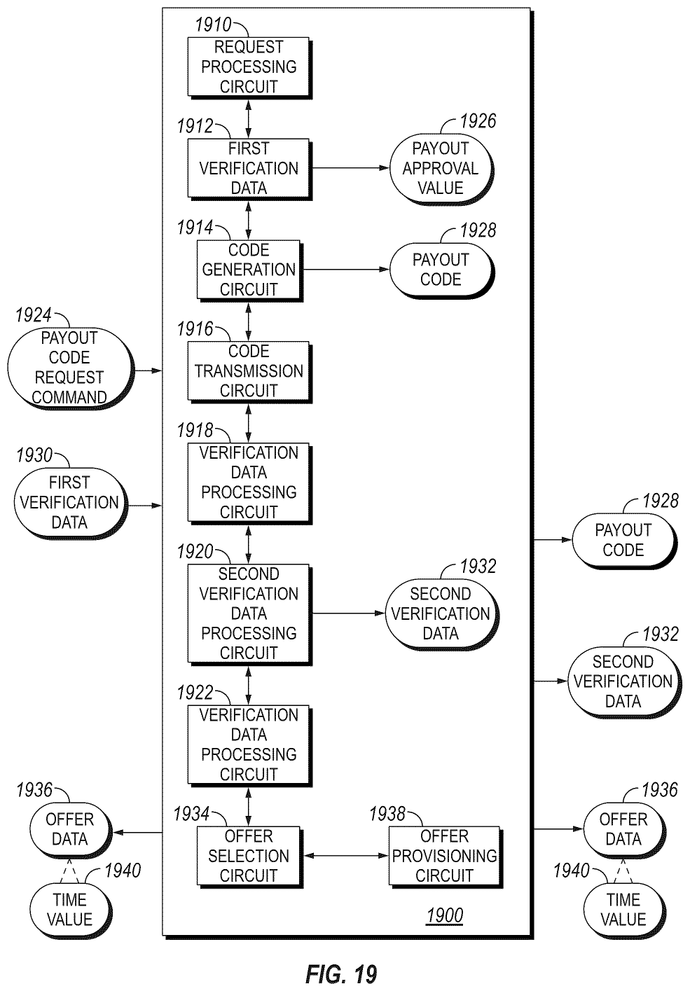

FIG. 19 depicts an apparatus 1900 for authorizing dispensing of wager payouts, in accordance with embodiments of the current disclosure. The apparatus 1900 may form part of the one or more servers 612 (FIG. 6), e.g., the apparatus 1900 may take the form of the one or more processors 616 (FIG. 6), and/or form part of any other computing/electronic device disclosed herein. A non-limiting use case for the apparatus 1900 includes a sportsbook server generating a QR code that is transmitted to a user device, which the user device displays on its screen for scanning/read-in by the ATM. The ATM may then interpret and use the data encoded in the QR code to verify the user and/or the amount to be dispensed.

Accordingly, the apparatus 1900 includes: a request processing circuit 1910, a first verification circuit 1912, a code generation circuit 1914, a code transmission circuit 1916, a verification data processing circuit 1918; a second verification circuit 1920, and a verification provisioning circuit 1922.

The request processing circuit 1910 is structured to interpret a payout code request command 1924 transmitted from a user device, e.g., 120, 122, 124, 126 (FIG. 1), 200 (FIG. 2) via one or more secure electronic communication channels, e.g., 156, 164 (FIG. 1), the payout code request command 1924 corresponds to a payout for one or more wagers made by a user corresponding to the user device. The first verification circuit 1912 is structured to verify, based at least in part on the payout code request command 1924, that the user is authorized to receive the payout and, if the user is authorized to receive the payout, generate a payout approval value 1926. The code generation circuit 1914 is structured to generate a payout code 1928 in response to the payout approval value 1926. The code transmission circuit 1916 is structured to transmit the payout code 1928 to the user device via the one or more secure electronic communication channels. The verification data processing circuit 1918 is structured to interpret first verification data 1930 transmitted from an item dispensing device, e.g., 128, 130, 132 (FIG. 2), 200 (FIG. 2), via the one or more secure electronic communication channels. The second verification circuit 1920 is structured to verify that the first verification data 1930 was generated based at least in part on the payout code 1928 transmitted to the user device and, if the first verification data 1930 was generated based at least in part on the payout code 1928, generate second verification data 1932. The verification provisioning circuit 1922 is structured to transmit the second verification data 1932 to the item dispensing device via the one or more secure electronic communication channels, e.g., 156, 164.

The apparatus 1900 may include an offer selection circuit 1934 structured to retrieve offer data 1936 from an offer database, e.g., 614 (FIG. 6) that stores data for a plurality of distinct offers. The offer data 1936 corresponds to an offer, of the plurality of distinct offers, for the user to make a new wager. The new wager may be any type of wager disclosed herein. The apparatus 1900 may include an offer provisioning circuit 1938 structured to transmit the offer data 1936 to at least one of the item dispensing device or the user device. The offer data 1936 may include a time value 1940 that determines, in part, when the offer data 1936 is transmitted by the offer provisioning circuit 1938 and/or when the offer is displayed on an electronic display at the item dispensing device and/or the user device. For example, in embodiments, the offer provisioning circuit 1938 is structured to transmit the offer data 1936 during a time period corresponding to the time value.

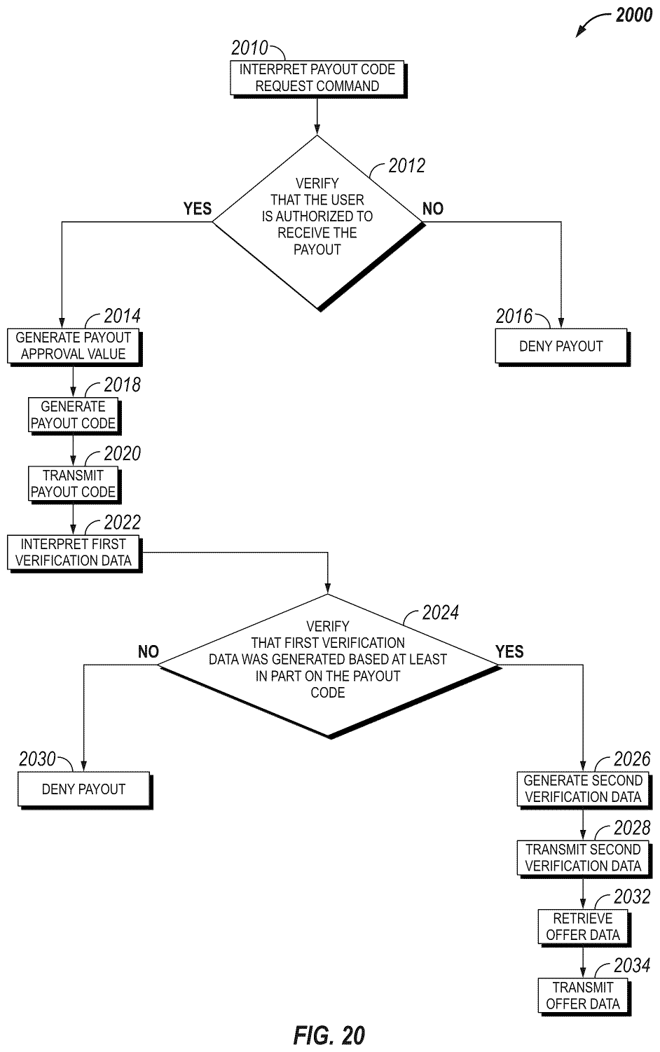

FIG. 20 depicts a method 2000 for dispensing wager payouts, in accordance with embodiments of the current disclosure. The method 2000 may be performed via apparatus 1900 and/or any other electrical/computing device disclosed herein. The method 2000 includes interpreting 2010 a payout code request command transmitted from a user device via one or more secure electronic communication channels. The payout code request command corresponds to a payout for one or more wagers made by a user corresponding to the user device. The method 2000 includes verifying 2012, based at least in part on the payout code request command, that the user is authorized to receive the payout. If the user is authorized to receive the payout, the method 2000 includes generating 2014 a payout approval value. If the user is not authorized to receive the payout, the method 2000 includes denying 2016 the payout.

The method 2000 includes: generating 2018 a payout code in response to the payout approval value; transmitting 2020 the payout code to the user device via the one or more secure electronic communication channels; and interpreting 2022 first verification data transmitted from an item dispensing device via the one or more secure electronic communication channels. The method 2000 includes verifying 2024 that the first verification data was generated based at least in part on the payout code transmitted to the user device. If the first verification data was generated based at least in part on the payout code, the method 2000 includes generating 2026 second verification data and transmitting 2028 the second verification data to the item dispensing device via the one or more secure electronic communication channels. If the first verification data was not generated based at least in part on the payout code, the method 2000 includes denying 2030 the payout.

In embodiments, the method 2000 includes: retrieving 2032 offer data from an offer database, e.g., 614 (FIG. 6) storing data for a plurality of distinct offers; and transmitting 2034 the offer data to at least one of the item dispensing device or the user device. The offer data corresponds to an offer, of the plurality of distinct offers, for the user to make a new wager, where the new wager may be any type of wager disclosed herein.

In embodiments, the offer data includes a time value corresponding to a time period during which the offer can be accepted by the user. In such embodiments, transmitting 2034 the offer data is based at least in part on the time period. For example, transmitting 2034 the offer data may occur during the time period corresponding to the time value.

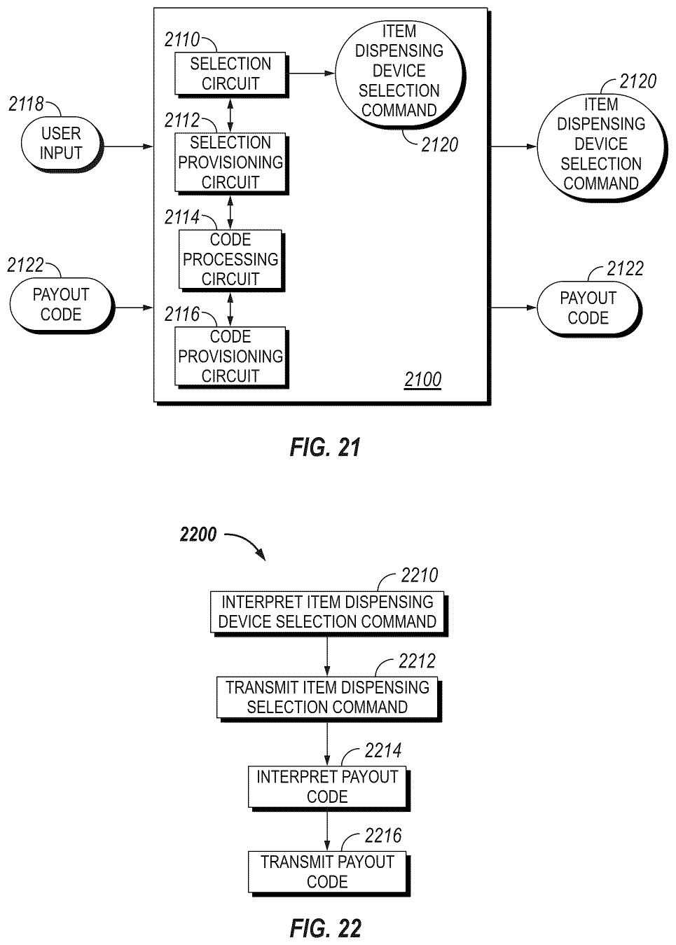

FIG. 21 depicts an apparatus 2100, in accordance with embodiments of the current disclosure. The apparatus 2100 may form part of the one or more user devices, e.g., 120, 122, 124, 126 (FIG. 1), 400 (FIGS. 4 and 5), e.g., the apparatus 2100 may take the form of the one or more processors 410 (FIG. 4), and/or form part of any other computing/electronic device disclosed herein. A non-limiting use case for the apparatus 2100 is a smart phone that provides for a user to view a list of nearby ATMs that are capable of dispensing a payout from a particular sportsbook entity, where the user selects one of the ATMs. The selection is transmitted to the sportsbook server. The user makes their way to the selected ATM and scans a QR code displayed by the ATM with the smart phone, and the smart phone interprets and uses the data encoded in the QR code to verify the ATM, which may occur on the smart phone and/or at the sportsbook server. Upon verification of the ATM, the ATM is approved and/or instructed to dispense the payout. As will be understood, in embodiments, a sportsbook and/or bank may selectively control which item dispensing devices a user may request a payout from. For example, a user may be restricted to only using a certain set of item dispensing devices. The restriction may be based on the user's identity, the one or more wagers corresponding to the payout, a date, a date range, the sportsbook, a location of the user, a location of the item dispensing device, an amount of the payout, the type of items to be dispensed, and/or the like. For example, a user may only wish to view and/or select an item dispensing device within a certain distance of themselves and/or another location; and/or the user may wish to view/select only item dispensing devices that a contain sufficient inventory of items to be dispensed to cover the full amount of the payout. In embodiments, the set of available item dispensing devices may be restricted based on a type of currency they can dispense. In embodiments, the set of available item dispensing devices may be restricted based on an ownership and/or licensing of the item dispensing devices, e.g., a sportsbook and/or bank may limit the user to using item dispensing devices for which the sportsbook and/or bank may generate a fee from.

Accordingly, the apparatus 2100 includes: a selection circuit 2110, a selection provisioning circuit 2112, a code processing circuit 2114, and a code provisioning circuit 2116. A user input device, e.g., 418 (FIG. 5) may be structured to receive a user input 2118 from a user and transmit the user input 2118 to the selection circuit 2110. The selection circuit 2110 is structured to interpret the user input 2118 and generate an item dispensing device selection command 2120 that identifies an item dispensing device for executing a payout for one or more wagers made by a user.

The selection provisioning circuit 2112 is structured to transmit the item dispensing device selection command 2120 to one or more servers, e.g., 612 (FIG. 6) via one or more secure electronic communication channels, e.g., 146, 148, 153. The code processing circuit 2114 is structured to interpret a payout code 2122 provided by the item dispensing device; and the code provisioning circuit 2116 is structured to transmit the payout code 2122 to the one or more servers, e.g., 612 (FIG. 6) via the one or more secure electronic communication channels.

FIG. 22 depicts a method 2200 for collecting a payout for one or more wagers made by a user. The method 2200 may be performed by apparatus 2100 and/or any other electrical/computing device disclosed herein. The method 2200 includes interpreting 2210, at a user device, e.g., 120, 122, 124, 126 (FIG. 1), 400 (FIGS. 4 and 5), corresponding to the user, an item dispensing device selection command that identifies an item dispensing device, e.g., 128, 130, 132 (FIG. 1), 200 (FIGS. 2 and 3), for executing the payout for the one or more wagers. The method 2200 includes: transmitting 2212, from the user device, the item dispensing device selection command to one or more servers, e.g., 612 (FIG. 6); interpreting 2214, at the user device, a payout code provided by the item dispensing device; and transmitting 2216, from the user device, the payout code to the one or more servers via one or more secure electronic communication channels, e.g., 146, 148, 153, 154 (FIG. 1).

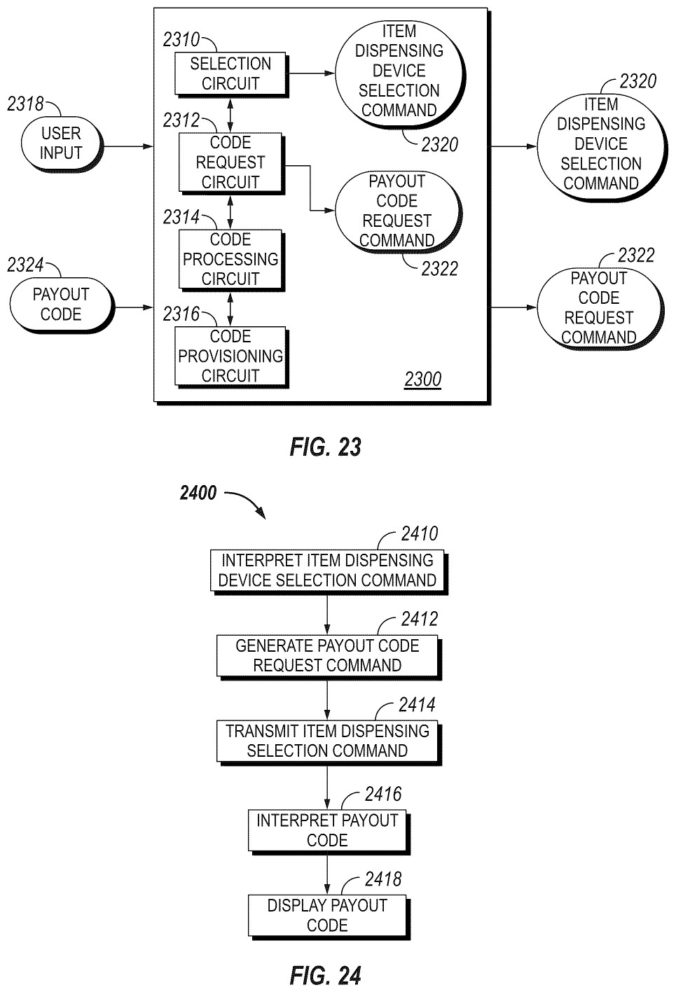

FIG. 23 depicts an apparatus 2300, in accordance with embodiments of the current disclosure. The apparatus 2300 may form part of the one or more user devices, e.g., 120, 122, 124, 126 (FIG. 1), 400 (FIGS. 4 and 5), e.g., the apparatus 2100 may take the form of the one or more processors 410 (FIG. 4), and/or form part of any other computing/electronic device disclosed herein. A non-limiting use case for the apparatus 2300 includes a smart phone that allows a user to select a nearby ATM that has the ability to dispense a payout from a particular sportsbook. The selection is sent to the sportsbook server which provides the smartphone a QR code to present to the ATM for scanning/reading-in. Upon scanning/reading in the QR code displayed on the smartphone, the ATM dispenses the payout the user. The ATM may exchange data with the sportsbook server prior to the user scanning in the QR code for the purpose of verifying the ATM with the sportsbook server and/or for verifying the user and/or the sportsbook with the ATM and/or a corresponding bank.

Accordingly, the apparatus 2300 includes: a selection circuit 2310, a code request circuit 2312, a code processing circuit 2314, and a code provisioning circuit 2316. A user input device, e.g., 418 (FIG. 5) may be structured to receive a user input 2318 from a user; and transmit the user input 2318 to the selection circuit 2310. The selection circuit 2310 is structured to interpret the user input 2318 and generate, based at least in part on the user input 2318, an item dispensing selection command 2320 that identifies an item dispensing device, e.g., 128, 130, 132 (FIG. 2), 200 (FIGS. 2 and 3), for executing a payout for one or more wagers made by the user. The code request circuit 2312 is structured to: generate a payout code request command 2322 based at least in part on the item dispensing selection command 2320; and transmit the payout code request command 2322 to one or more servers, e.g., 612 (FIG. 6), via one or more secure electronic communication channels, e.g., 146, 148, 153, 154. The code processing circuit 2314 is structured to interpret, in response to the transmitting of the payout code request command 2322, a payout code 2324 transmitted by the one or more servers via the one or more secure electronic communication channels. The code provisioning circuit 2316 is structured to display the payout code 2324 on an electronic display, e.g., 414 (FIGS. 4 and 5) for scanning by the item dispensing device.

FIG. 24 depicts a method 2400 for collecting a payout for one or more wagers, in accordance with embodiments of the current disclosure. The method 2400 may be performed by apparatus 2300 and/or any other electrical/computing device disclosed herein. The method 2400 includes: interpreting 2410 an item dispensing selection command that identifies an item dispensing device, e.g., 128, 130, 132 (FIG. 1), 200 (FIGS. 2 and 3), for executing a payout for one or more wagers made by a user; generating 2412 a payout code request command based at least in part on the item dispensing selection command; transmitting 2414 the payout code request command to one or more servers, e.g., 612 (FIG. 6) via one or more secure electronic communication channels, e.g., 146, 148, 153, 154; interpreting 2416, in response to the transmitting 2414 of the payout code request command, a payout code transmitted by the one or more servers via the one or more secure electronic communication channels; and displaying 2418 the payout code on an electronic display, e.g., 414 (FIGS. 4 and 5) for scanning by the item dispensing device.

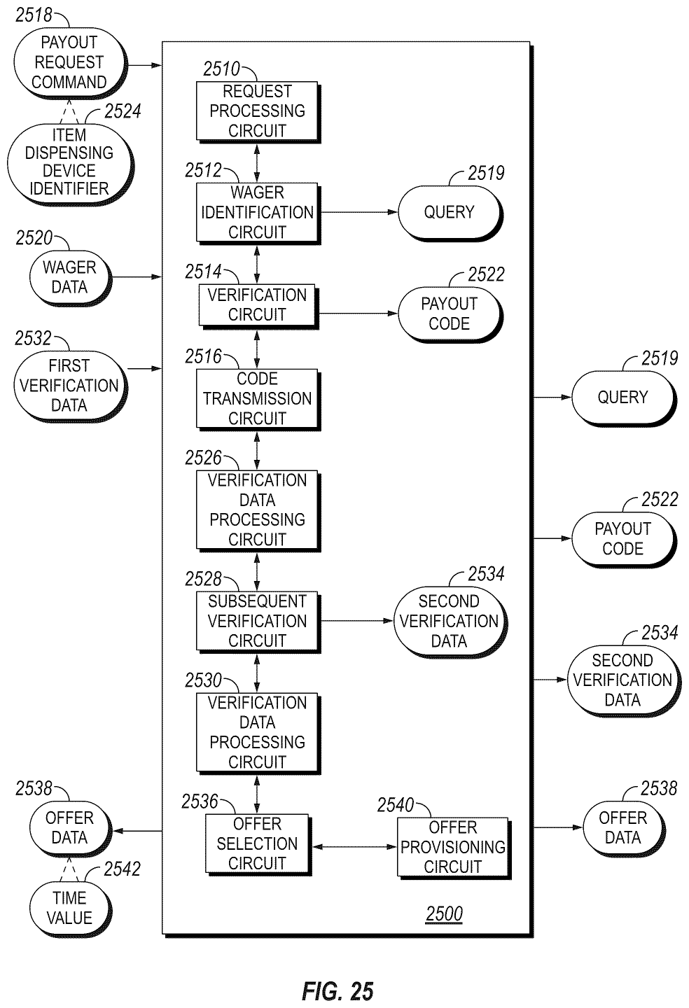

FIG. 25 depicts an apparatus 2500 for dispensing a payout for a wager between two users. The apparatus 2500 may form part of the one or more servers 612 (FIG. 6), e.g., the apparatus 2500 may take the form of the one or more processors 616 (FIG. 6), and/or form part of any other computing/electronic device disclosed herein. A non-limiting use case for the apparatus 2500 includes settling a bet between two friends regarding the winner of a hockey game. The winning user can request a payout from the sportsbook on their smartphone, where the sportsbook server verifies that the user requesting the payout is in fact the winner and then sends the winning user's smartphone a QR code to be scanned at an ATM. Scanning of the code by the winning user at an ATM causes the ATM to dispense the payout to the user.

Accordingly, the apparatus 2500 includes: a request processing circuit 2510, a wager identification circuit 2512, a verification circuit 2514, and a code transmission circuit 2516.

The request processing circuit 2510 is structured to interpret a payout request command 2518 transmitted from a user device 120 (FIG. 1), via one or more secure electronic communication channels 146 (FIG. 1). The user device 120 corresponds to a first user 112 and the payout request command corresponds to a payout for one or more wagers made between the first user 112 and a second user 116. The wager identification circuit 2512 is structured to query (by generating and transmitting a query command/request), based at least in part on the payout request command 2518, a database 614 (FIG. 6) that stores a plurality of records 622 corresponding to a plurality of wagers made between a plurality of distinct users, including the one or more wagers made between the first user 112 and the second user 116. The query 2519 is structured to return wager data 2520 corresponding to the one or more wagers made between the first user 112 and the second user 116. The verification circuit 2514 is structured to verify, based at least in part on the wager data 2520, that the first user 112 is a winning party to the one or more wagers and, if the first user 112 is the winning party, generate a payout code 2522 corresponding to the payout. The code transmission circuit 2516 is structured to transmit, via the one or more secure electronic communication channels, e.g., 156, 164 (FIG. 1), the payout code 2522 to the user device 122 and/or an item dispensing device 128, where the first user 112 can collect the payout in accordance with methods/processes disclosed herein.

In embodiments, the payout request command 2518 includes an item dispensing device identifier 2524 that identifies the item dispensing device 128; and the code transmission circuit 2516 is structured to transmit the payout code 2522 to the item dispensing device 128 based at least in part on the item dispensing device identifier 2524.

In embodiments, the apparatus 2500 includes: a verification data processing circuit 2526, a subsequent verification circuit 2528, and a verification data provisioning circuit 2530. The verification data processing circuit is structured to interpret first verification data 2532 transmitted by the user device 120 via the one or more secure electronic communication channels. The subsequent verification circuit 2528 is structured to verify that the first verification data 2532 was generated based at least in part on the payout code 2522 transmitted to the item dispensing device 128 and, if the first verification data 2532 was generated based at least in part on the payout code 2522, generate second verification data 2534. The verification data provisioning circuit 2530 is structured to transmit the second verification data 2534 to the item dispensing device 128 via the one or more secure electronic communication channels.

In embodiments, the payout request command 2518 includes the item dispensing device identifier; and the code transmission circuit 2516 is further structured to transmit the payout code 2522 to the user device 120 based at least in part on the item dispensing device identifier 2524.

In embodiments, the verification data processing circuit 2526 is structured to interpret the first verification data 2532, where the first verification data 2532 is transmitted by the item dispensing device 128 via the one or more secure electronic communication channels. In such embodiments: the subsequent verification circuit 2528 is structured to verify that the first verification data 2532 was generated based at least in part on the payout code 2522 transmitted to the user device 120 and, if the first verification data 2532 was generated based at least in part on the payout code 2522, generate the second verification data 2534; and the verification data provisioning circuit 2530 is structured to transmit the second verification data 2534 to the item dispensing device 128 via the one or more secure electronic communication channels.

In embodiments, the apparatus 2500 may include an offer selection circuit 2536 structured to retrieve offer data 2538 from an offer database, e.g., 612 (FIG. 6) storing data for a plurality of distinct offers, where the offer data 2538 corresponds to an offer, of the plurality of distinct offers, for the first user 112 to make a new wager, which may be any type of wager disclosed herein. The apparatus 2500 may include an offer provisioning circuit 2540 structured to transmit the offer data 2538 to at least one of: the item dispensing device 128 and/or the user device 120. The offer provisioning circuit 2540 may be further structured to transmit the offer data 2538 based at least in part on a time period corresponding to a time value 2542 included in the offer data 2538.

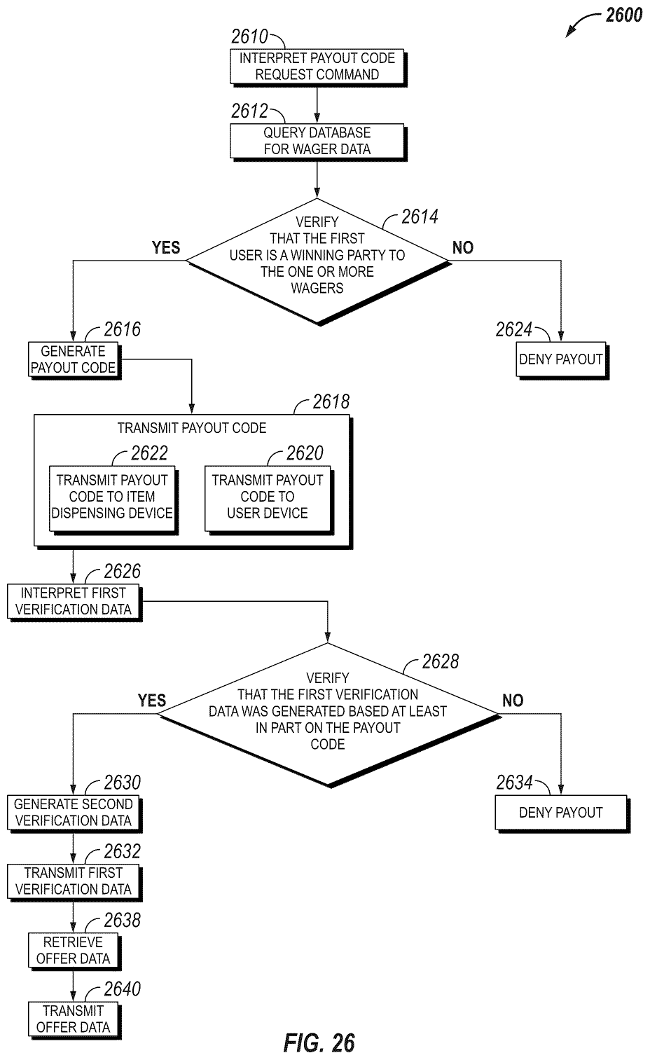

FIG. 26 depicts a method 2600 for dispensing a payout for a wager between two users. The method 2600 may be performed via the apparatus 2500 and/or any other computing device disclosed herein. The method 2600 includes interpreting 2610 a payout request command transmitted from a user device 120 via one or more secure electronic communication channels, e.g., 146. The user device 120 corresponds to a first user 112 and the payout request command corresponds to a payout for one or more wagers made between the first user 112 and a second user 116.

The method 2600 further includes querying 2612, based at least in part on the payout request command, a database, e.g., 612 (FIG. 6) that stores a plurality of records 622 corresponding to a plurality of wagers made between a plurality of distinct users. The plurality of distinct users includes the first user 112 and the second user 116, and the plurality of wagers includes the one or more wagers between the first user 112 and the second user 116. The query is structured to return wager data corresponding to the one or more wagers made between the first user 112 and the second user 116.

The method 2600 further includes verifying 2614, based at least in part on the wager data, that the first user 112 is a winning party to the one or more wagers. If the first user 112 is the winning party, the method 2600 includes generating 2616 a payout code corresponding to the payout; and transmitting 2618, via the one or more secure electronic communication channels, the payout code to the user device 120 (represented by box 2620) and/or an item dispensing device 128 (represented by box 2620). If the first user 112 is determined 2614 to not be the winning party, then the method 2600 includes denying 2624 the first user 112 the payout.

In embodiments, the payout request command includes an item dispensing device identifier that identifies the item dispensing device 128 (FIG. 1); and the payout code is transmitted 2618 to the item dispensing device based at least in part on the item dispensing device identifier.

In embodiments, the method 2600 includes: interpreting 2626 first verification data transmitted by the user device 120 via the one or more secure electronic communication channels, e.g., 146; and verifying 2628 that the first verification data was generated based at least in part on the payout code transmitted to the item dispensing device. If the first verification data is determined 2628 to have been generated based at least in part on the payout code, the method 2600 includes generating 2630 second verification data; and transmitting 2632 the second verification data to the item dispensing device 128 via the one or more secure electronic communication channels, e.g., 144 (FIG. 1). If the first verification data is determined 2628 to have not been generated based at least in part on the payout code, the method 2600 includes denying 2634 the first user 112 the payout.

In embodiments, the payout request command includes an item dispensing device identifier that identifies the item dispensing device; and the payout code is transmitted 2620 to the user device 120 and/or transmitted 2622 to the item dispensing device 128 based at least in part on the item dispensing device identifier.

In embodiments, the method 2600 includes: interpreting 2626 first verification data transmitted by the item dispensing device 128 via the one or more secure electronic communication channels; and verifying 2628 that the first verification data was generated based at least in part on the payout code transmitted to the user device 120. If the first verification data was generated based at least in part on the payout code, the method 2600 includes generating 2630 second verification data; and transmitting the second verification data to the item dispensing device 128 via the one or more secure electronic communication channels.

In embodiments, the method 2600 includes retrieving 2638 offer data from an offer database, e.g., 612 (FIG. 6) storing data for a plurality of distinct offers, the offer data corresponding to an offer, of the plurality of distinct offers, for the first user 112 to make a new wager, which may be any type of wager disclosed herein; and transmitting 2640 the offer data to the item dispensing device 128 and/or the user device 120. The offer data may include a time value corresponding to a time period during which the offer can be accepted by the first user; and transmitting 2632 the offer data is based at least in part on the time period. For example, transmitting 2632 the offer data may be performed during the time period corresponding to the time value.

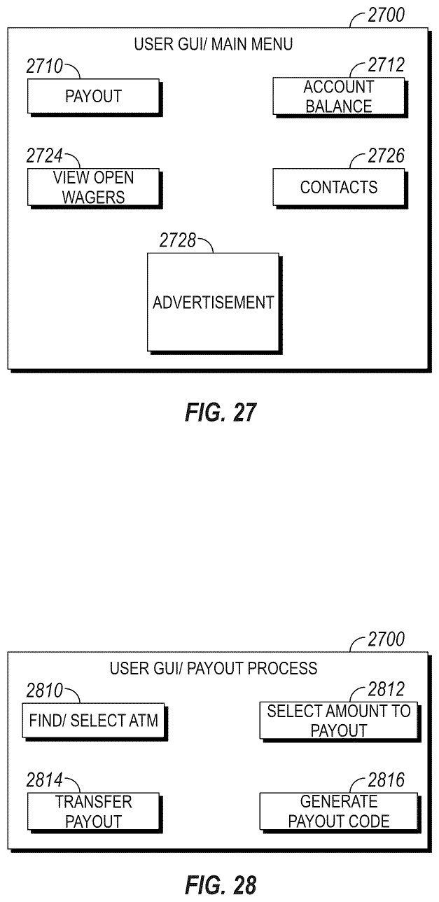

FIGS. 27 and 28 depict a graphical user interface 2700 for an application that adapts a user device, e.g., 120, 122, 124 (FIG. 1), 400 (FIGS. 4 and 5) to perform one or more of the methods/processes disclosed herein. The graphical user interface 2700 include a first menu (FIG. 7) having a payout button 2710, an account balance button 2712, a view open wagers button 2724, a contacts button 2726, and/or an advertisement panel 2728. The account balance button 2712 may provide for a user to check the balance of an account with a sportsbook, as disclosed herein. The view open wagers button 2724 may provide for the user to see a list of wagers that they have the option to participate in. The contacts button 2726 may provide a listing of other known users who may have open user defined wagers, as disclosed herein. The advertisement panel 2728 may provide advertisements and/or show offers for new wagers, as disclosed herein. The payout button 2710 may generate a payout request command and/or transition the graphical user interface to the menu shown in FIG. 28.

The menu shown in FIG. 28 may include a find/select ATM button 2810; a payout amount selection button 2812, a transfer payout button 2814; and a generate payout code button 2816. The find/select ATM button 2810 may provide for the user to see a list of nearby ATMs, and provide for selection of an ATM for cashing out a payout from a sportsbook, as disclosed herein. The payout amount selection button 2812 may provide for the user to enter the amount value, as disclosed herein, for a requested payout. The transfer payout button 2814 may provide for a user to allow another individual and/or entity to collect on the user's winnings with a sportsbook, as disclosed herein. The generate payout code button 2816 may provide for the generation of a payout code that can be electronically shared and/or printed for scanning at an ATM to collect on the corresponding payout. In embodiments, the graphical user interface 2700 may provide the user the option to view account and/or request payout from multiple sportsbooks.

Further, in embodiments, the input devices 316 (FIG. 3) of an item dispensing device 200 (FIGS. 2 and 3) may be structured to automatically detect the presence of a user and/or a user device. For example, a short-range wireless communication device 328, e.g., a Bluetooth radio, may be configured to scan for a broadcast by user device. Upon detecting the user device, the item dispensing device may bypass any standard menu screens, e.g., ATM welcome screens, baking option screens, etc., and display a screen that shows the payout amount which a one-button option for the user to press and have the item dispensing device dispense the payout. In such a case, one or more exchanges of data between the item dispensing device, the user device, and/or the sportsbook server, as disclosed herein, may occur prior to pressing of the one-button option and/or immediately after pressing of the one-button option, which may give the appearance of an instant payout. In such a scenario, the user may either instruct the smart phone to broadcast a message to inform listening item dispensing devices that the user wishes to receive a payout, e.g., the gamer or bettor may be able to unlock the payout directly from their smart phone whereby the item dispensing device detects that the bettor is requesting a payout from the mobile sports betting service. In embodiments, an item dispensing device may use one or more cameras, microphones, antennas, etc. to detect the presence of a user and/or user device, which may then cause the item dispensing device to interrogate the user device to see if it is running a sportsbook application and/or to see if the user has a payout to collect and/or wants to collect a payout.

In embodiments, the item dispensing device might not require any touching of a screen and/or other physical input device (other than the user's smart phone), where the entire withdrawal of the payout can take place with the interactions between the user device, the sportsbook server, and/or an item dispensing device, e.g., an ATM, conducted via electronic communications, as disclosed herein. In such embodiments, the only required “touch” may be the actual taking of the cash by the user from the dispenser.

In embodiments, rather than interact with an ATM machine, a gamer and/or player may instead choose an amount to receive as a payout on their user device, either on: a payment application, and/or a sports betting (or fantasy sports operator) service website and/or application. Upon choosing the amount to withdraw or have all the winnings paid in cash, a QR code is generated, which may be used to dispense the cash as disclosed herein.

In embodiments, an application on the user device may configure the smart device to broadcast a message informing listening item dispensing devices that the user does and/or may want to collect a payout. In embodiments, the message broadcast by the user device may be a payout request command, as disclosed herein.

Embodiments of the current disclosure may have a variety of other non-limiting use cases.

For example, an example embodiment of the present disclosure, utilizing one or more aspects as set forth preceding, includes a collection of services for online sportsbook operators and/or fantasy sports services to deliver cash payouts via automated teller machines located throughout the United States and/or internationally.

Another example, an example embodiment of the present disclosure, utilizing one or more aspects as set forth preceding, includes a slot machine, and/or other type of gaming device and/or game dealer, providing a payout code to a user, as opposed to money and/or casino chips. The payout code may be in physical printed form and/or in digital form, e.g., on an RFID device. The payout code may be electronically transmitted to a user device corresponding to a user. The user may then use the payout code to collect their winnings as disclosed herein.

Another an example embodiment of the present disclosure, utilizing one or more aspects as set forth preceding, includes ATMs that provide instant, or near instant, payouts for a winning fantasy lineup, ticket, and/or sports bet in cash to the winner with and/or without going through the player's bank account. Further, and as will be appreciated, there are hundreds of thousands of ATMs in the United States, dozens of online sports betting operators; dozens of real money online fantasy sports operations; and the vast majority of wagering volume is related to online and mobile sports. Thus, ATMs that dispense sportsbook winnings, as disclosed herein, increase the number of locations bettors can enjoy their winnings. Such locations may include sports bars, convenience stores, shopping malls, hotels, etc.

Further, many players/bettors desire instant gratification, and waiting for money erodes the feeling of actually winning money. By delivering cash instantly or conveniently to a winner, embodiments of the current disclosure help players/bettors to experience an even greater thrill—the visceral sensation of hard cash enhancing the victory.

Another an example embodiment of the present disclosure, utilizing one or more aspects as set forth preceding, includes providing instant payout in various forms of wagering, to include “igaming”, e.g., from online slots to online blackjack.

Another example embodiment of the present disclosure, utilizing one or more aspects as set forth preceding, includes a “soft” key, e.g., 217, that displays the sportsbook (or fantasy operator) logo and/or name. Upon clicking of the key, a QR code generates for an item dispensing machine, where the QR code does not contain any data regarding the identity of the user, but instead allows a 3rd-party to identify the location of the item dispensing machine. For example, upon the user taking a picture of the QR code from within a spart phone application, the QR code informs the sportsbook that their gamer is at the item dispensing machine. The user then inputs on the smart phone and the amount of cash to be withdrawn.

Another example embodiment of the present disclosure, utilizing one or more aspects as set forth preceding, includes integrating geo-location data of the user via their user device to show a listing of item dispensing devices that enable instant cash withdrawals of winnings, without touching/accessing a bank account.

Another an example embodiment of the present disclosure, utilizing one or more aspects as set forth preceding, includes use of one-time codes to verify payout transactions, e.g., comparing, e.g., 1646 (FIG. 16), second verification data to third verification data, as disclosed herein. For example, once a QR code is submitted to sportsbook server, the sportsbook server could transmit and/or display a one-time code to the user be submitted/entered into the ATM by the user. This may provide for the ATM to know that the sportsbook has confirmed the transaction and is authorizing the ATM to pay out the funds. Transmission and/or display of the one-time use code may be accomplished via short message server (SMS), e-mail, via a smart phone application, etc.

Another example embodiment of the present disclosure, utilizing one or more aspects as set forth preceding, includes aspects beyond user verification such as driving sports bettors and/or gamers to other services. For instance, a restaurant, club, bowling alley, golf driving range, and/or casino could offer a bonus, e.g., 20%, for a withdrawal if the sports bettor or gamer is induced to collect their cash/payout from an onsite location. As will be appreciated, the ability to drive potential customers/clients (the bettors and/or gamers) to a particular venue may provide a revenue stream and/or subsidy to the sportsbook operator. Additionally, for the ventures wishing to promote themselves, embodiments of the current disclosure provide for potential customers enthusiastic about getting cash/payouts in their pocket from visiting venue.

One or more certain further aspects of the example systems, apparatuses, and methods are described following, any one or more of which may be incorporated in certain embodiments.

An example apparatus for dispensing wager payouts includes: a body having a dispenser cavity and an opening; a dispenser disposed in at least a portion of the dispenser cavity, the dispenser having: a cavity that stores a plurality of items to be dispensed, a dispensing portion aligned with the opening of the body, and an actuator that dispenses, at the dispensing portion, one or more of the plurality of items from the cavity through the opening; a request processing circuit structured to interpret a payout request command generated by a user, the payout request command corresponding to a payout for one or more wagers made by the user; a verification circuit structured to, in response to the payout request command, determine that the user is authorized to receive the payout; and a payout provisioning circuit structured to, in response to determining that the user is authorized to receive the payout, cause the dispenser to dispense, via the actuator, an amount of the plurality of items corresponding to the payout.

In certain aspects, the plurality of items includes at least one of: a currency; a gift card; a coupon; a casino chip; or an event ticket. In certain aspects, the apparatus further includes: a banking circuit structured to generate and transmit, via one or one or more secure electronic communication channels, a banking command to a bank server. In certain aspects, the apparatus further includes: an electronic display; an offer processing circuit structured to interpret offer data corresponding to an offer for the user to make a new wager; and an offer provisioning circuit structured to display, based at least in part on the offer data, the offer on the electronic display prior to dispensing of the amount of the plurality of items. In certain aspects, the new wager has at least one of: an enhancement over the one or more wagers; an improved spread over the one or more wagers; or improved odds over the one or more wagers. In certain aspects, the offer data includes a time value corresponding to a time period during which the offer can be accepted by the user; and the offer provisioning circuit is further structured to display the offer on the electronic display based at least in part on the time value. In certain aspects, the offer provisioning circuit is further structured to display the offer during the time period corresponding to the time value. In certain aspects, the one or more wagers correspond to at least one of: a sporting event; a political election; or a user defined event.

An example method for dispensing wager payouts includes: interpreting, at an apparatus for dispensing the wager payouts, a payout request command generated by a user, the payout request command corresponding to a payout for one or more wagers made by the user; in response to the payout request command, determining, at the apparatus for dispensing the wager payouts, that the user is authorized to receive the payout; and in response to determining that the user is authorized to receive the payout, causing a dispenser, of the apparatus for dispensing wager payouts, to dispense, via an actuator of the apparatus for dispensing the wager payouts, an amount of a plurality of items corresponding to the payout.

In certain aspects the plurality of items includes at least one of: a currency; a gift card; a coupon; a casino chip; or an event ticket. In certain aspects, the method further includes: generating, at the apparatus for dispensing the wager payouts, a banking command; and transmitting, from the apparatus for dispensing the wager payouts via one or more secure electronic communication channels, the banking command to a bank server. In certain aspects, the method further includes: interpreting, at the apparatus for dispensing the wager payouts, offer data corresponding to an offer for the user to make a new wager; and displaying, on an electronic display of the apparatus for dispensing the wager payouts and based at least in part on the offer data, the offer prior to dispensing of the amount of the plurality of items. In certain aspects, the new wager has at least one of: an enhancement over the one or more wagers; an improved spread over the one or more wagers; or improved odds over the one or more wagers. In certain aspects, the offer data includes a time corresponding to a time period during which the offer can be accepted by the user; and displaying the offer is performed during the time period. In certain aspects, the one or more wagers correspond to at least one of: a sporting event; a political election; or a user defined event.

An example non-transitory computer-readable medium stores instructions that adapt at least one processor to: interpret a payout request command generated by a user, the payout request command corresponding to a payout for one or more wagers made by the user; in response to the payout request command, determine that the user is authorized to receive the payout; and in response to the determination that the user is authorized to receive the payout, cause an item dispensing device to dispense an amount of a plurality of items corresponding to the payout.

In certain aspects, the plurality of items includes at least one of: a currency; a gift card; a coupon; a casino chip; or an event ticket. In certain aspects, the stored instructions further adapt the at least one processor to: generate a banking command; and transmit, via one or more secure electronic communication channels, the banking command to a bank server. In certain aspects, the stored instructions further adapt the at least one processor to: interpret offer data corresponding to an offer for the user to make a new wager; and display, on an electronic display of the item dispensing device and based at least in part on the offer data, the offer prior to dispensing of the amount of the plurality of items. In certain aspects, the new wager has at least one of: an enhancement over the one or more wagers; an improved spread over the one or more wagers; or improved odds over the one or more wagers. In certain aspects, the offer data includes a time corresponding to a time period during which the offer can be accepted by the user; and the offer is displayed on the electronic display of the item dispensing device during the time period. In certain aspects, the one or more wagers correspond to at least one of: a sporting event; a political election; or a user defined event.

An example apparatus for dispensing wager payouts includes: a body having a dispenser cavity and an opening; a dispenser disposed in at least a portion of the dispenser cavity, the dispenser having: a cavity that stores a plurality of items to be dispensed, a dispensing portion aligned with the opening of the body, and an actuator that dispenses, at the dispensing portion, one or more of the plurality of items from the cavity through the opening; a payout code scanner; a request processing circuit structured to interpret a payout request command initiated by a user, the payout request command corresponding to a payout for one or more wagers made by the user; a verification circuit including: a code request circuit structured to, in response to the payout request command, generate and transmit a code prompt command structured to generate a prompt for a payout code to be provided for read-in via the payout code scanner; a code processing circuit structured to, in response to the payout code scanner reading-in the payout code, interpret the payout code and generate first verification data based at least in part on the payout code; a code communication circuit structured to: transmit, via one or more secure electronic communication channels, the first verification data to one or more servers, and in response to transmitting the first verification data, interpret second verification data transmitted from the one or more servers via the one or more secure electronic communication channels; and a confirmation circuit structured to determine, based at least in part on the second verification data, that the user is authorized to receive the payout and, if the user is determined to be authorized to receive the payout, generate a payout command; and a payout provisioning circuit structured to cause, in response to the payout command, the dispenser to dispense, via the actuator, an amount of the plurality of items corresponding to the payout.

In certain aspects, the payout code includes a quick response code. In certain aspects, the payout code includes at least one of: a bar code; or alphanumeric characters. In certain aspects, the apparatus further includes: an input device structured to receive the payout request command and transmit the payout request command to the request processing circuit. In certain aspects, the input device includes at least one of: a network interface device; or a short-range wireless communication device. In certain aspects, the input device includes the network interface device, and the network interface device is structured to communicate based at least in part on at least one of: an ethernet-based protocol; an Internet Protocol-based protocol; a cellular protocol; a satellite communication-based protocol; or a dial-up connection-based protocol. In certain aspects, the input device includes the short-range wireless communication device, and the short-range wireless communication device is structured to communicate based at least in part on at least one of: a WiFi-based protocol; a Bluetooth-based protocol; a ZigBee-based protocol; an IR-based protocol; or a UWB-based protocol. In certain aspects, the apparatus further includes: an input device structured to receive a user input and, in response to the user input, generate the payout request command. In certain aspects, the input device includes at least one of: a physical button, or an electronic display having a virtual button. In certain aspects, the apparatus further includes: a physical token reading device structured to: interpret token data from a physical token device, and transmit the token data to the confirmation circuit; and the confirmation circuit is further structured to determine that the user is authorized to receive the payout based at least in part on the token data. In certain aspects, the physical token reading device is at least one of: a cart reading device; or an RFID scanning device. In certain aspects, the apparatus further includes: a biometric device structured to: generate biometric data corresponding to the user, and transmit the biometric data to the confirmation circuit; and the confirmation circuit is further structured to determine that the user is authorized to receive the payout based at least in part on the biometric data. In certain aspects, the apparatus further includes: an input device structured to interpret third verification data from at least one of: a user device corresponding to the user, or the user; and the confirmation circuit is further structured to determine that the user is authorized to receive the payout further based at least in part on the third verification data. In certain aspects, the verification circuit further includes: a second code communication circuit structured to interpret fourth verification data transmitted by the one or more servers via the one or more secure electronic communication channels; and the confirmation circuit is further structured to determine that the user is authorized to receive the payout further based at least in part on comparing the third verification data to the fourth verification data. In certain aspects, the confirmation circuit is further structured to determine that the user is authorized to receive the payout if the third verification data matches the fourth verification data. In certain aspects, the apparatus further includes an electronic display, and the code prompt command is structured to display the prompt as a visual message via the electronic display. In certain aspects, the apparatus further includes an audio device, and the code prompt command is structured to play the prompt as an audio message over the audio device. In certain aspects, the code request circuit is further structured to transmit the code prompt command to a user device corresponding to the user; and the code prompt command is structured to display the prompt as a visual message on an electronic display of the user device. In certain aspects, the code request circuit is further structured to transmit the code prompt command to a user device corresponding to the user; and the code prompt command is structured to play the prompt as an audio message over an audio device of the user device. In certain aspects, the plurality of items to be dispensed includes at least one of: a currency; a gift card; a coupon; a casino chip; or an event ticket. In certain aspects, the apparatus further includes: a banking circuit structured to generate and transmit, via the one or more secure electronic communication channels, a banking command to a bank server. In certain aspects, the apparatus further includes: an electronic display; an offer processing circuit structured to interpret offer data corresponding to an offer for the user to make a new wager; and an offer provisioning circuit structured to display, based at least in part on the offer data, the offer on the electronic display prior to dispensing of the amount of the plurality of items. In certain aspects, the new wager has at least one of: an enhancement over the one or more wagers; an improved spread over the one or more wagers; or improved odds over the one or more wagers. In certain aspects, the offer data includes a time value corresponding to a time period during which the offer can be accepted by the user; and the offer provisioning circuit is further structured to display the offer on the electronic display based at least in part on the time value. In certain aspects, the offer provisioning circuit is further structured to display the offer during the time period corresponding to the time value. In certain aspects, the one or more wagers correspond to at least one of: a sporting event; a political election; or a user defined event.

An example method for dispensing wager payouts includes: interpreting, at an item dispensing device, a payout request command initiated by a user, the payout request command corresponding to a payout for one or more wagers made by the user; generating, at the item dispensing device and in response to the payout request command, a code prompt command structured to generate a prompt for a payout code to be provided for read-in via a payout code scanner of the item dispensing device; transmitting, by the item dispensing device, the code prompt command; reading-in, in response to transmitting the code prompt command, the payout code via a payout code scanner of the item dispensing device; generating, at the item dispensing device in response to reading-in the payout code, first verification data; transmitting, from the item dispensing device via one or more secure electronic communication channels, the first verification data to one or more servers; interpreting, at the item dispensing device in response to transmitting the first verification data, second verification data transmitted from the one or more servers via the one or more secure electronic communication channels; determining, at the item dispensing device and based at least in part on the second verification data, that the user is authorized to receive the payout; if the user is determined to be authorized to receive the payout, generating, at the item dispensing device, a payout command; and causing, based at least in part on the payout command, a dispenser of the item dispensing device to dispense, via an actuator, an amount of a plurality of items corresponding to the payout.

In certain aspects, the payout code includes a quick response code. In certain aspects, the payout code includes at least one of: a bar code; or alphanumeric characters. In certain aspects, the method further includes: receiving, at an input device of the item dispensing device, the payout request command. In certain aspects, the input device includes at least one of: a network interface device; or a short-range wireless communication device. In certain aspects, the input device includes the network interface device, and receiving the payout request command is based at least in part on at least one of: an ethernet-based protocol; an Internet Protocol-based protocol; a cellular-based protocol; a satellite communication-based protocol; or a dial-up connection-based protocol. In certain aspects, the input device includes the short-range wireless communication device, and receiving the payout request command is based at least in part on at least one of: a WiFi-based protocol; a Bluetooth-based protocol; a ZigBee-based protocol; an IR-based protocol; or a UWB-based protocol. In certain aspects, the method further includes: receiving, at an input device of the item dispensing device, a user input; and generating, by the input device, the payout request command. In certain aspects, the input device includes at least one of: a physical button, or an electronic display having a virtual button. In certain aspects, the method further includes: interpreting, via a physical token reading device of the item dispensing device, token data from a physical token device; wherein determining that the user is authorized to receive the payout is further based at least in part on the token data. In certain aspects, the physical token reading device is at least one of: a cart reading device; or an RFID scanning device. In certain aspects, the method further includes: generating, via a biometric device of the item dispensing device, biometric data corresponding to the user; wherein determining that the user is authorized to receive the payout is further based at least in part on the biometric data. In certain aspects, the method further includes: interpreting, at an input device of the item dispensing device, third verification data from at least one of: a user device corresponding to the user, or the user; wherein determining that the user is authorized to receive the payout is further based at least in part on the third verification data. In certain aspects, the method further includes: interpreting, at the item dispensing device, fourth verification data transmitted by the one or more servers via the one or more secure electronic communication channels; and comparing, at the item dispensing device, the third verification data to the fourth verification data; wherein determining that the user is authorized to receive the payout is further based at least in part on the comparing of the third verification data to the fourth verification data. In certain aspects, the user is determined to be authorized to receive the payout if the third verification data matches the fourth verification data. In certain aspects, the method further includes: displaying, based at least in part on the code prompt command, the prompt as a visual message on an electronic display of the item dispensing device. In certain aspects, the method further includes: playing, based at least in part on the code prompt command, the prompt as an audio message on an audio device of the item dispensing device. In certain aspects, transmitting the code prompt command includes: transmitting the code prompt command to a user device corresponding to the user, wherein the code prompt command is structured to display the prompt as a visual message on an electronic display of the user device. In certain aspects, transmitting the code prompt command includes: transmitting the code prompt command to a user device corresponding to the user, and the code prompt command is structured to play the prompt as an audio message on an audio device of the user device. In certain aspects, the plurality of items includes at least one of: a currency; a gift card; a coupon; a casino chip; or an event ticket. In certain aspects, the method further includes: generating, at the item dispensing device, a banking command; and transmitting, from the item dispensing device via the one or more secure electronic communication channels, the banking command to a bank server. In certain aspects, the method further includes: interpreting, at the item dispensing device, offer data corresponding to an offer for the user to make a new wager; and displaying, based at least in part on the offer data, the offer on an electronic display of the item dispensing device prior to dispensing of the amount of the plurality of items. In certain aspects, the new wager has at least one of: an enhancement over the one or more wagers; an improved spread over the one or more wagers; or improved odds over the one or more wagers. In certain aspects, the offer data includes a time value corresponding to a time period during which the offer can be accepted by the user; and displaying the offer on the electronic display of the item dispensing device is based at least in part on the time value. In certain aspects, displaying the offer is performed during the time period corresponding to the time value. In certain aspects, the one or more wagers correspond to at least one of: a sporting event; a political election; or a user defined event.

An example non-transitory computer-readable medium stores instructions that adapt at least one processor of an item dispensing device to: interpret a payout request command initiated by a user, the payout request command corresponding to a payout for one or more wagers made by the user; generate, in response to the payout request command, a code prompt command structured to generate a prompt for a payout code to be provided for read-in via a payout code scanner of an item dispensing device; transmit the code prompt command; read-in, in response to transmission of the code prompt command, the payout code via a payout code scanner of the item dispensing device; generate, in response to the payout code, first verification data; transmit, via one or more secure electronic communication channels, the first verification data to one or more servers; interpret, in response to transmission of the first verification data, second verification data transmitted from the one or more servers via the one or more secure electronic communication channels; determine, based at least in part on the second verification data, that the user is authorized to receive the payout; if the user is determined to be authorized to receive the payout, generate a payout command; and cause, based at least in part on the payout command, a dispenser of an item dispensing device to dispense, via an actuator, an amount of a plurality of items corresponding to the payout.

In certain aspects, the payout code includes a quick response code. In certain aspects, the payout code includes at least one of: a bar code; or alphanumeric characters. In certain aspects, the stored instructions further adapt the at least one processor to: receive, via an input device of the item dispensing device, the payout request command. In certain aspects, the input device includes at least one of: a network interface device; or a short-range wireless communication device. In certain aspects, the input device includes the network interface device, and the network interface device is based at least in part on at least one of: an ethernet-based protocol; an Internet Protocol-based protocol; a cellular protocol; a satellite communication-based protocol; or a dial-up connection-based protocol. In certain aspects, the input device includes the short-range wireless communication device, and the short-range wireless communication device is based at least in part on at least one of: a WiFi-based protocol; a Bluetooth-based protocol; a ZigBee-based protocol; an IR-based protocol; or a UWB-based protocol. In certain aspects, the stored instructions further adapt the at least one processor to: receive, at an input device of the item dispensing device, a user input; and generate the payout request command. In certain aspects, the input device includes at least one of: a physical button, or an electronic display having a virtual button. In certain aspects, the stored instructions further adapt the at least one processor to: interpret, via a physical token reading device of the item dispensing device, token data from a physical token device; wherein the determination that the user is authorized to receive the payout is further based at least in part on the token data. In certain aspects, the physical token reading device is at least one of: a cart reading device; or an RFID scanning device. In certain aspects, the stored instructions further adapt the at least one processor to: generate, via a biometric device of the item dispensing device, biometric data corresponding to the user; wherein the determination that the user is authorized to receive the payout is further based at least in part on the biometric data. In certain aspects, the stored instructions further adapt the at least one processor to: interpret, at an input device of the item dispensing device, third verification data from at least one of: a user device corresponding to the user, or the user; wherein the determination that the user is authorized to receive the payout is further based at least in part on the third verification data. In certain aspects, the stored instructions further adapt the at least one processor to: interpret fourth verification data transmitted by the one or more servers via the one or more secure electronic communication channels; and compare the third verification data to the fourth verification data; and the determination that the user is authorized to receive the payout is further based at least in part on the comparing of the third verification data to the fourth verification data. In certain aspects, the user is determined to be authorized to receive the payout if the third verification data matches the fourth verification data. In certain aspects, the stored instructions further adapt the at least one processor to: display, based at least in part on the code prompt command, the prompt as a visual message on an electronic display of the item dispensing device. In certain aspects, the stored instructions further adapt the at least one processor to: play, based at least in part on the code prompt command, the prompt as an audio message on an audio device of the item dispensing device. In certain aspects, the stored instructions further adapt the at least one processor to: transmit the code prompt command to a user device corresponding to the user, and the code prompt command is structured to display the prompt as a visual message on an electronic display of the user device. In certain aspects, the stored instructions further adapt the at least one processor to: transmit the code prompt command to a user device corresponding to the user, and the code prompt command is structured to play the prompt as an audio message on an audio device of the user device.

In certain aspects, the plurality of items to be dispensed includes at least one of: a currency; a gift card; a coupon; a casino chip; or an event ticket. In certain aspects, the stored instructions further adapt the at least one processor to: generate a banking command; and transmit, via the one or more secure electronic communication channels, the banking command to a bank server. In certain aspects, the stored instructions further adapt the at least one processor to: interpret offer data corresponding to an offer for the user to make a new wager; and display, based at least in part on the offer data, the offer on an electronic display of the item dispensing device prior to dispensing of the amount of the plurality of items. In certain aspects, the new wager has at least one of: an enhancement over the one or more wagers; an improved spread over the one or more wagers; or improved odds over the one or more wagers. In certain aspects, the offer data includes a time value corresponding to a time period during which the offer can be accepted by the user; and the display of the offer on the electronic display of the item dispensing device is based at least in part on the time value. In certain aspects, the display of the offer on the electronic display of the item dispensing device is during the time period corresponding to the time value. In certain aspects, the one or more wagers correspond to at least one of: a sporting event; a political election; or a user defined event.

An example server for authorizing dispensing of wager payouts includes: a request processing circuit structured to interpret a payout code request command transmitted from a user device via one or more secure electronic communication channels, the payout code request command corresponding to a payout for one or more wagers made by a user corresponding to the user device; a first verification circuit structured to verify, based at least in part on the payout code request command, that the user is authorized to receive the payout and, if the user is authorized to receive the payout, generate a payout approval value; a code generation circuit structured to generate a payout code in response to the payout approval value; a code transmission circuit structured to transmit the payout code to the user device via the one or more secure electronic communication channels; a verification data processing circuit structured to interpret first verification data transmitted from an item dispensing device via the one or more secure electronic communication channels; a second verification circuit structured to verify that the first verification data was generated based at least in part on the payout code transmitted to the user device and, if the first verification data was generated based at least in part on the payout code, generate second verification data; and a verification provisioning circuit structured to transmit the second verification data to the item dispensing device via the one or more secure electronic communication channels.

In certain aspects, the payout code includes a quick response code. In certain aspects, the payout code includes at least one of: a bar code; or alphanumeric characters. In certain aspects, the server further includes: an offer selection circuit structured to retrieve offer data from an offer database storing data for a plurality of distinct offers, the offer data corresponding to an offer, of the plurality of distinct offers, for the user to make a new wager; and an offer provisioning circuit structured to transmit the offer data to at least one of the item dispensing device or the user device. In certain aspects, the new wager has at least one of: an enhancement over the one or more wagers; an improved spread over the one or more wagers; or improved odds over the one or more wagers. In certain aspects, the offer data includes a time value corresponding to a time period during which the offer can be accepted by the user; and the offer provisioning circuit is further structured to transmit the offer data based at least in part on the time period. In certain aspects, the offer provisioning circuit is further structured to transmit the offer data during the time period corresponding to the time value. In certain aspects, the one or more wagers correspond to at least one of: a sporting event; a political election; or a user defined event.

an example method for dispensing of wager payouts includes: interpreting a payout code request command transmitted from a user device via one or more secure electronic communication channels, the payout code request command corresponding to a payout for one or more wagers made by a user corresponding to the user device; verifying, based at least in part on the payout code request command, that the user is authorized to receive the payout; if the user is authorized to receive the payout, generating a payout approval value; generating a payout code in response to the payout approval value; transmitting the payout code to the user device via the one or more secure electronic communication channels; interpreting first verification data transmitted from an item dispensing device via the one or more secure electronic communication channels; verifying that the first verification data was generated based at least in part on the payout code transmitted to the user device; if the first verification data was generated based at least in part on the payout code, generating second verification data; and transmitting the second verification data to the item dispensing device via the one or more secure electronic communication channels.

In certain aspects, the payout code includes a quick response code. In certain aspects, the payout code includes at least one of: a bar code; or alphanumeric characters. In certain aspects, the method further includes: retrieving offer data from an offer database storing data for a plurality of distinct offers, the offer data corresponding to an offer, of the plurality of distinct offers, for the user to make a new wager; and transmitting the offer data to at least one of the item dispensing device or the user device. In certain aspects, the new wager has at least one of: an enhancement over the one or more wagers; an improved spread over the one or more wagers; or improved odds over the one or more wagers. In certain aspects, the offer data includes a time value corresponding to a time period during which the offer can be accepted by the user; and transmitting the offer data is based at least in part on the time period. In certain aspects, transmitting the offer data occurs during the time period corresponding to the time value. In certain aspects, the one or more wagers correspond to at least one of: a sporting event; a political election; or a user defined event.

An example non-transitory computer-readable medium stores instructions that adapt at least one processor to: interpret a payout code request command transmitted from a user device via one or more secure electronic communication channels, the payout code request command corresponding to a payout for one or more wagers made by a user corresponding to the user device; verify, based at least in part on the payout code request command, that the user is authorized to receive the payout; if the user is authorized to receive the payout, generate a payout approval value; generate a payout code in response to the payout approval value; transmit the payout code to the user device via the one or more secure electronic communication channels; interpret first verification data transmitted from an item dispensing device via the one or more secure electronic communication channels; verify that the first verification data was generated based at least in part on the payout code transmitted to the user device; if the first verification data was generated based at least in part on the payout code, generate second verification data; and transmit the second verification data to the item dispensing device via the one or more secure electronic communication channels.

In certain aspects, the payout code includes a quick response code. In certain aspects, the payout code includes at least one of: a bar code; or alphanumeric characters. In certain aspects, the stored instructions further adapt the at least one processor to: retrieve offer data from an offer database storing data for a plurality of distinct offers, the offer data corresponding to an offer, of the plurality of distinct offers, for the user to make a new wager; and transmit the offer data to at least one of the item dispensing device or the user device. In certain aspects, the new wager has at least one of: an enhancement over the one or more wagers; an improved spread over the one or more wagers; or improved odds over the one or more wagers. In certain aspects, the offer data includes a time value corresponding to a time period during which the offer can be accepted by the user; and transmission of the offer data is based at least in part on the time period. In certain aspects, transmission of the offer data occurs during the time period corresponding to the time value. In certain aspects, the one or more wagers correspond to at least one of: a sporting event; a political election; or a user defined event.

An example apparatus for dispensing wager payouts includes: a body having a dispenser cavity and an opening; a dispenser disposed in at least a portion of the dispenser cavity, the dispenser having: a cavity that stores a plurality of items to be dispensed, a dispensing portion aligned with the opening of the body, and an actuator that dispenses, at the dispensing portion, one or more of the plurality of items from the cavity through the opening; an electronic display; a request processing circuit structured to interpret a payout request command generated by a user, the payout request command corresponding to a payout for one or more wagers made by the user; a verification circuit including: a code request circuit structured to, in response to the payout request command, generate a payout code request command and transmit the payout code request command to one or more servers via one or more secure electronic communication channels; a code processing circuit structured to, in response to transmission of the payout code request command, interpret a payout code transmitted by the one or more servers via the one or more secure electronic communication channels; a code provisioning circuit structured to display the payout code via the electronic display for scanning by a user device corresponding to the user; and a verification data processing circuit structured to interpret verification data transmitted from the one or more servers via the one or more secure electronic communication channels, the verification data corresponding to the payout code; and a payout provisioning circuit structured to cause, in response to the verification data, the dispenser to dispense, via the actuator, an amount of the plurality of items corresponding to the payout.

In certain aspects, the payout code includes a quick response code. In certain aspects, the payout code includes at least one of: a bar code; or alphanumeric characters. In certain aspects, the apparatus further includes: an input device structured to receive the payout request command and transmit the payout request command to the request processing circuit. In certain aspects, the input device includes at least one of: a network interface device; or a short-range wireless communication device. In certain aspects, the input device includes the network interface device, and the network interface device is structured to communicate based at least in part on at least one of: an ethernet-based protocol; an Internet Protocol-based protocol; a cellular-based protocol; a satellite communication-based protocol; or a dial-up connection-based protocol. In certain aspects, the input device includes the short-range wireless communication device, and the short-range wireless communication device is structured to communicate based at least in part on at least one of: a WiFi-based protocol; a Bluetooth-based protocol; a ZigBee-based protocol; an IR-based protocol; or a UWB-based protocol. In certain aspects, the apparatus further includes: an input device structured to receive a user input and, in response to the user input, generate the payout request command. In certain aspects, the input device includes at least one of: a physical button, or an electronic display having a virtual button. In certain aspects, the verification circuit further includes: a confirmation circuit; and the apparatus further includes: a physical token reading device structured to: interpret token data from a physical token device, and transmit the token data to the confirmation circuit; the confirmation circuit is structured to transmit the token data to the one or more servers; and the verification data is based at least in part on the token data. In certain aspects, the physical token reading device is at least one of: a cart reading device; or an RFID scanning device. In certain aspects, the verification circuit further includes: a confirmation circuit; and the apparatus further includes: a biometric device structured to: generate biometric data corresponding to the user, and transmit the biometric data to the confirmation circuit; the confirmation circuit is structured to transmit the biometric data to the one or more servers; and the verification data is based at least in part on the biometric data. In certain aspects, the verification circuit further includes: a confirmation circuit; and the apparatus further includes: an input device structured to: interpret second verification data from at least one of: the user device or the user; and transmit the second verification data to the confirmation circuit; the confirmation circuit is structured to transmit the second verification data to the one or more servers; and the verification data transmitted from the one or more servers is based at least in part on the second verification data. In certain aspects, the verification circuit further includes: a confirmation circuit structured to interpret second verification data transmitted by the one or more servers via the one or more secure electronic communication channels; and the apparatus further includes: an input device structured to: interpret third verification data from at least one of: the user device, or the user; and transmit the third verification data to the confirmation circuit; the confirmation circuit is further structured to determine that the user is authorized to receive the payout further based at least in part on comparing the second verification data to the third verification data; and the payout provisioning circuit is further structured to cause the dispenser to dispense the amount of the plurality of items corresponding to the payout if the user is authorized to receive the payout. In certain aspects, the confirmation circuit is further structured to determine that the user is authorized to receive the payout if the second verification data matches the third verification data. In certain aspects, the plurality of items to be dispensed includes at least one of: a currency; a gift card; a coupon; a casino chip; or an event ticket. In certain aspects, the apparatus further includes: a banking circuit structured to generate and transmit, via one or one or more secure electronic communication channels, a banking command to a bank server. In certain aspects, the apparatus further includes: an offer processing circuit structured to interpret offer data corresponding to an offer for the user to make a new wager; and an offer provisioning circuit structured to display the offer on the electronic display prior to dispensing of the amount of the plurality of items. In certain aspects, the new wager has at least one of: an enhancement over the one or more wagers; an improved spread over the one or more wagers; or improved odds over the one or more wagers. In certain aspects, the offer data includes a time value corresponding to a time period during which the offer can be accepted by the user, and the offer provisioning circuit is further structured to display the offer on the electronic display based at least in part on the time value. In certain aspects, the offer provisioning circuit is further structured to display the offer during the time period corresponding to the time value. In certain aspects, the one or more wagers correspond to at least one of: a sporting event; a political election; or a user defined event.

An example method for dispensing wager payouts includes: interpreting, at an item dispensing device, a payout request command generated by a user, the payout request command corresponding to a payout for one or more wagers made by the user; in response to the payout request command, generating, at the item dispensing device, a payout code request command; transmitting, from the item dispensing device, the payout code request command to one or more servers via one or more secure electronic communication channels; in response to transmitting the payout code request command, interpreting, at the item dispensing device, a payout code transmitted by the one or more servers via the one or more secure electronic communication channels; displaying the payout code via an electronic display of the item dispensing device for scanning by a user device corresponding to the user; interpreting, at the item dispensing device, verification data transmitted from the one or more servers via the one or more secure electronic communication channels, the verification data corresponding to the payout code; and in response to the verification data, dispensing, by the item dispensing device, an amount of a plurality of items corresponding to the payout.

In certain aspects, the payout code includes a quick response code. In certain aspects, the payout code includes at least one of: a bar code; or alphanumeric characters. In certain aspects, the method further includes: receiving, at an input device of the item dispensing device, the payout request command. In certain aspects, the input device includes at least one of: a network interface device; or a short-range wireless communication device. In certain aspects, the input device includes the network interface device, and receiving the payout request command is based at least in part on at least one of: an ethernet-based protocol; an Internet Protocol-based protocol; a cellular-based protocol; a satellite communication-based protocol; or a dial-up connection-based protocol. In certain aspects, the input device includes the short-range wireless communication device, and receiving the payout request command is based at least in part on at least one of: a WiFi-based protocol; a Bluetooth-based protocol; a ZigBee-based protocol; an IR-based protocol; or a UWB-based protocol. In certain aspects, the method further includes: receiving, at a user input device of the item dispensing device, a user input; and in response to the user input, generating the payout request command. In certain aspects, the user input device includes at least one of: a physical button, or an electronic display having a virtual button. In certain aspects, the method further includes: interpreting, via a physical token reading device of the item dispensing device, token data form a physical token device; and transmitting the token data from the item dispensing device to the one or more servers; and the verification data is based at least in part on the token data. In certain aspects, the physical token reading device is at least one of: a cart reading device; or an RFID scanning device. In certain aspects, the method further includes: generating, via a biometric device of the item dispensing device, biometric data corresponding to the user; and transmitting the biometric data from the item dispensing device to the one or more servers via the one or more secure electronic communication channels; and the verification data is based at least in part on the biometric data. In certain aspects, the method, further includes: interpreting, via an input device of the item dispensing device, second verification data; and transmitting second verification data from the item dispensing device to the one or more servers via the one or more secure electronic communication channels; and the verification data transmitted from the one or more servers is based at least in part on the second verification data. In certain aspects, the method further includes: interpreting, at the item dispensing device, second verification data transmitted by the one or more servers via the one or more secure electronic communication channels; interpreting, via an input device of the item dispensing device, third verification data from at least one of: the user device, or the user; comparing, at the item dispensing device, the second verification data to the third verification data; and determining, at the item dispensing device and based at least in part on the comparing of the second verification data to the third verification data, that the user is authorized to receive the payout; and dispensing, by the item dispensing device, an amount of the plurality of items corresponding to the payout is performed if the user is authorized to receive the payout. In certain aspects, the user is determined to be authorized to receive the payout if the second verification data matches the third verification data. In certain aspects, the plurality of items to be dispensed includes at least one of: a currency; a gift card; a coupon; a casino chip; or an event ticket. In certain aspects, the method further includes: generating, at the item dispensing device, a banking command; and transmitting the banking command from the item dispensing device to the one or more servers via the one or more secure electronic communication channels. In certain aspects, the method further includes: interpreting, at the item dispensing device, offer data corresponding to an offer for the user to make a new wager; and displaying the offer on the electronic display prior to the dispensing of the amount of the plurality of items. In certain aspects, the new wager has at least one of: an enhancement over the one or more wagers; an improved spread over the one or more wagers; or improved odds over the one or more wagers. In certain aspects, the offer data includes a time value corresponding to a time period during which the offer can be accepted by the user, and displaying the offer on the electronic display is based at least in part on the time value. In certain aspects, displaying the offer on the electronic display is performed during the time period corresponding to the time value. In certain aspects, the one or more wagers correspond to at least one of: a sporting event; a political election; or a user defined event.

An example non-transitory computer-readable medium stores instructions that adapt at least one processor to: interpret a payout request command generated by a user, the payout request command corresponding to a payout for one or more wagers made by the user; in response to the payout request command, generate, a payout code request command; transmit the payout code request command to one or more servers via one or more secure electronic communication channels; in response to transmitting the payout code request command, interpret, a payout code transmitted by the one or more servers via the one or more secure electronic communication channels; display the payout code via an electronic display of an item dispensing device for scanning by a user device corresponding to the user; interpret verification data transmitted from the one or more servers via the one or more secure electronic communication channels, the verification data corresponding to the payout code; and in response to the verification data, dispense, via the item dispensing device, an amount of a plurality of items corresponding to the payout.

In certain aspects, the payout code includes a quick response code. In certain aspects, the payout code includes at least one of: a bar code; or alphanumeric characters. In certain aspects, the stored instructions further adapt the at least one processor to: receive, at an input device of the item dispensing device, the payout request command. In certain aspects, the input device includes at least one of: a network interface device; or a short-range wireless communication device. In certain aspects, the input device includes the network interface device, and the network interface device is based at least in part on at least one of: an ethernet-based protocol; an Internet Protocol-based protocol; a cellular-based protocol; a satellite communication-based protocol; or a dial-up connection-based protocol. In certain aspects, the input device includes the short-range wireless communication device, and the short-range wireless communication device is based at least in part on at least one of: a WiFi-based protocol; a Bluetooth-based protocol; a ZigBee-based protocol; an IR-based protocol; or a UWB-based protocol. In certain aspects, the stored instructions further adapt the at least one processor to: receive, at a user input device of the item dispensing device, a user input; and in response to the user input, generate the payout request command. In certain aspects, the user input device includes at least one of: a physical button, or an electronic display having a virtual button. In certain aspects, the stored instructions further adapt the at least one processor to: interpret, via a physical token reading device of the item dispensing device, token data form a physical token device; and transmit the token data from the item dispensing device to the one or more servers; and the verification data is based at least in part on the token data. In certain aspects, the physical token reading device is at least one of: a cart reading device; or an RFID scanning device. In certain aspects, the stored instructions further adapt the at least one processor to: generate, via a biometric device of the item dispensing device, biometric data corresponding to the user; and transmit the biometric data from the item dispensing device to the one or more servers via the one or more secure electronic communication channels; and the verification data is based at least in part on the biometric data. In certain aspects, the stored instructions further adapt the at least one processor to: interpret, via an input device of the item dispensing device, second verification data; and transmit second verification data from the item dispensing device to the one or more servers via the one or more secure electronic communication channels; and the verification data transmitted from the one or more servers is based at least in part on the second verification data. In certain aspects, the stored instructions further adapt the at least one processor to: interpret second verification data transmitted by the one or more servers via the one or more secure electronic communication channels; interpret, via an input device of the item dispensing device, third verification data from at least one of: the user device, or the user; compare the second verification data to the third verification data; and determine, based at least in part on the comparing of the second verification data to the third verification data, that the user is authorized to receive the payout; wherein the amount of the plurality of items corresponding to the payout is dispensed if the user is authorized to receive the payout. In certain aspects, the user is determined to be authorized to receive the payout if the second verification data matches the third verification data. In certain aspects, the plurality of items to be dispensed includes at least one of: a currency; a gift card; a coupon; a casino chip; or an event ticket. In certain aspects, the stored instructions further adapt the at least one processor to: generate a banking command; and transmit the banking command to the one or more servers via the one or more secure electronic communication channels. In certain aspects, the stored instructions further adapt the at least one processor to: interpret offer data corresponding to an offer for the user to make a new wager; and display the offer on the electronic display prior to the dispensing of the amount of the plurality of items. In certain aspects, the new wager has at least one of: an enhancement over the one or more wagers; an improved spread over the one or more wagers; or improved odds over the one or more wagers. In certain aspects, the offer data includes a time value corresponding to a time period during which the offer can be accepted by the user, and the display of the offer on the electronic display is based at least in part on the time value. In certain aspects, the display of the offer on the electronic display is performed during the time period. In certain aspects, the one or more wagers correspond to at least one of: a sporting event; a political election; or a user defined event.

An example non-transitory computer-readable medium stores instructions that adapt at least one processor to: interpret an item dispensing device selection command that identifies an item dispensing device for executing a payout for one or more wagers made by a user; transmit the item dispensing device selection command to one or more servers via one or more secure electronic communication channels; interpret a payout code provided by the item dispensing device; and transmit the payout code to the one or more servers via the one or more secure electronic communication channels.

In certain aspects, the payout code includes a quick response code. In certain aspects, the payout code includes at least one of: a bar code; or alphanumeric characters.

An example method for collecting a payout for one or more wagers made by a user includes: interpreting, at a user device corresponding to the user, an item dispensing device selection command that identifies an item dispensing device for executing the payout for the one or more wagers; transmitting, from the user device, the item dispensing device selection command to one or more servers; interpreting, at the user device, a payout code provided by the item dispensing device; and transmitting, from the user device, the payout code to the one or more servers via one or more secure electronic communication channels.

An example apparatus includes: a user input device structured to receive a user input from a user; a selection circuit structured to interpret the user input and generate an item dispensing device selection command that identifies an item dispensing device for executing a payout for one or more wagers made by the user; a selection provisioning circuit structured to transmit the item dispensing device selection command to one or more servers via one or more secure electronic communication channels; a code processing circuit structured to interpret a payout code provided by the item dispensing device; and a code provisioning circuit structured to transmit the payout code to the one or more servers via the one or more secure electronic communication channels.

In certain aspects, the payout code includes a quick response code. In certain aspects, the payout code includes at least one of: a bar code; or alphanumeric characters.

An example non-transitory computer-readable medium stores instructions that adapt at least one processor to: interpret an item dispensing selection command that identifies an item dispensing device for executing a payout for one or more wagers made by a user; generate a payout code request command based at least in part on the item dispensing selection command; transmit the payout code request command to one or more servers via one or more secure electronic communication channels; interpret, in response to the transmitting of the payout code request command, a payout code transmitted by the one or more servers via the one or more secure electronic communication channels; and display the payout code on an electronic display for scanning by the item dispensing device.

In certain aspects, the one or more wagers correspond to at least one of: a sporting event; a political election; or a user defined event. In certain aspects, the payout code includes a quick response code. In certain aspects, the payout code includes at least one of: a bar code; or alphanumeric characters.

An example method for collecting a payout for one or more wagers includes: interpreting an item dispensing selection command that identifies an item dispensing device for executing a payout for one or more wagers made by a user; generating a payout code request command based at least in part on the item dispensing selection command; transmitting the payout code request command to one or more servers via one or more secure electronic communication channels; interpreting, in response to the transmitting of the payout code request command, a payout code transmitted by the one or more servers via the one or more secure electronic communication channels; and displaying the payout code on an electronic display for scanning by the item dispensing device.

In certain aspects, the one or more wagers correspond to at least one of: a sporting event; a political election; or a user defined event. In certain aspects, the payout code includes a quick response code. In certain aspects, the payout code includes at least one of: a bar code; or alphanumeric characters.

An example apparatus includes: a user input device structured to receive a user input from a user; a selection circuit structured to interpret the user input and generate, based at least in part on the user input, an item dispensing selection command that identifies an item dispensing device for executing a payout for one or more wagers made by the user; a code request circuit structured to: generate a payout code request command based at least in part on the item dispensing selection command; and transmit the payout code request command to one or more servers via one or more secure electronic communication channels; a code processing circuit structured to interpret, in response to the transmitting of the payout code request command, a payout code transmitted by the one or more servers via the one or more secure electronic communication channels; and a code provisioning circuit structured to display the payout code on an electronic display for scanning by the item dispensing device.

In certain aspects, the one or more wagers correspond to at least one of: a sporting event; a political election; or a user defined event. In certain aspects, the payout code includes a quick response code. In certain aspects, the payout code includes at least one of: a bar code; or alphanumeric characters.

An example server for dispensing a payout for a wager between two users includes: a request processing circuit structured to interpret a payout request command transmitted from a user device via one or more secure electronic communication channels, the user device corresponding to a first user and the payout request command corresponding to a payout for one or more wagers made between the first user and a second user; a wager identification circuit structured to query, based at least in part on the payout request command, a database that stores a plurality of records corresponding to a plurality of wagers made between a plurality of distinct users, the plurality of distinct users includes the first user and the second user, the plurality of wagers includes the one or more wagers between the first user and the second user, and the query is structured to return wager data corresponding to the one or more wagers made between the first user and the second user; a verification circuit structured to verify, based at least in part on the wager data, that the first user is a winning party to the one or more wagers and, if the first user is the winning party, generate a payout code corresponding to the payout; and a code transmission circuit structured to transmit, via the one or more secure electronic communication channels, the payout code to at least one of: the user device; or an item dispensing device.

In certain aspects, the payout request command includes an item dispensing device identifier that identifies the item dispensing device; and the code transmission circuit is further structured to transmit the payout code to the item dispensing device based at least in part on the item dispensing device identifier. In certain aspects, the server further includes: a verification data processing circuit structured to interpret first verification data transmitted by the user device via the one or more secure electronic communication channels; a subsequent verification circuit structured to verify that the first verification data was generated based at least in part on the payout code transmitted to the item dispensing device and, if the first verification data was generated based at least in part on the payout code, generate second verification data; and a verification data provisioning circuit structured to transmit the second verification data to the item dispensing device via the one or more secure electronic communication channels. In certain aspects, the payout request command includes an item dispensing device identifier that identifies the item dispensing device; and the code transmission circuit is further structured to transmit the payout code to the user device based at least in part on the item dispensing device identifier. In certain aspects, the server further includes: a verification data processing circuit structured to interpret first verification data transmitted by the item dispensing device via the one or more secure electronic communication channels; a subsequent verification circuit structured to verify that the first verification data was generated based at least in part on the payout code transmitted to the user device and, if the first verification data was generated based at least in part on the payout code, generate second verification data; and a verification data provisioning circuit structured to transmit the second verification data to the item dispensing device via the one or more secure electronic communication channels. In certain aspects, the payout code includes a quick response code. In certain aspects, the payout code includes at least one of: a bar code; or alphanumeric characters. In certain aspects, the one or more wagers correspond to at least one of: a sporting event; a political election; or a user defined event. In certain aspects, the server further includes: an offer selection circuit structured to retrieve offer data from an offer database storing data for a plurality of distinct offers, the offer data corresponding to an offer, of the plurality of distinct offers, for the first user to make a new wager; and an offer provisioning circuit structured to transmit the offer data to at least one of: the item dispensing device; or the user device. In certain aspects, the new wager has at least one of: an enhancement over the one or more wagers; an improved spread over the one or more wagers; or improved odds over the one or more wagers. In certain aspects, the offer data includes a time value corresponding to a time period during which the offer can be accepted by the first user; and the offer provisioning circuit is further structured to transmit the offer data based at least in part on the time period. In certain aspects, the offer provisioning circuit is further structured to transmit the offer data during the time period corresponding to the time value.

An example method for dispensing a payout for a wager between two users, includes: interpreting a payout request command transmitted from a user device via one or more secure electronic communication channels, the user device corresponding to a first user and the payout request command corresponding to a payout for one or more wagers made between the first user and a second user; querying, based at least in part on the payout request command, a database that stores a plurality of records corresponding to a plurality of wagers made between a plurality of distinct users, the plurality of distinct users includes the first user and the second user, the plurality of wagers includes the one or more wagers between the first user and the second user, and the query is structured to return wager data corresponding to the one or more wagers made between the first user and the second user; verifying, based at least in part on the wager data, that the first user is a winning party to the one or more wagers; if the first user is the winning party, generating a payout code corresponding to the payout; and transmitting, via the one or more secure electronic communication channels, the payout code to at least one of: the user device; or an item dispensing device.

In certain aspects, the payout request command includes an item dispensing device identifier that identifies the item dispensing device; and the payout code is transmitted to the item dispensing device based at least in part on the item dispensing device identifier. In certain aspects, the method further includes: interpreting first verification data transmitted by the user device via the one or more secure electronic communication channels; verifying that the first verification data was generated based at least in part on the payout code transmitted to the item dispensing device; if the first verification data was generated based at least in part on the payout code, generating second verification data; and transmitting the second verification data to the item dispensing device via the one or more secure electronic communication channels. In certain aspects, the payout request command includes an item dispensing device identifier that identifies the item dispensing device; and the payout code is transmitted to the user device based at least in part on the item dispensing device identifier. In certain aspects, the method further includes: interpreting first verification data transmitted by the item dispensing device via the one or more secure electronic communication channels; verifying that the first verification data was generated based at least in part on the payout code transmitted to the user device; if the first verification data was generated based at least in part on the payout code, generating second verification data; and transmitting the second verification data to the item dispensing device via the one or more secure electronic communication channels. In certain aspects, the payout code includes a quick response code. In certain aspects, the payout code includes at least one of: a bar code; or alphanumeric characters. In certain aspects, the one or more wagers correspond to at least one of: a sporting event; a political election; or a user defined event. In certain aspects, the method further includes: retrieving offer data from an offer database storing data for a plurality of distinct offers, the offer data corresponding to an offer, of the plurality of distinct offers, for the first user to make a new wager; and transmitting the offer data to at least one of: the item dispensing device; or the user device. In certain aspects, the new wager has at least one of: an enhancement over the one or more wagers; an improved spread over the one or more wagers; or improved odds over the one or more wagers. In certain aspects, the offer data includes a time value corresponding to a time period during which the offer can be accepted by the first user; and transmitting of the offer data is based at least in part on the time period. In certain aspects, transmitting of the offer data is performed during the time period corresponding to the time value.

An example non-transitory computer-readable medium stores instructions that adapt at least one processor to: interpret a payout request command transmitted from a user device via one or more secure electronic communication channels, the user device corresponding to a first user and the payout request command corresponding to a payout for one or more wagers made between the first user and a second user; query, based at least in part on the payout request command, a database that stores a plurality of records corresponding to a plurality of wagers made between a plurality of distinct users, the plurality of distinct users includes the first user and the second user, the plurality of wagers includes the one or more wagers between the first user and the second user, and the query is structured to return wager data corresponding to the one or more wagers made between the first user and the second user; verify, based at least in part on the wager data, that the first user is a winning party to the one or more wagers; if the first user is the winning party, generate a payout code corresponding to the payout; and transmit, via the one or more secure electronic communication channels, the payout code to at least one of: the user device; or an item dispensing device.

In certain aspects, the payout request command includes an item dispensing device identifier that identifies the item dispensing device; and the payout code is transmitted to the item dispensing device based at least in part on the item dispensing device identifier. In certain aspects, the stored instructions further adapt the at least one processor to: interpret first verification data transmitted by the user device via the one or more secure electronic communication channels; verify that the first verification data was generated based at least in part on the payout code transmitted to the item dispensing device; if the first verification data was generated based at least in part on the payout code, generate second verification data; and transmit the second verification data to the item dispensing device via the one or more secure electronic communication channels. In certain aspects, a non-transitory computer-readable medium, the payout request command includes an item dispensing device identifier that identifies the item dispensing device; and the payout code is transmitted to the user device based at least in part on the item dispensing device identifier. In certain aspects, the stored instructions further adapt the at least one processor to: interpret first verification data transmitted by the item dispensing device via the one or more secure electronic communication channels; verify that the first verification data was generated based at least in part on the payout code transmitted to the user device; if the first verification data was generated based at least in part on the payout code, generate second verification data; and transmit the second verification data to the item dispensing device via the one or more secure electronic communication channels. In certain aspects, the payout code includes a quick response code. In certain aspects, the payout code includes at least one of: a bar code; or alphanumeric characters. In certain aspects, the one or more wagers correspond to at least one of: a sporting event; a political election; or a user defined event. In certain aspects, the stored instructions further adapt the at least one processor to: retrieve offer data from an offer database storing data for a plurality of distinct offers, the offer data corresponding to an offer, of the plurality of distinct offers, for the first user to make a new wager; and transmit the offer data to at least one of: the item dispensing device; or the user device. In certain aspects, the new wager has at least one of: an enhancement over the one or more wagers; an improved spread over the one or more wagers; or improved odds over the one or more wagers. In certain aspects, the offer data includes a time value corresponding to a time period during which the offer can be accepted by the first user; and the offer data is transmitted based at least in part on the time period. In certain aspects, the offer data is transmitted during the time period corresponding to the time value.

An example apparatus for dispensing wager payouts, the apparatus including: a body having a dispenser cavity and an opening; a dispenser disposed in at least a portion of the dispenser cavity, the dispenser having: a cavity that stores a plurality of items to be dispensed, a dispensing portion aligned with the opening of the body, and an actuator that dispenses, at the dispensing portion, one or more of the plurality of items from the cavity through the opening; an electronic display; a request processing circuit structured to interpret a payout request command initiated by a user, the payout request command corresponding to a payout for one or more wagers made by the user; a verification circuit including: a code provisioning circuit structured to display, in response to the payout request command, a payout code via the electronic display for scanning by a user device corresponding to the user; and a verification data processing circuit structured to interpret, in response to the display of the payout code, verification data transmitted from one or more servers via one or more secure electronic communication channels; and a payout provisioning circuit structured to cause, in response to the verification data, the dispenser to dispense, via the actuator, an amount of the plurality of items corresponding to the payout.

In certain aspects, the request processing circuit is further structured to interpret a dispense amount value that defines, at least in part, the amount of the plurality of items dispensed by the dispenser. In certain aspects, the payout code is distinct. In certain aspects, the payout code is structured to identify a location. In certain aspects, the apparatus further includes: a memory device structured to store the payout code prior to display of the payout code on the electronic display for scanning by the user device; and the code provisioning circuit is further structured to access the payout code from the memory device. In certain aspects, the apparatus further includes: a code generation circuit structured to generate the payout code. In certain aspects, the plurality of items to be dispensed includes at least one of: a currency; a gift card; a coupon; a casino chip; or an event ticket. In certain aspects, the one or more wagers correspond to at least one of: a sporting event; a political election; or a user defined event. In certain aspects, the payout code includes a quick response code. In certain aspects, the payout code includes at least one of: a bar code; or alphanumeric characters. In certain aspects, the apparatus further includes: an input device structured to receive the payout request command and transmit the payout request command to the request processing circuit. In certain aspects, the input device includes at least one of: a network interface device; or a short-range wireless communication device. In certain aspects, the input device includes the network interface device, and the network interface device is structured to communicate based at least in part on at least one of: an ethernet-based protocol; an Internet Protocol-based protocol; a cellular-based protocol; a satellite communication-based protocol; or a dial-up connection-based protocol. In certain aspects, the input device includes the short-range wireless communication device, and the short-range wireless communication device is structured to communicate based at least in part on at least one of: a WiFi-based protocol; a Bluetooth-based protocol; a ZigBee-based protocol; an IR-based protocol; or a UWB-based protocol. In certain aspects, the apparatus further includes: an input device structured to receive a user input and, in response to the user input, generate the payout request command. In certain aspects, the input device includes at least one of: a physical button, or a virtual button on the electronic display. In certain aspects, the verification circuit further includes a confirmation circuit; and the apparatus further includes a physical token reading device structured to: interpret token data from a physical token device, and transmit the token data to the confirmation circuit; the confirmation circuit is structured to transmit the token data to the one or more servers; and the verification data is based at least in part on the token data. In certain aspects, the physical token reading device is at least one of: a cart reading device; or an RFID scanning device. In certain aspects, the verification circuit further includes a confirmation circuit; and the apparatus further includes a biometric device structured to: generate biometric data corresponding to the user, and transmit the biometric data to the confirmation circuit; the confirmation circuit is structured to transmit the biometric data to the one or more servers; and the verification data is based at least in part on the biometric data. In certain aspects, the verification circuit further includes a confirmation circuit; and the apparatus further includes an input device structured to: interpret second verification data from at least one of: the user device or the user; and transmit the second verification data to the confirmation circuit; the confirmation circuit is further structured to transmit the second verification data to the one or more servers; and the verification data transmitted from the one or more servers is based at least in part on the second verification data. In certain aspects, the verification circuit further includes: a confirmation circuit structured to interpret second verification data transmitted by the one or more servers via the one or more secure electronic communication channels; and the apparatus further includes: an input device structured to: interpret third verification data from at least one of: the user device, or the user; and transmit the third verification data to the confirmation circuit; the confirmation circuit is further structured to determine that the user is authorized to receive the payout further based at least in part on comparing the second verification data to the third verification data; and the payout provisioning circuit is further structured to cause the dispenser to dispense the amount of the plurality of items corresponding to the payout if the user is authorized to receive the payout. In certain aspects, the confirmation circuit is further structured to determine that the user is authorized to receive the payout if the second verification data matches the third verification data.

An example method for dispensing wager payouts includes: interpreting, at an item dispensing device, a payout request command initiated by a user, the payout request command corresponding to a payout for one or more wagers made by the user; displaying, in response to the payout request command, a payout code via an electronic display for scanning by a user device corresponding to the user; interpreting, at the item dispensing device, in response to the display of the payout code, verification data transmitted from one or more servers via one or more secure electronic communication channels; and causing, in response to the verification data, a dispenser of the item dispensing device to dispense, via an actuator, an amount of a plurality of items corresponding to the payout.

In certain aspects, the method further includes: interpreting, at the item dispensing device, a dispense amount value that defines, at least in part, the amount of the plurality of items dispensed by the dispenser. In certain aspects, the payout code is distinct. In certain aspects, the payout code is structured to identify a location. In certain aspects, the method further includes: prior to display of the payout code on the electronic display for scanning by the user device: storing the payout code in a memory device of the item dispensing device; and accessing, at the item dispensing device, the payout code from the memory device. In certain aspects, the method further includes: generating, at the item dispensing device, the payout code. In certain aspects, the plurality of items includes at least one of: a currency; a gift card; a coupon; a casino chip; or an event ticket. In certain aspects, the one or more wagers correspond to at least one of: a sporting event; a political election; or a user defined event. In certain aspects, the payout code includes a quick response code. In certain aspects, the payout code includes at least one of: a bar code; or alphanumeric characters. In certain aspects, the method further includes: receiving, at an input device of the item dispensing device, the payout request command. In certain aspects, the input device includes at least one of: a network interface device; or a short-range wireless communication device. In certain aspects, the input device includes the network interface device, and receiving the payout request command is based at least in part on at least one of: an ethernet-based protocol; an Internet Protocol-based protocol; a cellular-based protocol; a satellite communication-based protocol; or a dial-up connection-based protocol. In certain aspects, the input device includes the short-range wireless communication device, and receiving the payout request command is based at least in part on at least one of: a WiFi-based protocol; a Bluetooth-based protocol; a ZigBee-based protocol; an IR-based protocol; or a UWB-based protocol. In certain aspects, the method further includes: receiving, at an input device of the item dispensing device, a user input; and in response to the user input, generating, at the item dispensing device, the payout request command. In certain aspects, the input device includes at least one of: a physical button, or an electronic display having a virtual button. In certain aspects, the method further includes: interpreting, via a physical token reading device of the item dispensing device, token data from a physical token device, and transmitting the token data from the item dispensing device to the one or more servers; and the verification data is based at least in part on the token data. In certain aspects, the physical token reading device is at least one of: a cart reading device; or an RFID scanning device. In certain aspects, the method further includes: generating, via a biometric device of the item dispensing device, biometric data corresponding to the user, and transmitting the biometric data from the item dispensing device to the one or more servers; and the verification data is based at least in part on the biometric data. In certain aspects, the method further includes: interpreting, via a user input device of the item dispensing device, second verification data from at least one of: the user device or the user; and transmitting the second verification data from the item dispensing device to the one or more servers; wherein the verification data transmitted from the one or more servers is based at least in part on the second verification data. In certain aspects, the method further includes: interpreting, at the item dispensing device, second verification data transmitted by the one or more servers via the one or more secure electronic communication channels; and interpreting, via an input device of the item dispensing device, third verification data from at least one of: the user device, or the user; comparing, at the item dispensing device, the second verification data to the third verification data; and determining, at the item dispensing device and based at least in part on the comparing of the second verification data to the third verification data, that the user is authorized to receive the payout; and dispensing, by the item dispensing device, the amount of the plurality of items corresponding to the payout is performed if the user is authorized to receive the payout. In certain aspects, the user is determined to be authorized to receive the payout if the second verification data matches the third verification data.

An example non-transitory computer-readable medium stores instructions that adapt at least one processor to: interpret a payout request command initiated by a user via an input device, the payout request command corresponding to a payout for one or more wagers made by the user; display, in response to the payout request command, a payout code via an electronic display for scanning by a user device corresponding to the user; interpret, in response to the display of the payout code, verification data transmitted from one or more servers via one or more secure electronic communication channels; and cause, in response to the verification data, a dispenser to dispense, via an actuator, an amount of a plurality of items corresponding to the payout.

In certain aspects, the stored instructions further adapt the at least one processor to: interpret a dispense amount value that defines, at least in part, the amount of the plurality of items dispensed by the dispenser. In certain aspects, the payout code is distinct. In certain aspects, the payout code is structured to identify a location. In certain aspects, the stored instructions further adapt the at least one processor to: prior to display of the payout code on the electronic display for scanning by the user device: store the payout code in a memory device; and access the payout code from the memory device. In certain aspects, the stored instructions further adapt the at least one processor to: generate the payout code. In certain aspects, the plurality of items to be dispensed includes at least one of: a currency; a gift card; a coupon; a casino chip; or an event ticket. In certain aspects, the one or more wagers correspond to at least one of: a sporting event; a political election; or a user defined event. In certain aspects, the payout code includes a quick response code. In certain aspects, the payout code includes at least one of: a bar code; or alphanumeric characters. In certain aspects, the stored instructions further adapt the at least one processor to: receive the payout request command. In certain aspects, the input device includes at least one of: a network interface device; or a short-range wireless communication device. In certain aspects, the input device includes the network interface device, and the network interface device is structured to communicate based at least in part on at least one of: an ethernet-based protocol; an Internet Protocol-based protocol; a cellular-based protocol; a satellite communication-based protocol; or a dial-up connection-based protocol. In certain aspects, the input device includes the short-range wireless communication device, and the short-range wireless communication device is structured to communicate based at least in part on at least one of: a WiFi-based protocol; a Bluetooth-based protocol; a ZigBee-based protocol; an IR-based protocol; or a UWB-based protocol. In certain aspects, the stored instructions further adapt the at least one processor to: receive, at an input device, a user input; and in response to the user input, generate the payout request command. In certain aspects, the input device includes at least one of: a physical button, or an electronic display having a virtual button. In certain aspects, a non-transitory computer-readable medium, and the stored instructions further adapt the at least one processor to: interpret, via a physical token reading device, token data from a physical token device, and transmit the token data to the one or more servers; and the verification data is based at least in part on the token data. In certain aspects, the physical token reading device is at least one of: a cart reading device; or an RFID scanning device. In certain aspects, the stored instructions further adapt the at least one processor to: generate, via a biometric device, biometric data corresponding to the user, and transmit the biometric data to the one or more servers; wherein the verification data is based at least in part on the biometric data. In certain aspects, the stored instructions further adapt the at least one processor to: interpret, via a user input device, second verification data from at least one of: the user device or the user; and transmit the second verification data to the one or more servers; and the verification data transmitted from the one or more servers is based at least in part on the second verification data. In certain aspects, the stored instructions further adapt the at least one processor to: interpret second verification data transmitted by the one or more servers via the one or more secure electronic communication channels; interpret, via an input device, third verification data from at least one of: the user device, or the user; compare the second verification data to the third verification data; and determine, based at least in part on the comparing of the second verification data to the third verification data, that the user is authorized to receive the payout; and the amount of the plurality of items corresponding to the payout is dispensed if the user is authorized to receive the payout. In certain aspects, the user is determined to be authorized to receive the payout if the second verification data matches the third verification data.

An example system includes: one or more servers; and an item dispensing device structured to: interpret a payout code corresponding to a payout for one or more wagers made by a user; generate first verification data based at least in part on the payout code; and transmit the first verification data to the one or more servers; and the one or more servers are structured to: interpret the first verification data; determine, based at least in part on the first verification data, that the user is authorized to receive the payout; if the user is authorized to receive the payout, generate second verification data in response to the first verification data; and transmit the second verification data to the item dispensing device; and the item dispensing device is further structured to: interpret the second verification data; and dispense, in response to the second verification data, an amount of a plurality of items corresponding to the payout.

In certain aspects, the system further includes: a user device corresponding to the user and structured to: generate a payout code request command corresponding to the payout; and transmit the payout code request command to the one or more servers; wherein the one or more servers are further structured to: interpret the payout code request command; in response to the payout code request command, generate the payout code; and transmit the payout code to the user device; wherein the user device is further structured to: interpret the payout code; and present the payout code to the item dispensing device. In certain aspects, the item dispensing device includes a scanning device structured to read-in the payout code; and the user device includes an electronic display and is structured to present the payout code to the item dispensing device by displaying the payout code on the electronic display to be read-in by the scanning device. In certain aspects, the user device is structured to present the payout code to the item dispensing device by transmitting the payout code to the item dispensing device. In certain aspects, the payout code includes a quick response code. In certain aspects, the payout code includes at least one of: a bar code; or alphanumeric characters. In certain aspects, the plurality of items to be dispensed includes at least one of: a currency; a gift card; a coupon; a casino chip; or an event ticket.

An example system includes: a user device corresponding to a user and structured to: generate a payout code request command corresponding to a payout for one or more wagers made by a user; and transmit the payout code request command; and one or more servers structured to; interpret the payout code request command; in response to the payout code request command, generate a payout code corresponding to the payout; and transmit the payout code to the user device; and the user device is further structured to: interpret the payout code; and present the payout code to an item dispensing device.

In certain aspects, the user device includes an electronic display and is structured to present the payout code to the item dispensing device by displaying the payout code on the electronic display to be read-in by a scanning device of the item dispensing device. In certain aspects, the user device is further structured to present the payout code to the item dispensing device by transmitting the payout code to the item dispensing device. In certain aspects, the one or more servers are further structured to: interpret first verification data transmitted by the item dispensing device, the first verification data based at least in part on the payout code; generate, in response to the first verification data, second verification data that indicates the user is authorized to receive the payout; and transmit the second verification data to the item dispensing device. In certain aspects, the payout code includes a quick response code. In certain aspects, the payout code includes at least one of: a bar code; or alphanumeric characters.

An example system includes: a non-transitory computer-readable medium storing instructions that adapt at least one processor of an electronic device to: generate a payout code request command corresponding to a payout for one or more wagers made by a user corresponding to the electronic device; and transmit the payout code request command; and one or more servers structured to: interpret the payout code request command; in response to the payout code request command, generate a payout code corresponding to the payout; and transmit the payout code to the electronic device; and the stored instructions further adapt the at least one processor to: interpret the payout code; and present the payout code to an item dispensing device.

In certain aspects, the item dispensing device includes a scanning device structured to read-in the payout code; and the stored instructions further adapt the at least one processor to present the payout code to the item dispensing device by displaying the payout code on an electronic display of the electronic device. In certain aspects, the stored instructions further adapt the at least one processor to present the payout code to the item dispensing device by transmitting, via electronic device, the payout code to the item dispensing device. In certain aspects, the one or more servers are further structured to: interpret first verification data transmitted by the item dispensing device, the first verification data based at least in part on the payout code; generate, in response to the first verification data, second verification data that indicates the user is authorized to receive the payout; and transmit the second verification data to the item dispensing device. In certain aspects, the payout code includes a quick response code. In certain aspects, the payout code includes at least one of: a bar code; or alphanumeric characters.

The methods and systems described herein may be deployed in part or in whole through a machine having a computer, e.g., user devices 120, 122, 124, 126, item dispensing devices 128, 130, 132, servers 612, 812, 910, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Components and/or circuits, as set forth herein, include any combination of processors, computing devices, circuits, sensors, input/output devices, communication infrastructure, any other hardware devices, logic circuits, and/or aspects configured as computer readable instructions executable by a processor to perform one or more operations of the component, arranged and/or in communication that, taken together, perform the operations set forth for a given component. The constituent elements of a given component may change over time and/or operating conditions, for example due to utilizing different servers, installing or removing portions of the component on devices, performing updates, corrections, or upgrades to computer readable instructions, or the like.

Network and/or communication resources include, without limitation, local area network, wide area network, wireless, internet, or any other known communication resources and protocols. Example and non-limiting hardware, computers, computing devices, processors, circuits, and/or servers include, without limitation, a general-purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer-readable instructions described above. All such permutations and combinations are contemplated in embodiments of the present disclosure.

While the disclosure has been disclosed in connection with the embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

1-8. (canceled)

9. An apparatus for dispensing wager payouts, the apparatus comprising:
a body having a dispenser cavity and an opening;
a dispenser disposed in at least a portion of the dispenser cavity, the dispenser having:
a cavity that stores a plurality of items to be dispensed,
a dispensing portion aligned with the opening of the body, and
an actuator that dispenses, at the dispensing portion, one or more of the plurality of items from the cavity through the opening;
a payout code scanner;
a request processing circuit structured to interpret a payout request command initiated by a user, the payout request command corresponding to a payout for one or more wagers made by the user;
a verification circuit comprising:
a code request circuit structured to, in response to the payout request command, generate and transmit a code prompt command structured to generate a prompt for a payout code to be provided for read-in via the payout code scanner;
a code processing circuit structured to, in response to the payout code scanner reading-in the payout code, interpret the payout code and generate first verification data based at least in part on the payout code;
a code communication circuit structured to:
transmit, via one or more secure electronic communication channels, the first verification data to one or more servers, and
in response to transmitting the first verification data, interpret second verification data transmitted from the one or more servers via the one or more secure electronic communication channels; and
a confirmation circuit structured to determine, based at least in part on the second verification data, that the user is authorized to receive the payout and, in response to determining that the user is to be authorized to receive the payout, generate a payout command; and
a payout provisioning circuit structured to cause, in response to the payout command, the dispenser to dispense, via the actuator, an amount of the plurality of items corresponding to the payout.

10. The apparatus of claim 9, wherein the payout code comprises a quick response code.

11. The apparatus of claim 9, wherein the payout code comprises at least one of:
a bar code; or
alphanumeric characters.

12. The apparatus of claim 9 further comprising:
an input device structured to receive the payout request command and transmit the payout request command to the request processing circuit.

13. The apparatus of claim 12, wherein the input device includes at least one of:
a network interface device; or
a short-range wireless communication device.

14. The apparatus of claim 13, wherein the input device includes the network interface device, and the network interface device is structured to communicate based at least in part on at least one of:
an ethernet-based protocol;
an Internet Protocol-based protocol;
a cellular protocol;
a satellite communication-based protocol; or
a dial-up connection-based protocol.

15. The apparatus of claim 13, wherein the input device includes the short-range wireless communication device, and the short-range wireless communication device is structured to communicate based at least in part on at least one of:
a WiFi-based protocol;
a Bluetooth-based protocol;
a ZigBee-based protocol;
an IR-based protocol; or
a UWB-based protocol.

16. The apparatus of claim 9 further comprising:
an input device structured to receive a user input and, in response to the user input, generate the payout request command.

17. The apparatus of claim 16, wherein the input device includes at least one of:
a physical button, or
an electronic display having a virtual button.

18. The apparatus of claim 9 further comprising:
a physical token reading device structured to:
interpret token data from a physical token device, and
transmit the token data to the confirmation circuit;
wherein the confirmation circuit is further structured to determine that the user is authorized to receive the payout based at least in part on the token data.

19. The apparatus of claim 18, wherein the physical token reading device is at least one of:
a cart reading device; or
an RFID scanning device.

20. The apparatus of claim 9 further comprising:
a biometric device structured to:
generate biometric data corresponding to the user, and
transmit the biometric data to the confirmation circuit;
wherein the confirmation circuit is further structured to determine that the user is authorized to receive the payout based at least in part on the biometric data.

21-23. (canceled)

24. The apparatus of claim 9, wherein the apparatus further comprises an electronic display and the code prompt command is structured to display the prompt as a visual message via the electronic display.

25. The apparatus of claim 9, wherein the apparatus further comprises an audio device and the code prompt command is structured to play the prompt as an audio message over the audio device.

26. The apparatus of claim 9, wherein:
the code request circuit is further structured to transmit the code prompt command to a user device corresponding to the user; and
the code prompt command is structured to display the prompt as a visual message on an electronic display of the user device.

27. The apparatus of claim 9, wherein:
the code request circuit is further structured to transmit the code prompt command to a user device corresponding to the user; and
the code prompt command is structured to play the prompt as an audio message over an audio device of the user device.

28-72. (canceled)

73. A method for dispensing wager payouts, the method comprising:
storing, in a cavity of a dispenser disposed in at least a portion of a dispenser cavity of a body, a plurality of items to be dispensed;
interpreting, via a request processing circuit, a payout request command initiated by a user, the payout request command corresponding to a payout for one or more wages made by the user;
generating, via a code request circuit of a verification circuit and in response to the payout request command, a code prompt command structured to generate a prompt for a payout code to be provided for read-in via a payout code scanner;
reading-in, via the payout code scanner, the payout code;
interpreting, via a code processing circuit of the verification circuit and in response to the payout code scanner reading-in the payout code, the payout code and generating first verification data based at least in part on the payout code;
transmitting, over one or more secure electronic communication channels via a code communication circuit of the verification circuit, the first verification data to one or more servers;
interpreting, via the code communication circuit and in response to transmitting the first verification data, second verification data transmitted from the one or more servers via the one or more secure electronic communication channels;
determining, via a confirmation circuit of the verification circuit and based at least in part on the second verification data, that the user is authorized to receive the payout;
generating, via the confirmation circuit and in response to determining that the user is authorized to receive the payout, a payout command; and
dispensing, via a payout provisioning circuit in electronic communication with an actuator of the dispenser and in response to the payout command, an amount of the plurality of items, corresponding to the payout, from the cavity and through an opening of the body, wherein the actuator is disposed at a dispensing portion of the dispenser aligned with the opening.

74. The method of claim 73 further comprising:
interpreting, via an input device, a user input; and
generating, via the input device, the payout request command.

75. The method of claim 74, wherein the input device includes at least one of:
a physical button; or
an electronic display having a virtual button.

76. The method of claim 73 further comprising:
generating, via a biometric device, biometric data corresponding to the user, and
transmitting, via the biometric device, the biometric data to the confirmation circuit;
wherein determining, via the confirmation circuit, that the user is authorized to receive the payout is based at least in part on the biometric data.
